(19) United States
(12) Patent Application Publication
(10) Pub. No.: US 2015/0360317 A1
(43) Pub. Date: Dec. 17, 2015

(54) Friction Spot Welding and Friction Seam Welding

(71) Applicant: UNIVERSITY OF UTAH RESEARCH FOUNDATION, Salt Lake City, UT (US)

(72) Inventors: Prasad Rao Kalvala, Salt Lake City, UT (US); Javed Akram, Salt Lake City, UT (US); Alex Ilunga Tshibind, Salt Lake City, UT (US); Abraham L. Jurovitzki, Salt Lake City, UT (US); Manoranjan Minra, Salt Lake City, UT (US); Biplab Sarma, Salt Lake City, UT (US)

(21) Appl. No.: 14/762,705

(22) PCT Filed: Jan. 21, 2014
(86) PCT No.: PCT/US14/12355

§ 371 Date: Jul. 22, 2015

Related U.S. Application Data
(60) Provisional application No. 61/849,224, filed on Jan. 22, 2013.
(60) Provisional application No. 61/817,510, filed on Apr. 30, 2013.
(60) Provisional application No. 61/839,562, filed on Jun. 26, 2013.

(51) Int. Cl. B23K 20/12; B23K 20/22

(52) U.S. Cl. CPC B23K 20/12; B23K 20/22; B23K 20/1265

(57) ABSTRACT

Systems and methods for spot welding and seam welding an upper material layer to a lower material layer using a rod. The rod can be a non-consumable rod or a consumable rod.

### CROSS-REFERENCE TO RELATED APPLICATIONS

This application claims the benefit of the filing dates of U.S. Provisional Patent Application No. 61/849,224, filed Jan. 22, 2013, U.S. Provisional Patent Application No. 61/817,510, filed Apr. 30, 2013, and U.S. Provisional Patent Application No. 61/839,562, filed Jun. 26, 2013. Each of the above-referenced provisional patent applications is hereby incorporated by reference herein in its entirety.

### FIELD

This invention relates to systems and methods for spot welding a first material layer to at least one additional material layer, and to systems and methods for lap seam welding a first material layer to at least one additional material layer.

### BACKGROUND

### Spot Welding Methods

Currently known methods for obtaining lap joints between two or more materials include friction stir spot welding, resistance spot welding, laser spot welding, various arc welding processes, ultrasonic welding, and riveting.

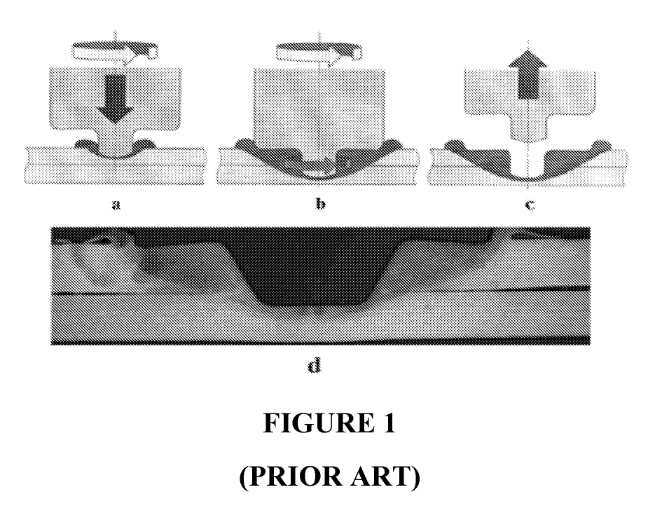

FIGS. 1A-1D depict the process of friction stir spot welding (FSSW), an off-shoot of friction stir welding (FSW). As shown, a typical FSSW sequence includes (A) plunging, (B) rotation, and (C) retraction. A cross-sectional image of a typical friction stir spot weld produced by the FSSW method is shown in FIG. 1D. As depicted, the FSSW weld is characterized by a hole (left when the pin is withdrawn) that inevitably remains at the center of the weld nugget. This hole has been found to limit the life of the welded components because of corrosion and other problems. The “refill mode” variation of FSSW utilizes a tool consisting of a pin, a shoulder, and an outside clamp to enable the capture of flash material extruded during a plunge sequence. The captured flash material is then deposited back into the exit hole to create a weld that is flush with the top surface. Although the “refill mode” eliminates the exit hole, the welds produced using the “refill mode” exhibit poor fatigue performance compared to conventional FSSW welds. Currently, the FSSW process is only applied to materials having low melting temperatures, such as Aluminum and Magnesium alloys. The use of FSSW process to weld harder materials such as steels, stainless steels, nickel-based alloys, and the like is limited due to the high cost of tool materials.

Although resistance spot welding does not suffer from the hole formation issues associated with FSSW methods, conventional resistance spot welds exhibit both physical deficiencies (for example, porosity and cracks) and metallurgical deficiencies (for example, micro-segregation and phase transformations). Steels with high carbon equivalents typically need additional post-weld annealing treatments. Some combinations of dissimilar metal spot welds can crack. Additionally, more energy is required to complete resistance spot welds of metals exhibiting high conductivity, such as copper and aluminum alloys.

Conventional laser spot welding techniques result in porosity in the joint formed between materials, especially in aluminum alloys, and high-strength materials (for example, steels) will crack due to fast cooling. Additionally, conventional laser equipment is costly. Arc welding processes, such as gas tungsten arc spot welding, gas metal arc spot welding, micro-plasma arc spot welding, and the like, exhibit both physical deficiencies (for example, porosity and cracks) and metallurgical deficiencies (for example, micro-segregation and phase transformations). Ultrasonic spot welding is typically limited to thin sheet metals that have thicknesses of less than 1 mm. Conventional riveting methods produce mechanical bonds rather than metallurgical bonds. The joints produced by such riveting methods are heavier and have comparatively poor performance compared to the joints produced by other conventional methods.

### Seam Welding Methods

Conventionally, a joint in which the work pieces are overlapped sufficiently to prevent the sheet edges from becoming part of the weld is classified as a lap seam weld. Conventional lap seam welding processes can be classified as fusion-based (including resistance seam, laser beam, electron beam, plasma arc welding, soldering, and brazing) and solid-state-based (including ultrasonic welding and roll bonding). The lap seam welds produced by conventional fusion-based methods are often associated with a variety of problems, including cracking, high porosity, deleterious metallurgical changes, and high residual stresses. Cracking, expulsion of molten metal, and unclean work-piece surfaces can all cause defective resistance seam welds. Limitations of ultrasonic seam welding include an inability to weld large and thick base metals and a tendency of base metals to bond to the anvil or sonotrode. Roll bonding (both cold and hot) involves heat treatment. Metals such as titanium and alloys are difficult to roll bond because of their reactivity and narrow working temperature range.

Conventionally, cladding refers to the deposition of a filler metal on a substrate metal to impart corrosion, wear resistance or some desired property that is not possessed by the substrate metal. Conventional cladding processes can be classified as fusion-based (including electric arc welding processes, brazing, electron beam welding, and laser beam welding) and solid-state welding processes (including explosive cladding, friction surfacing and roll bonding). The clad metals produced by conventional fusion-based methods are often associated with a variety of problems, including cracking, high porosity, deleterious metallurgical changes, and high residual stresses. High percentages of dilution (the amount of base metal in the clad metal) can occur in such fusion-based clad metals. Dilution percentages are typically very high in deposition arc cladding processes such as submerged arc, which is used extensively in the industry. Explosion cladding is typically restricted to metals with minimum ductility. Friction surfacing is limited by its inability to produce larger clad areas in less time. Roll cladding (both cold and hot) involves heat treatment. Metals such as titanium and alloys are difficult to roll clad because of their reactivity and narrow working temperature range.

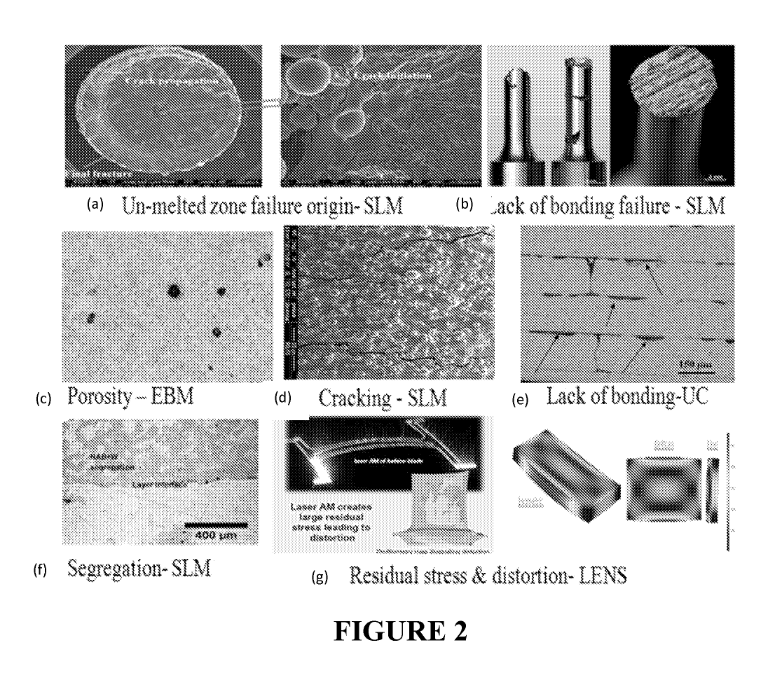

Additive manufacturing methods and additive and selective subtractive manufacturing methods are conventionally used to fabricate layered, multi-material structural components. Layer-by-layer fabrication of three-dimensional (3D) components can be directly fabricated from a computer-aided design (CAD) model of an object. Laser Engineered Net Shaping, Direct Metal Deposition, Selective Laser Melting, and Electron Beam Melting are among a number of processes being considered as additive manufacturing methods by which material addition is achieved through melting and solidification. Due to melting and solidification involved in these processes, the parts made by these techniques suffer from the following limitations (See FIGS. 2A-2G): 1) unmelted zones resulting in lack of bonding between powder particles; 2) porosity; 3) solidification cracking susceptibility; 4) a cast microstructure and micro-segregation leading to compositional in-homogeneities; 5) significant tensile residual stress build-up; 6) long production times for large components (often less than 1 gram/minute build rates); and 7) stiffness problems. Many dissimilar metal combinations cannot be deposited by these processes as the resultant deposited layers crack.

Solid-state additive manufacturing methods (where liquid to solid transformation is absent) have been used to address many of the shortcomings of liquid-to-solid-based additive manufacturing methods. Ultrasonic consolidation (UC) was the first solid state additive and selective subtractive manufacturing method to be commercialized, and was shown to overcome some of the limitations of fusion-based methods. In contrast to the fusion based additive manufacturing methods, UC is a typical additive and selective subtractive manufacturing method to build up a near-net shape part which is then machined to its final dimensions using an integrated, 3-axis CNC milling machine. However, UC suffers from its own major limitations, including the formation of inter-foil defects as shown in FIGS. 2A-2G. Further, in a UC process, if the substrate is not stiff enough, friction cannot develop between the foil being deposited and the substrate. Additionally, a conventional UC process is conducted at 300° F. by employing a heated base plate. A major limitation of this process is that it can be applied to metallic layers which are few microns thick. Therefore, it takes a significantly longer time to build 3D components. The application of conventional UC processes to higher strength alloys, such as titanium, is very much limited due to the resultant inconsistent bond-quality and poor through-thickness properties. UC processes require additional time to consolidate thicker sheets due to the difficult transfer of process parameters at the interface. Thus, conventional fusion-based and solid-state additive manufacturing methods and additive and selective subtractive manufacturing methods suffer from physical, metallurgical, and mechanical limitations.

Accordingly, there is a need in the pertinent art for systems and methods for forming strong lap joints between a variety of hard and soft materials while avoiding the physical and metallurgical deficiencies of conventional spot welding methods. There is a further need in the pertinent art for systems and methods for forming strong lap seam welds between a variety of hard and soft materials while avoiding the physical and metallurgical deficiencies of conventional seam welding methods. There is still a further need in the pertinent art for applying these lap seam welds in cladding and additive manufacturing applications.

### SUMMARY

Described herein, in one aspect, is a method of spot welding an upper material layer to a lower material layer relative to a welding axis. The upper material layer can be positioned in overlying relation to at least a portion of the lower material layer. The upper and lower material layers can have respective top and bottom surfaces. The method can include axially advancing and rotating a rod relative to the welding axis such that a distal end of the rod contacts the top surface of the upper material layer. The method can also include applying an axial force to the rotating rod such that frictional heat between the distal end of the rod and the upper material layer plasticizes a portion of the upper material layer. With the portion of the upper material layer plasticized, the method can further include applying the axial force to the rotating rod such that a portion of the bottom surface of the upper material layer and a portion of the top surface of the lower material layer are deformed, thereby forming a metallurgical bond between the upper and lower material layers. The method can further include axially retracting the rod relative to the welding axis such that the distal end of the rod is removed from contact with the top surface of the upper material layer. Optionally, the rod can be a consumable rod. It is contemplated that the rod can penetrate into at least a portion of the upper material layer. It is further contemplated that plasticized portions of the rod can fill the cavity prior to retraction of the rod.

Systems for implementing the disclosed spot welding method are also described. Such systems can include a rod having a longitudinal axis substantially axially aligned with the welding axis. The systems can also include means for selectively axially moving the rod relative to the welding axis and means for selectively rotating the rod about the longitudinal axis of the rod.

Described herein, in another aspect, is a method of lap seam welding an upper material layer to a lower material layer relative to a vertical axis (z-axis). The upper material layer can be secured in overlying relation to at least a portion of the lower material layer. The upper material layer and lower material layers can be positioned within a plane that is perpendicular to the vertical axis. The upper and lower material layers can be configured for movement along a weld traverse axis (x-axis) and a transverse axis (y-axis).

The method of lap seam welding can include: axially advancing and rotating a rod relative to the vertical axis such that a distal end of the rod contacts the top surface of the upper material layer and applying an axial force to the rotating rod such that frictional heat between the distal end of the rod and the upper material layer plasticizes a portion of the upper material layer. With a portion of the upper material layer plasticized, the method can include applying the axial force to the rotating rod such that a portion of the bottom surface of the upper material layer and a portion of the top surface of the lower material layer are deformed. The method can further include axially advancing the upper and lower material layers relative to the weld traverse axis by a desired length, thereby forming a metallurgical bond between the upper and lower material layers. Following completion of the weld, the method can include axially retracting the rod relative to the vertical axis such that the distal end of the rod is removed from contact with the top surface of the upper material layer. Multi-track seam welds can be formed by repeating the above steps after the upper and lower material layers are axially shifted relative to the transverse axis.

Systems for implementing the disclosed lap seam welding methods are also described. Such systems can include a rod having a longitudinal axis substantially axially aligned with the vertical axis. The systems can also include means for selectively axially moving the rod relative to the vertical axis, means for selectively rotating the rod about the longitudinal axis of the rod, and means for selectively axially moving the upper and lower material layers relative to the weld traverse axis (and, optionally, the transverse axis).

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

FIGS. 1A-1D depict an exemplary friction stir spot welding (FSSW) process as is known in the art. FIGS. 1A-1C depict the sequence of the FSSW process. FIG. 1D is a cross-sectional image of an exemplary FSSW weld.

FIGS. 2A-2G provide a series of images indicative of the shortcomings of conventional welding, cladding, and additive-manufacturing methods.

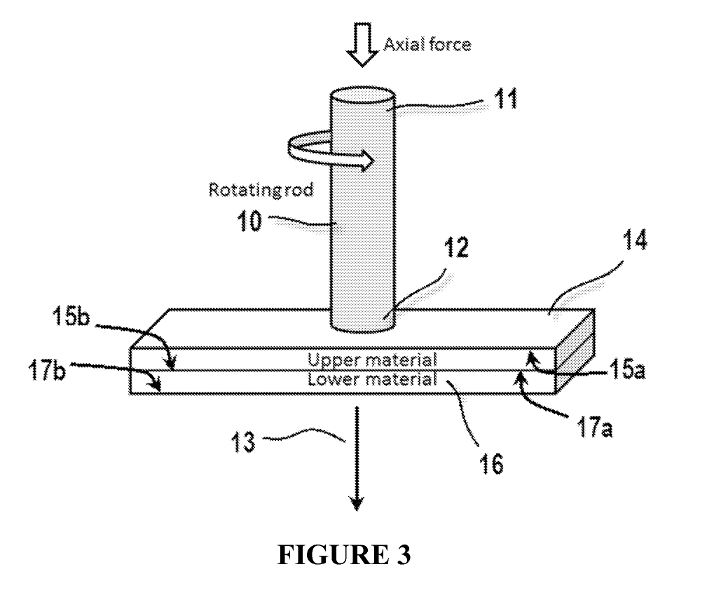

FIG. 3 is a schematic view of an exemplary rotating rod being used to spot weld an upper material layer to a lower material layer as described herein.

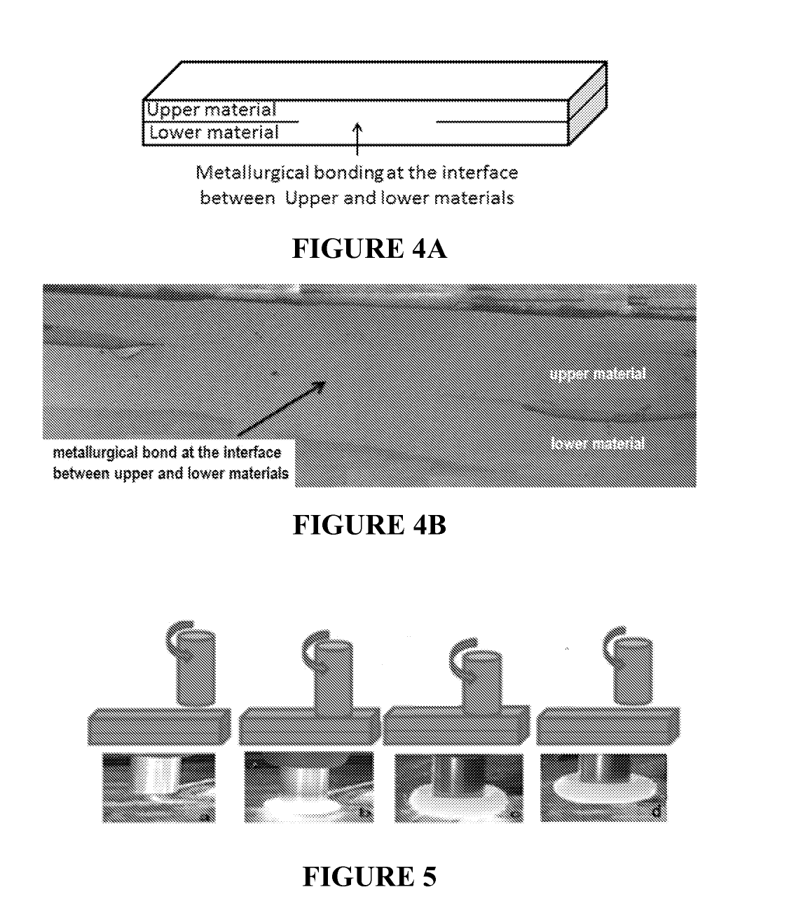

FIGS. 4A-4B are cross-sectional views of an exemplary weld formed using the friction spot welding methods described herein.

FIG. 5 is a schematic diagram depicting the sequential steps of an exemplary friction spot welding method as described herein.

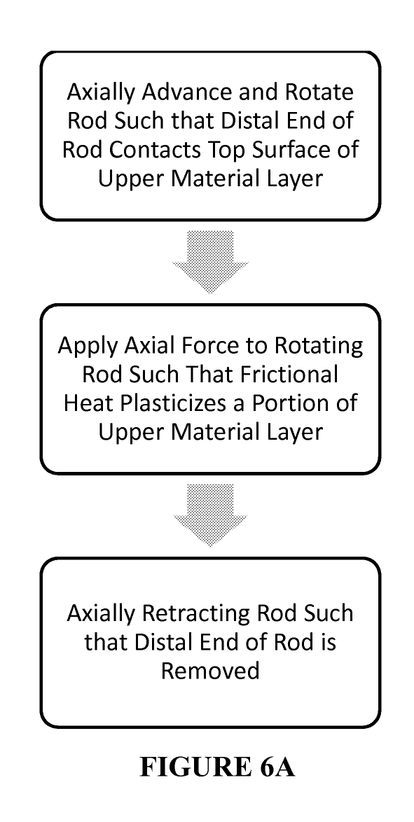

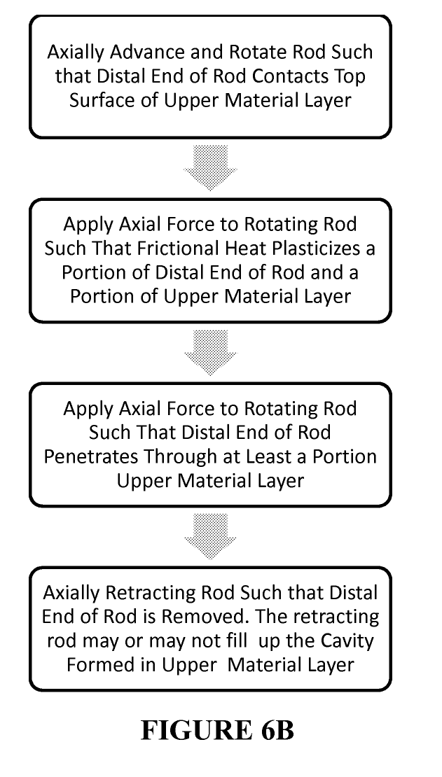

FIGS. 6A-6B are flowcharts depicting the steps of exemplary friction spot welding methods as described herein.

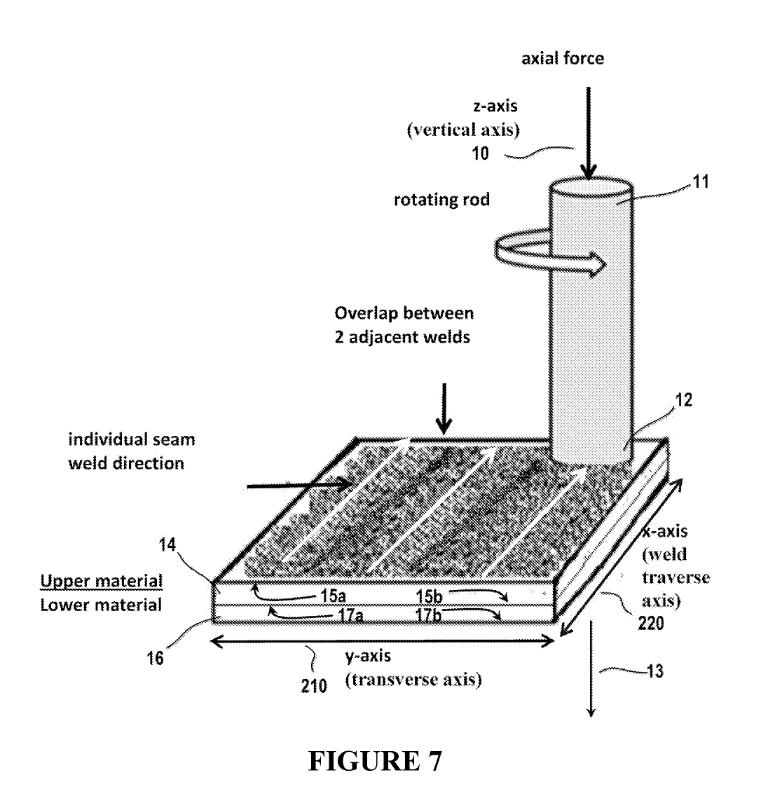

FIG. 7 is a schematic view of an exemplary rotating rod being used to lap-seam weld an upper material layer to a lower material layer as described herein.

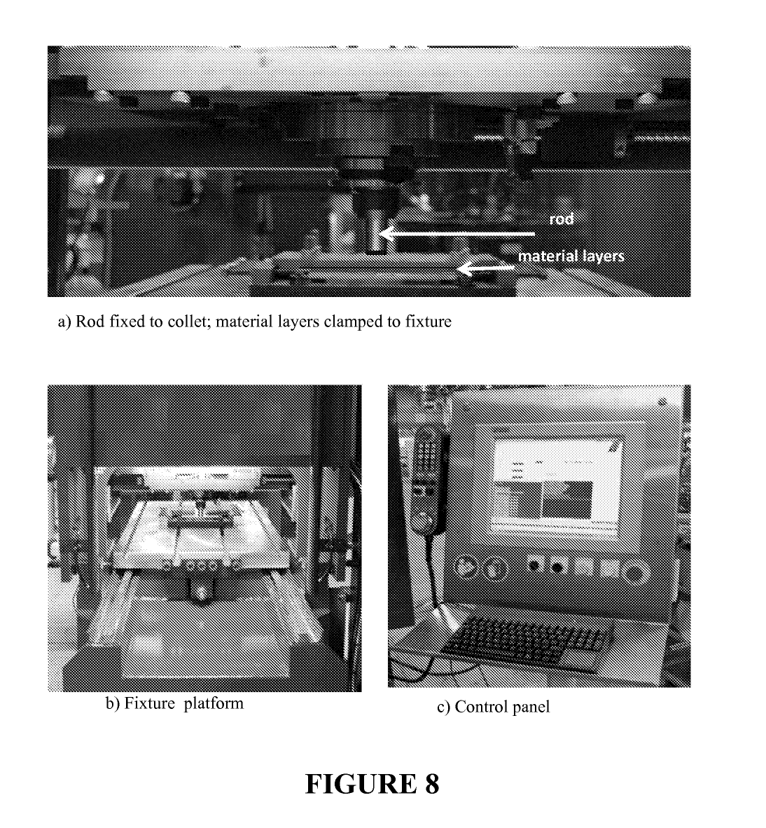

FIGS. 8A-8C provide images of (a) a rod and material layers, (b) a fixture platform, and (c) a control panel of an exemplary lap seam welding system as disclosed herein.

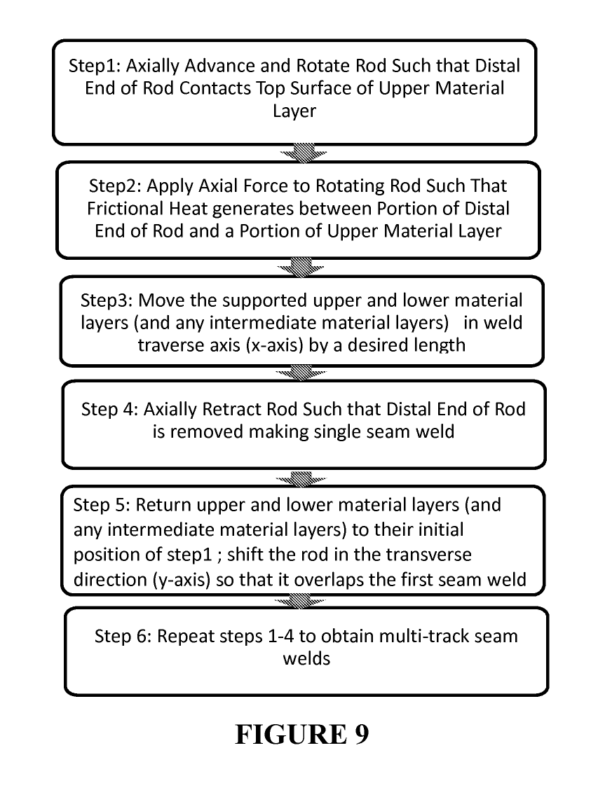

FIG. 9 is a flowchart depicting the steps of an exemplary lap seam welding method as described herein.

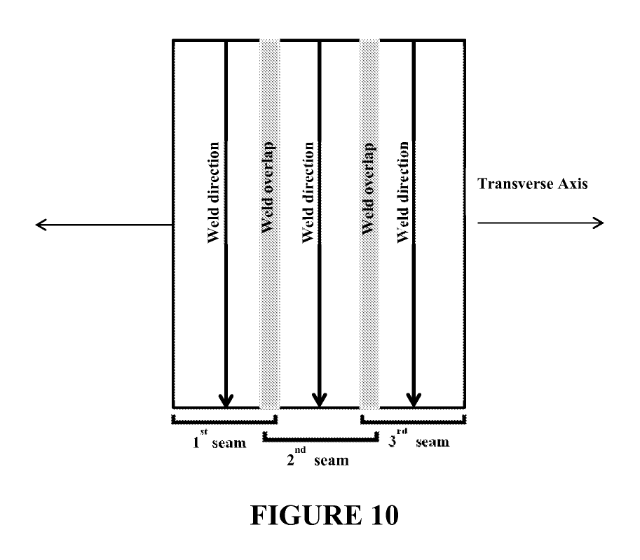

FIG. 10 is a schematic diagram depicting the formation of a multi-track lap seam weld as described herein.

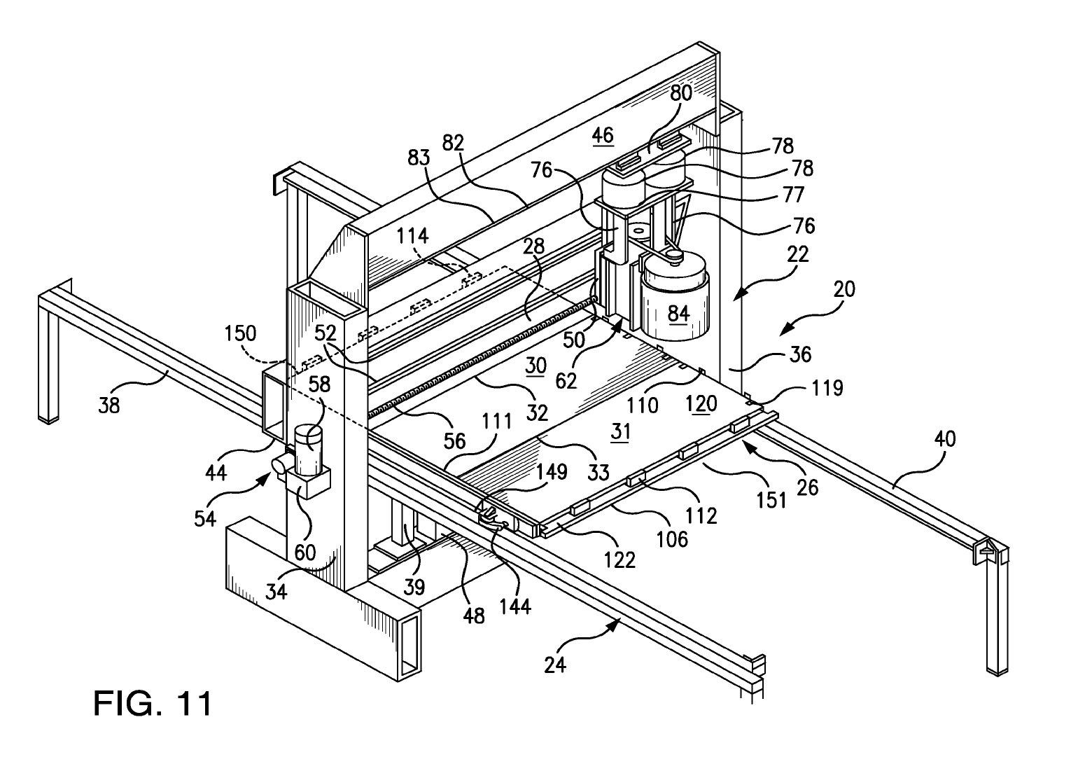

FIG. 11 is a perspective view of an exemplary system for performing the friction spot welding methods described herein.

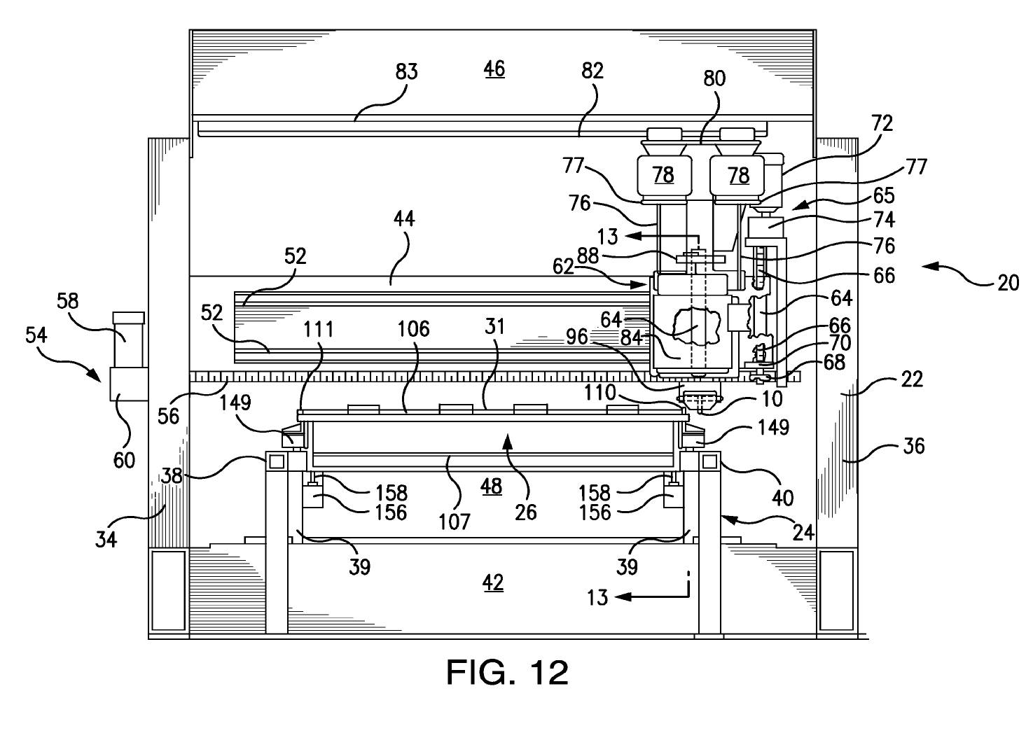

FIG. 12 is a side perspective view of the system of FIG. 11.

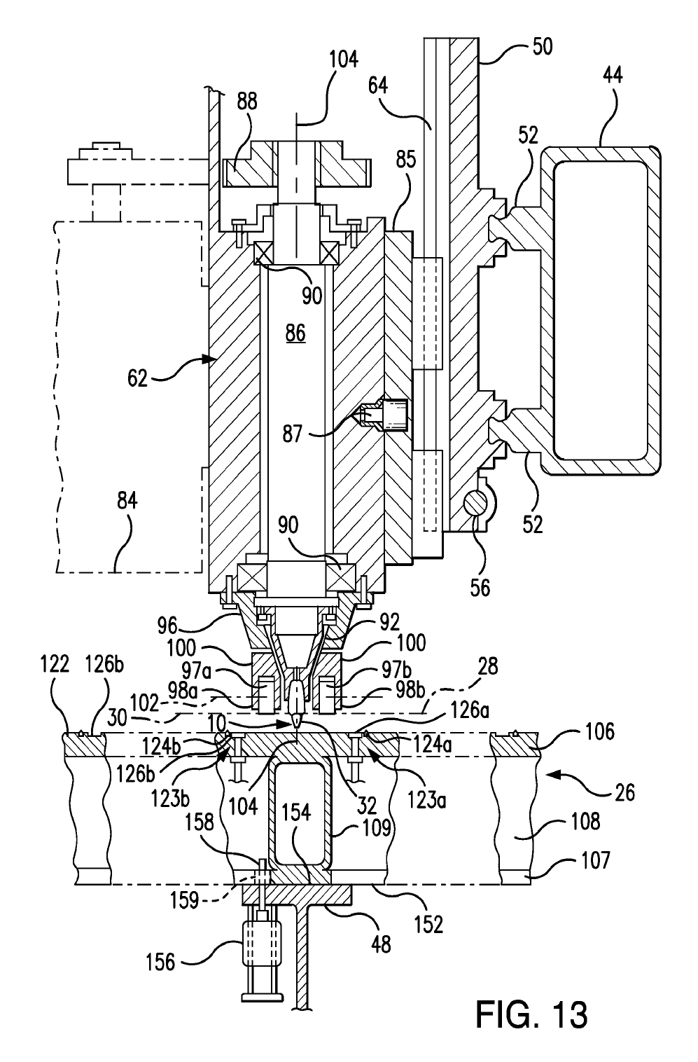

FIG. 13 is a cross-sectional view of the system of FIG. 12, taken at line 13-13.

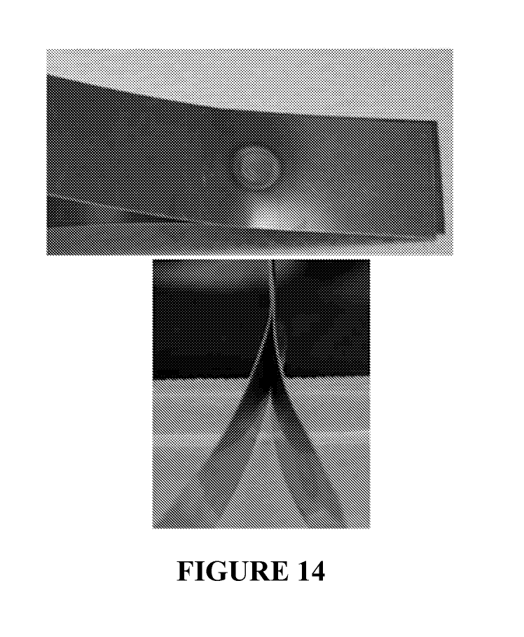

FIGS. 14-17 are images of exemplary spot welds achieved using consumable AISI 304 rods.

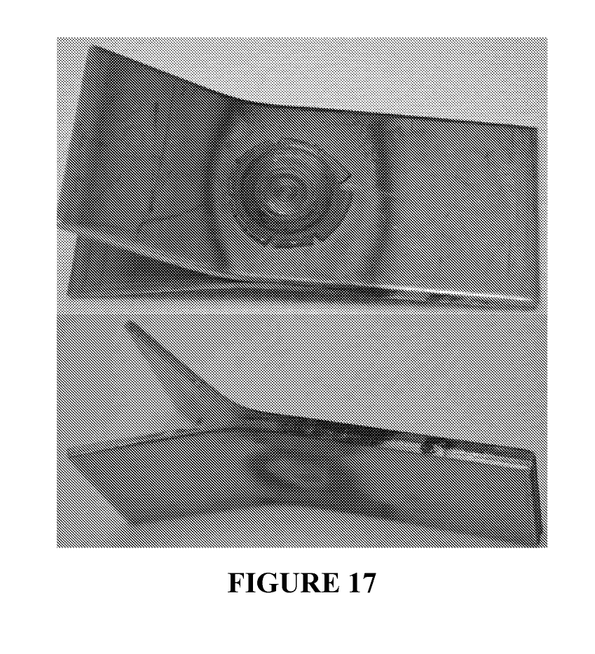

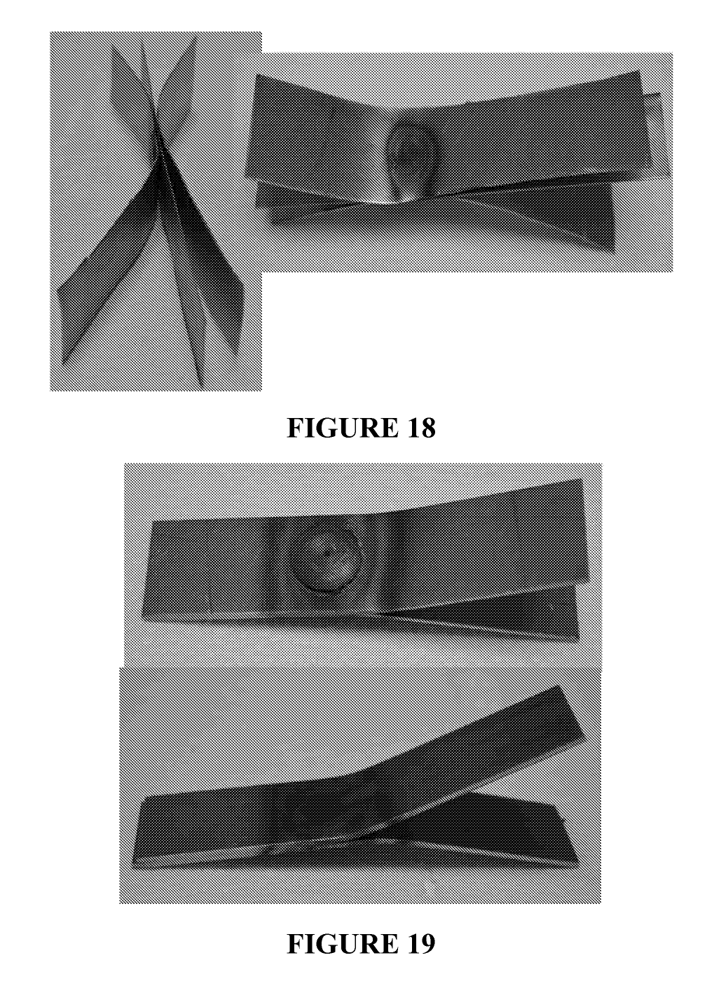

FIGS. 18-20 are images of exemplary spot welds achieved using consumable C—Mn steel rods.

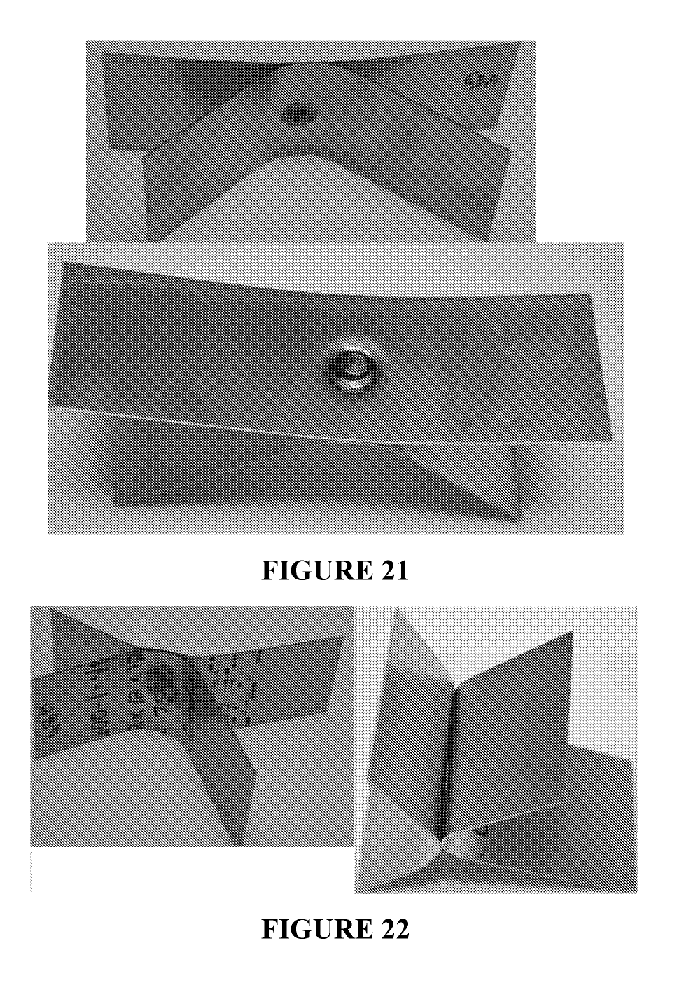

FIGS. 21-24 are images of exemplary spot welds achieved using consumable AISI 304 rods and consumable Inconel 718 rods.

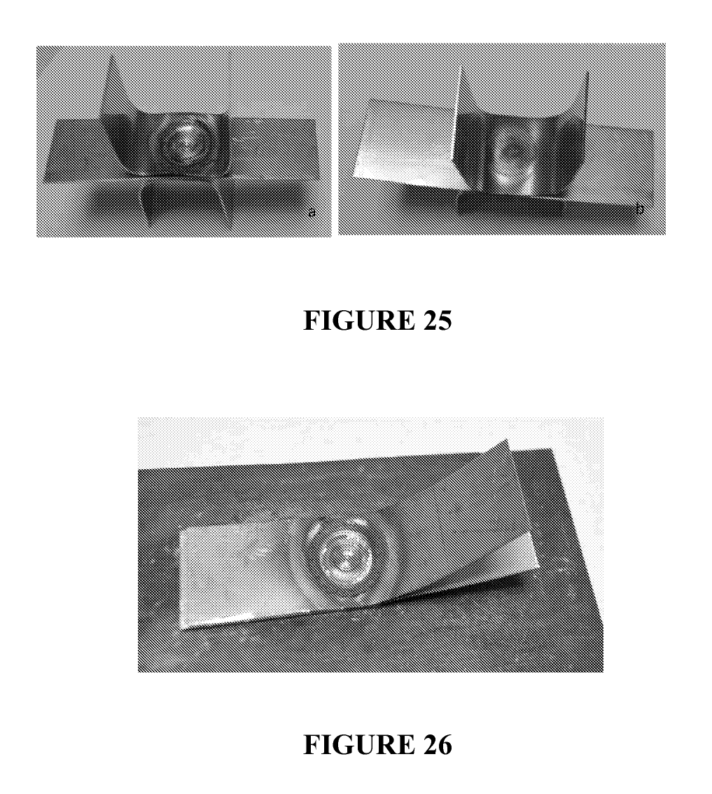

FIGS. 25-32 are images of exemplary spot welds achieved using nonconsumable commercially pure Molybdenum rods.

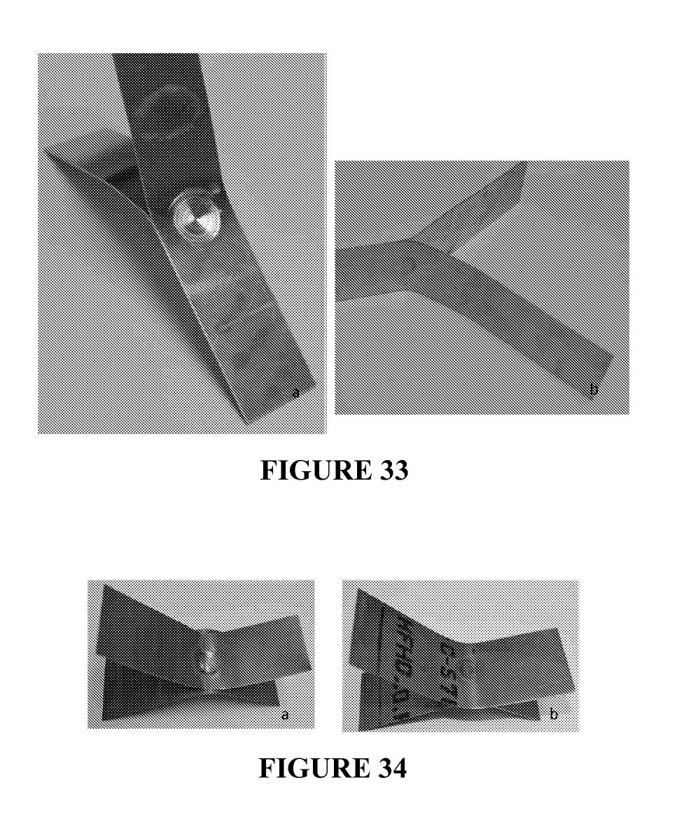

FIG. 33 is an image of an exemplary spot weld achieved between aluminum alloys using a nonconsumable AISI 304 rod.

FIGS. 34-36 are images of exemplary spot welds achieved between non-ferrous metallic sheets using nonconsumable AISI 304 rods.

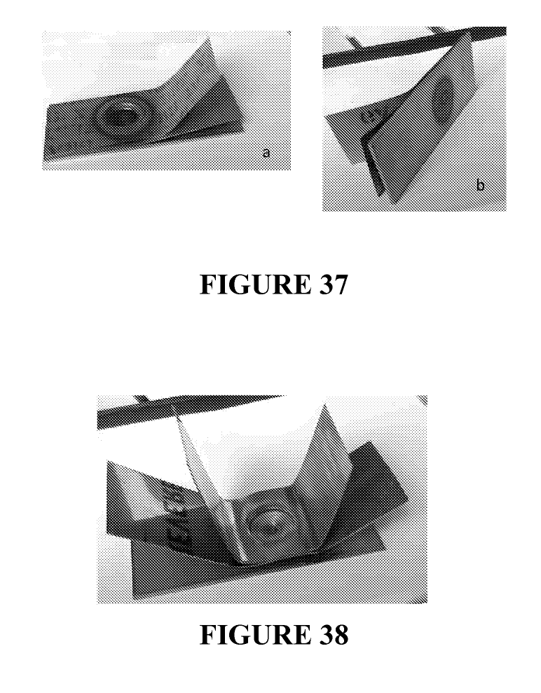

FIGS. 37-38 are images of exemplary spot welds achieved between dissimilar metallic sheets using nonconsumable AISI 304 rods.

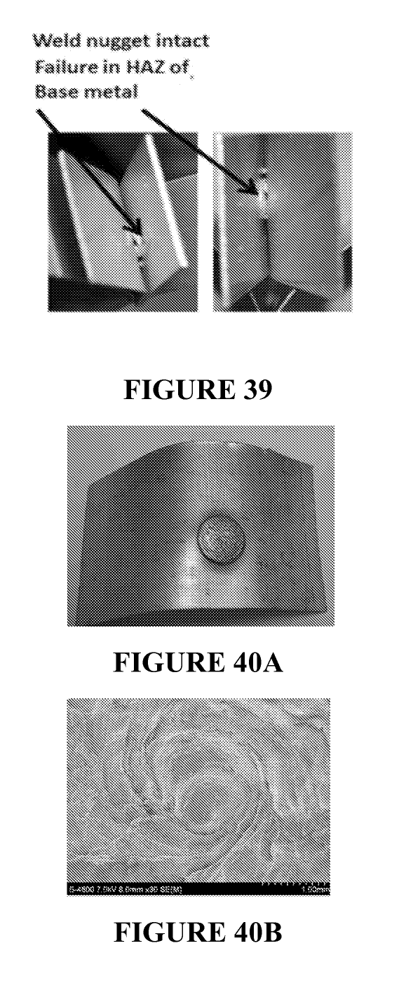

FIG. 39 displays images of exemplary spot welds achieved using the friction spot welding methods described herein, after the welds have been subjected to a peel-off test.

FIG. 40A displays an image of the bottom surface of an upper material layer of an exemplary weld between two CP Mg sheets. FIG. 40B displays a scanning electron microscopic image of the weld shown in FIG. 40A.

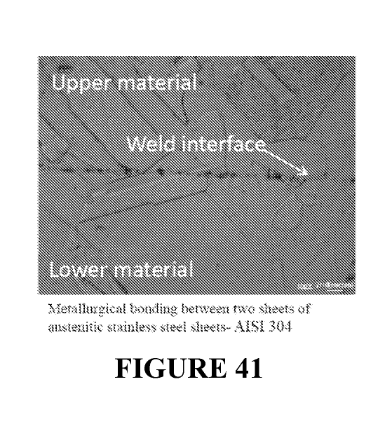

FIG. 41 displays cross-sectional images of exemplary spot welds achieved using the friction spot welding methods described herein.

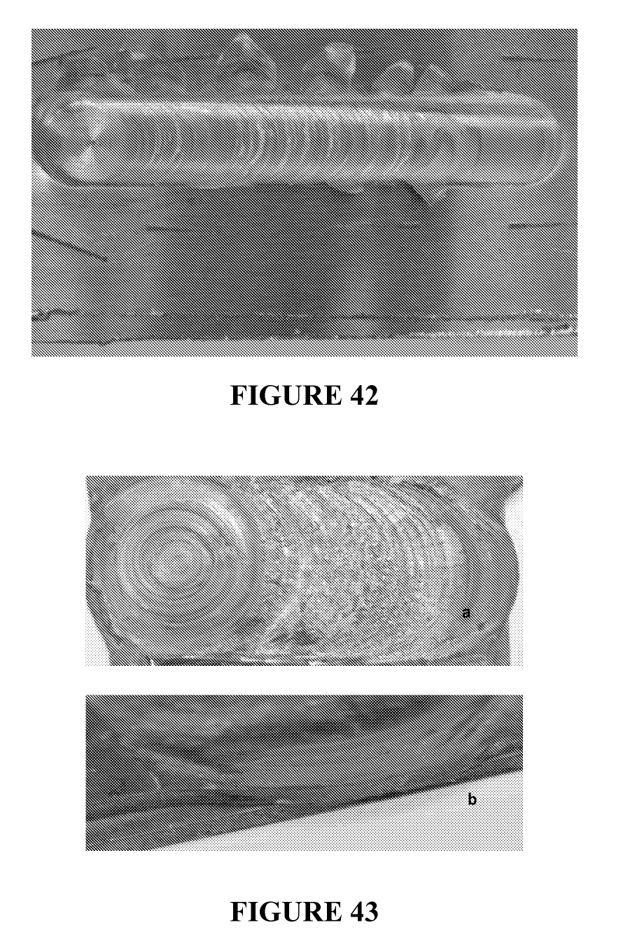

FIGS. 42-45 are images of exemplary friction seam welds (single track) for joining metals.

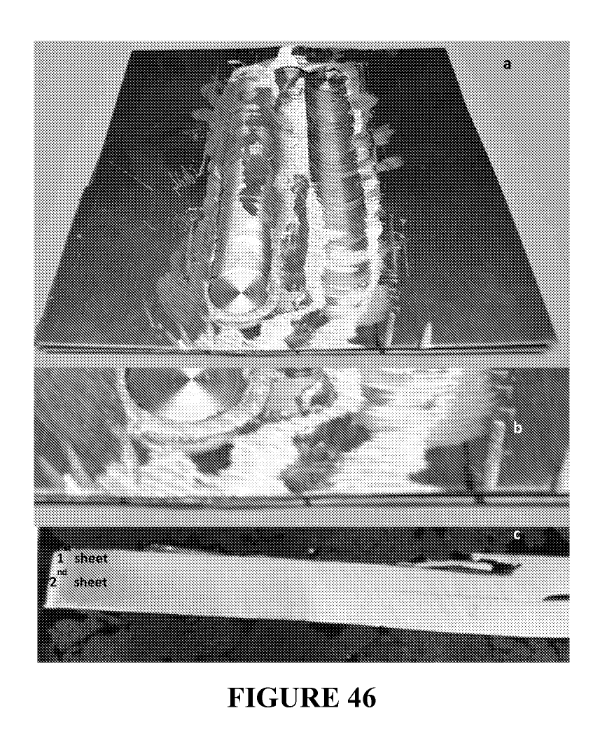

FIGS. 46A-50B are images of exemplary friction seam welds (multi-tracks) between materials having similar chemical compositions for additive manufacturing applications.

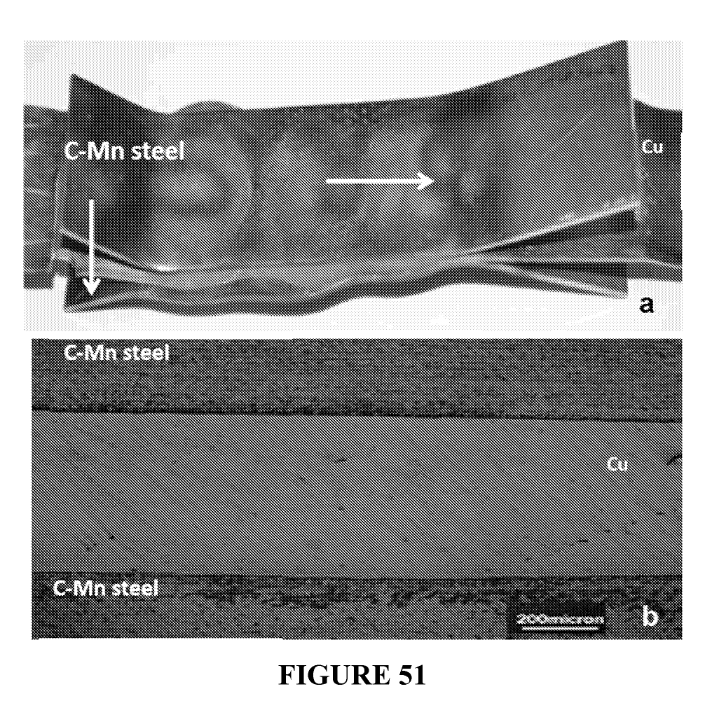

FIGS. 51A-53B are images of exemplary friction seam welds (single seam) between dissimilar chemical composition materials for additive manufacturing applications.

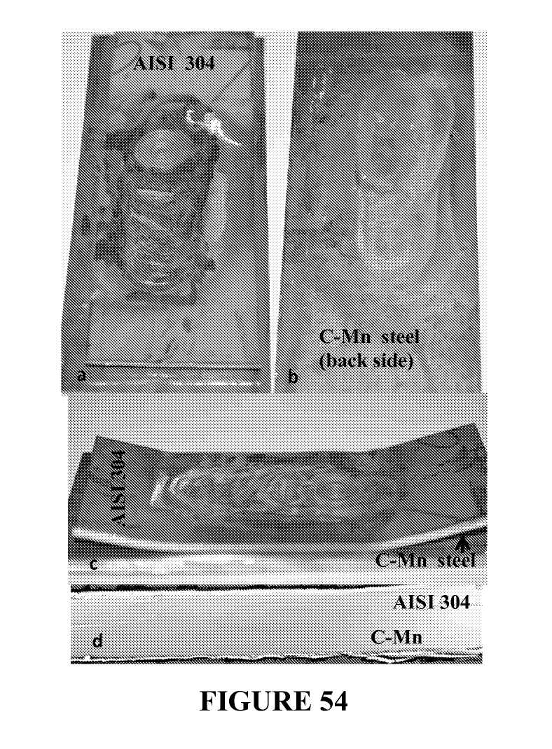

FIGS. 54A-57B are images of exemplary friction seam welds for cladding applications.

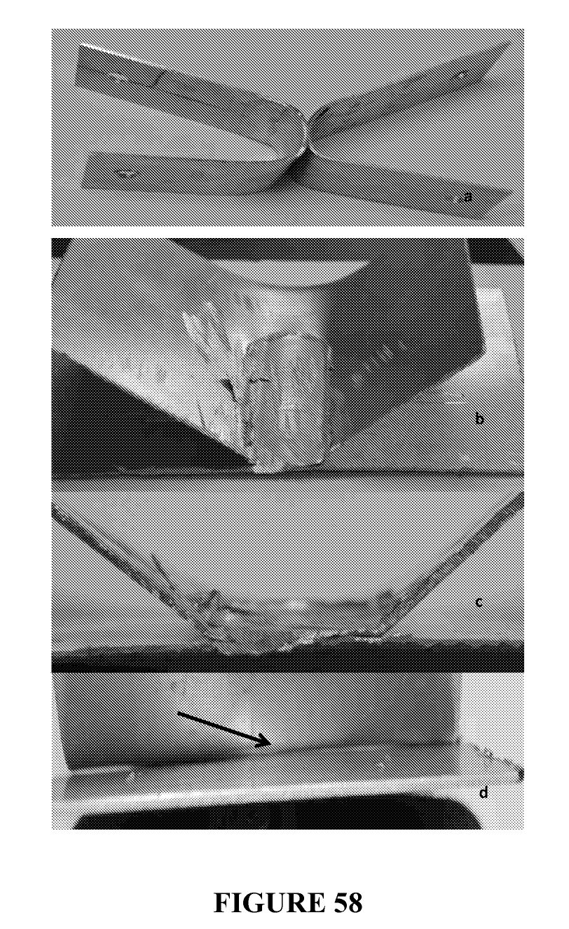

FIGS. 58A-61 are images showing the appearance of various friction seam welds following bend testing.

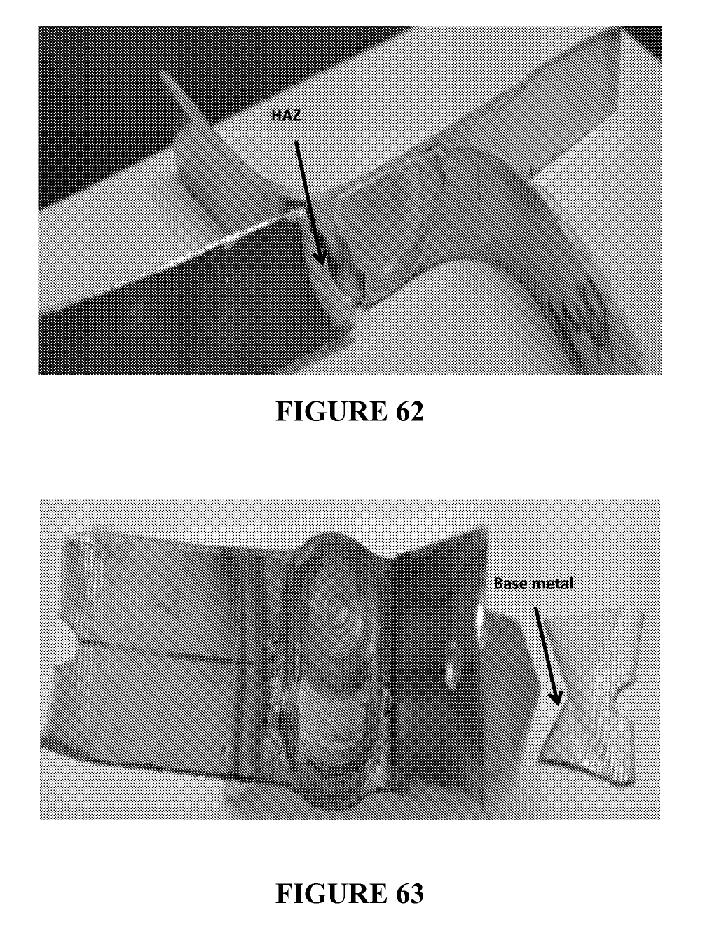

FIGS. 62-65C are images showing the appearance of various friction seam welds following shear testing.

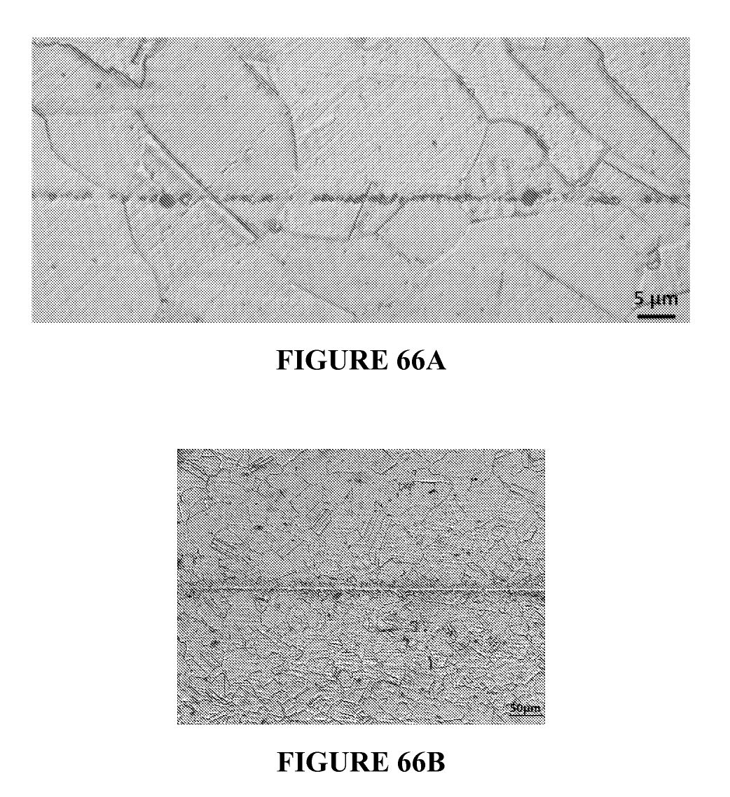

FIGS. 66A and 66B display cross-sectional images of exemplary seam welds achieved between similar materials using the friction seam welding methods described herein.

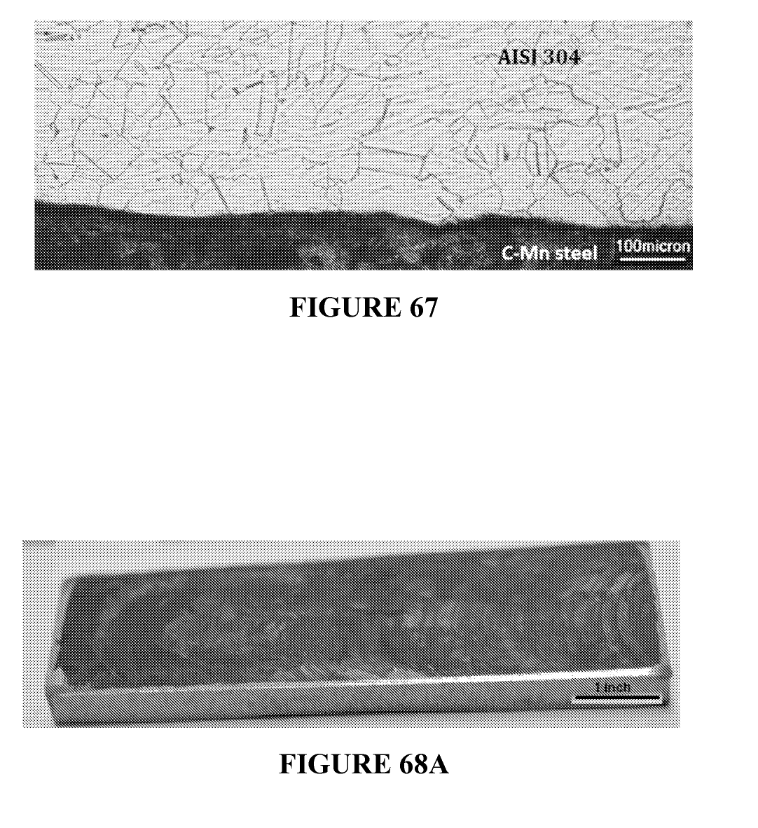

FIG. 67 is a cross-sectional image of an exemplary friction seam weld between a cladding layer and a substrate layer, following corrosion testing.

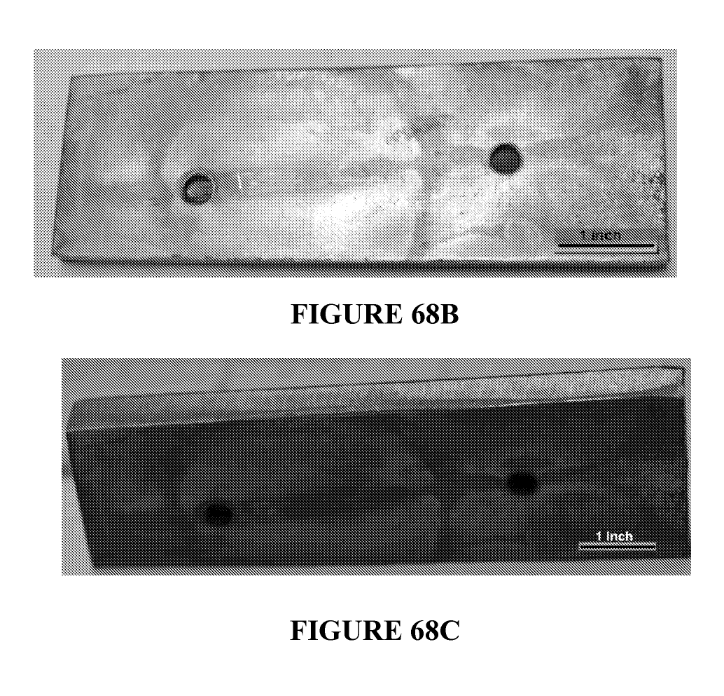

FIGS. 68A-68C depict a single seam weld between an upper material layer and a lower material layer with a milled micro-channel.

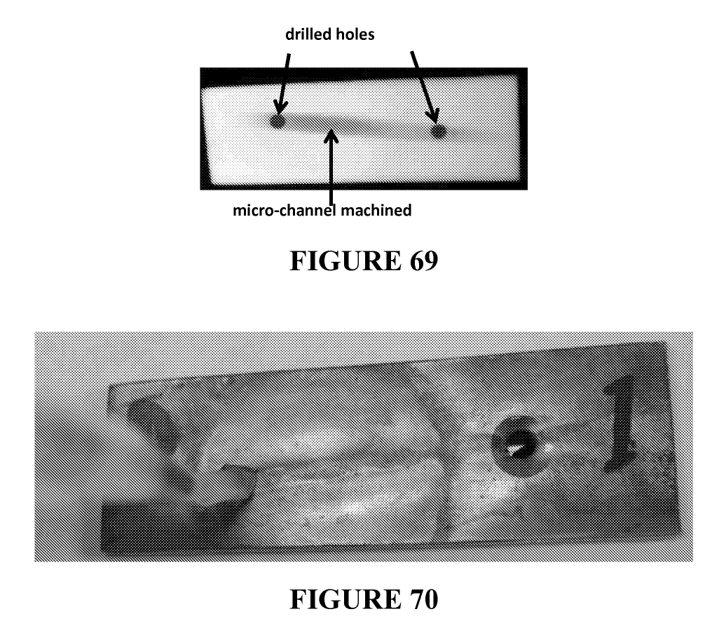

FIG. 69 depicts a radiographic image of the seam weld of FIGS. 68A-68C.

FIG. 70 depicts water exiting the micro-channel of the seam weld of FIGS. 68A-68C.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not limitation thereof.

As used throughout, the singular forms “a,” “an” and “the” include plural referents unless the context clearly dictates otherwise. Thus, for example, reference to “a rod” can include two or more such rods unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

As used herein, the terms “plasticize” and “plasticization” refer to extensive deformation and softening of a rod, material layer, and/or other metallic or synthetic metal materials.

Described herein with reference to FIGS. 3-6B and 11-13 are systems and methods for spot-welding an upper material layer 14 to a lower material layer 16 relative to a welding axis. The upper material layer 14 can be positioned in overlying relation to at least a portion of the lower material layer 16. Optionally, in one aspect, it is contemplated that one or more edges of the upper material layer 14 can be substantially aligned with one or more corresponding edges of the lower material layer 16. In another aspect, the upper and lower material layers 14, 16 can have respective top and bottom surfaces (15a, 15b for the upper material layer, and 17a, 17b for the lower material layer). In exemplary aspects, it is contemplated that the upper and lower material layers 14, 16 can be provided in the form of a sheet. However, it is contemplated that the upper and lower material layers 14, 16 can be provided in any form that permits at least a portion of the upper material layer to overlie at least a portion of the lower material layer such that the upper material layer can be welded to the lower material layer. It is further contemplated that one or more intermediate material layers can be provided in between the upper and lower material layers 14, 16 without affecting the ability of the disclosed systems and methods to form a spot weld between the upper and lower material layers.

It is contemplated that the systems and methods disclosed herein can achieve stronger spot welds than can be achieved using conventional welding methods, without leaving a hole in the welded materials. It is further contemplated that the systems and methods disclosed herein can be used to weld together a larger variety of materials (including, for example, hard metals and high-conductivity materials) than can be welded together using conventional methods. It is still further contemplated that the systems and methods disclosed herein can be used in a variety of industrial welding applications, including, for example and without limitation, welding applications in the automotive, aircraft, aerospace, nuclear, marine, chemical, and processing industries.

### Friction Spot Welding Systems

In exemplary aspects, a spot welding system for welding an upper material layer 14 to a lower material layer 16 relative to a welding axis can be provided. In one aspect, the spot welding system can comprise a rod 10 having a collet end 11, an opposed distal end 12, and a longitudinal axis 13. In this aspect, the rod 10 can have a diameter ranging from about 5 mm to about 25 mm. It is contemplated that, prior to formation of a spot weld using the rod 10 as disclosed herein, the rod can have a longitudinal length ranging from about 50 mm to about 100 mm (from the collet end 11 to the distal end 12 of the rod). It is further contemplated that the longitudinal axis 13 of the rod 10 can be substantially axially aligned with the welding axis. In exemplary aspects, the rod 10 can be axially tapered relative to its longitudinal axis 13. Although generally depicted and described herein as a substantially cylindrical rod having a circular cross-section, it is contemplated that the rod 10 can have any selected cross-sectional shape, including, for example and without limitation, rectangular, square, and elliptical cross-sectional shapes. Optionally, in some aspects, the rod 10 can be a non-consumable rod. Alternatively, in other optional aspects, it is contemplated that the rod 10 can be a consumable rod.

In another aspect, the spot welding system can comprise means for selectively axially moving the rod 10 relative to the welding axis. In this aspect, it is contemplated that the means for selectively axially moving the rod 10 can be configured to apply an axial force to the rod relative to the welding axis. It is further contemplated that the axial force can range from about 1,000 Newtons (N) to about 25,000 N. Exemplary means for selectively axially moving the rod 10 comprise, for example and without limitation, axial spindles, servo-motors, and other motorized/axially translational mechanisms as are conventionally known in the art. In an additional aspect, the spot welding system can comprise means for selectively rotating the rod 10 about the longitudinal axis of the rod. In this aspect, it is contemplated that the means for selectively rotating the rod 10 can be configured to rotate the rod at a rotational rate ranging from about 1,000 rotations per minute (RPM) to about 3,000 RPM. Exemplary means for selectively rotating the rod 10 comprise, for example and without limitation, rotational spindles, servo-motors, and other motorized/rotationally translational mechanisms as are conventionally known in the art.

In exemplary aspects, it is contemplated that the spot welding system can comprise a conventional welding machine that is configured to selectively move and rotate a rod as disclosed herein. Exemplary welding machines for use as disclosed herein include, for example and without limitation, an RM-1 model friction stir welding machine (Manufacturing Technology, Inc.), and a friction stir welding machine as disclosed in U.S. Pat. No. 6,554,175 and U.S. Patent Application Publication No. 2003/0209586, both of which are incorporated by reference herein in their entirety.

Thus, in exemplary aspects, and with reference to FIGS. 11-13, the spot welding system can comprise a welding machine 20 comprised of a frame or gantry 22 and a base 24 extending therethrough. The base 24 can support a work table 26 that is slidable (manually or automatically) along the length of the base 24 in a generally horizontal direction. The work table 28 can support various material layers (shown as 28, 30, 31), which can be secured adjacent each other using the methods disclosed herein to form joints 32, 33. Friction spot welding the material layers 28, 30, 31 along the joints 32, 33 as disclosed herein can secure the parts 28, 30, 31 together in a unitary piece. The gantry 22 can have a pair of columns or uprights 34, 36 that are spaced outside of, but adjacent to, lateral side rails 38, 40 of the base 24. The columns 34, 36 can be joined together by lower, intermediate and upper cross members or cross rails 42, 44, 46, respectively. An anvil 48 can be rigidly connected to the top of the lower cross member 42. Each of the side rails 38, 40 can be joined to the lower cross member 42 by a post 39 to connect the frame 22 and base 24 into a unitary structure. A spindle carriage or slide 50 can be mounted to the intermediate cross member 44 by means of a pair of linear guides or bearings 52. The spindle carriage 50 can also be operatively connected to a drive 54 providing motion of the linear carriage 50 in a generally horizontal direction substantially perpendicular to the longitudinal side rails 38, 40 of the base 24. The drive 54 can be of various known types, but the illustrated drive 54 is a five ton “ComDRIVE ACTUATOR” commercially available from Joyce Dayton of Dayton, Ohio. The drive 54 can use a jack or screw 56 having one end rotatably mounted in a bearing attached to the column 36. A nut (not shown) can be attached to the rear side of the spindle carriage 50 in a known manner. The drive 54 can further include a source of power 58, for example, a three horsepower AC induction motor, that is coupled to an opposite end of the screw 56 by a mechanical coupling, for example, a worm gear 60 commercially available from Cincinnati Electric of Cincinnati, Ohio. The drive 54 can be capable of providing a horizontal drive force of approximately 10,000 pounds.

A spindle or tool head 62 can be slidably mounted to the spindle carriage 50 by linear guides or bearings 64. Referring to FIG. 12, a pair of linear guides 64 can be used; and the guides 64 can be positioned laterally on opposite sides of the spindle carrier 50. The spindle 62 can be operatively connected to a second drive 65 for moving the spindle 62 in a generally vertical linear path substantially perpendicular to the spindle carriage guides 52 and the longitudinal side rails 38, 40 of the base 24. The second drive 65 can be of various known types, but the illustrated drive 65 has a screw 66 rotatably mounted at its upper end to the spindle carriage 50. The spindle 62 can be moved vertically by a nut (not shown) that carries a bracket 70 rigidly connected to the spindle 62. Referring to FIG. 12, a power source 72, for example, a one horsepower electric motor, can be mechanically coupled to an upper end of the screw 66 through a gear box 74. Thus, rotation of the motor 72 and screw 66 can be operative to move the nut 68 that carries the bracket 70 and spindle 62 in a generally vertical direction.

The spindle 62 can be rigidly connected to a lower end of a pair of rods or brackets 76 that have upper ends connected to movable portions 77 of respective drive 78. The drive 78 can function as a weld force generator and is comprised of a pair of power actuators, for example, air stroke actuators Model No. 1T15S-6 commercially available from Firestone of Carmel, Ind. It is contemplated that the air stroke actuators 78 can have a desirable characteristic of having a limited stroke or displacement within their total range of displacement in which they apply a relatively constant force through that limited displacement. Thus, through that limited displacement, it is contemplated that the force being applied by the actuators is a known, relatively constant magnitude and is applied independent of any deflections in the structure of the machine. The actuators 78 can have movable portions 77 rigidly connected to a plate 80 that is slidably mounted to the upper cross member 46 by means of a linear guide 82. The linear guide 82 can be located substantially along a longitudinal centerline of a lower surface 83 of the upper cross member 46. The linear guides 52, 64, 82 can be known devices such as Tompson linear guides commercially available from Tompson of Port Washington, N.Y.

With reference to FIGS. 12-13, it is contemplated that the rod 10 can be oriented perpendicularly or at a slight angle, for example, between 0 and 4 degrees, relative to the top surface of the upper material layer. Angular orientation of the rod 10 can be accomplished by rotating the spindle 62 clockwise through a small angle about an axis of rotation parallel to the side rails 38, 40. Referring to FIG. 13, the spindle 62 can be pivotally mounted to a plate 85 by means of a pivot pin 87; and the plate 85 can be mounted to the linear guides 64 on the spindle carriage 50. Thus, the spindle 62 and rod 10 can be angularly displaced, for example, up to five degrees, and clamped to the plate 85 by bolts or other means.

The rod 10 can be powered by a spindle motor 84, for example, a 25 horsepower motor commercially available from Cincinnati Electric mounted on the spindle 62. Referring to FIG. 13, the spindle motor 84 can be rotatably coupled to an upper end of a spindle shaft 86 by means of a belt drive 88. The spindle shaft 86 can be rotatably mounted in the spindle 62 by bearings 90. A tool holder 92 (for holding the rod 10) can be mounted to a lower end of the spindle shaft 86, and the rod 10 can be mounted within the tool holder 92. The tool holder 92 can be made from a material having a low thermal conductivity, for example, stainless steel, so that only minimal heat from the welding process and in the rod 10 can be conducted to other components, for example, the bearings 90, of the spindle 62. A spindle cover 96 can also be connected to the lower end of the spindle 62 and can cover a portion of the lower end of the spindle shaft 86. Rollers 97a, 97b can be rotatably mounted in a roller support or truck 100 on respective axles or pins 98a, 98b. The lower end of the spindle cover 96 can have a generally U-shaped clevis. The roller truck 100 can be pivotally mounted within the clevis of the spindle cover 96 by a pair of shoulder bolts that extend through clearance holes in opposed arms of the clevis and are threaded into opposite sides the spindle cover 96. One of the rollers 97a, 97b can be located on each side of the tool 10 and the joint 32. Referring to FIG. 13, the rollers 97a, 97b can contact the upper surfaces of the respective material layers 28, 30. The rollers 97 can turn about an axis of rotation 102 that is substantially perpendicular to the axis of rotation 104 of the rod 10 and substantially parallel to the longitudinal side rails 38, 40 (FIG. 11) of the base 24.

In exemplary aspects, it is contemplated that the spot welding system can comprise processing means for effecting movement and rotation of the rod 10 as described herein. In these aspects, it is contemplated that the processing means can comprise a computer having a processor. It is further contemplated that the processor can be configured to cause the spot welding system to effect movement and/or rotation in a desired manner according to preset parameters, including, for example and without limitation, rotation rate, plunge depth, feed rate, applied axial force, and the like. It is still further contemplated that the processing means can comprise a control panel positioned in operative communication with the processor such that a user can selectively adjust the operating parameters of the seam welding system. In further exemplary aspects, it is contemplated that the computer can have a memory in operative communication with the processor. In these aspects, it is contemplated that the memory can be configured to store predetermined system parameters, such as, for example and without limitation, rotation rate, plunge depth, feed rate, applied axial force, and the like.

### Friction Spot Welding Methods

In operation, and with reference to FIGS. 3-6B, the spot welding system can be used in a method of spot welding the upper material layer to the lower material layer relative to the welding axis. In one aspect, the method of spot welding can comprise axially advancing and rotating the rod relative to the welding axis such that the distal end of the rod contacts the top surface of the upper material layer. In another aspect, the method of spot welding can comprise applying an axial force to the rotating rod such that frictional heat between the distal end of the rod and the upper material layer plasticizes a portion of the upper material layer. Optionally, in still another aspect, when the rod is a consumable rod, it is contemplated that the method of spot welding can comprise applying an axial force to the rotating rod such that frictional heat between the distal end of the rod and the upper material layer plasticizes a portion of the distal end of the rod and a portion of the upper material layer.

With a portion of the upper material layer plasticized, the method of spot welding can further comprise applying the axial force to the rotating rod such that a portion of the bottom surface of the upper material layer and a portion of the top surface of the lower material layer are deformed. It is contemplated that this deformation at the interface between the upper and lower material layers can result in a metallurgical bond between the upper and lower material layers.

It is contemplated that the sudden rise in temperature at the distal end of the rod and the upper material layer can result in extensive plastic deformation. It is further contemplated that this sudden rise in temperature can be due to the adiabatic heating resulting from viscous heat dissipation during plastic deformation. In operation, the rod can rotate at a given rotational rate, and an axial load applied to the rod can impart rotational force to the plasticized metal on the top surface of the upper sheet. It is contemplated that the imparted rotational force can cause elasto-plastic deformation due to the shear forces at the interface between the bottom surface of upper material layer and top surface of lower material layer. More particularly, tangential (centrifugal or rotational) forces can lead to the formation of spiral flow lines between a center portion of the material layers and the peripheral portions of the material layers. (See FIGS. 40A-40B). It is further contemplated that highly localized stick and slip at the interface can break up surface oxides and surface films. This, in turn, can facilitate metal-to-metal contact between contacting surfaces at the interface. The metal-to-metal contact area can grow due to the continued stick and slip mechanism, resulting in a continuous metallurgically bonded interface. Additionally, it is contemplated that there can be a rise in localized temperature at the interface between the upper and lower material layers due to the combined effects of conduction (imparted from the rotating plasticized metal), interfacial stick-slip mechanism, and plastic deformation. It is further contemplated that this rise in temperature at the interface can help solid state diffusion to take place at the interface between the upper and lower material layers. Thus, the metallurgical bonding at the interface between the upper and lower material layers can result from one or more operating mechanisms, including localized stick and slip at the interface, which tends to break up surface oxides and surface films, and diffusion between the upper and lower material layers while they are held together under high axial force applied through the rod. FIG. 4B depicts the metallurgical bond between austenitic stainless steel material layers. As depicted, there is complete bonding between the material layers at the interface. FIG. 41 provides an image of the microstructure near the interface between the upper and lower material layers. The image displays discrete oxide particles embedded in the matrix, indicating that the stick-slip mechanism caused a break up of surface oxide. The grains extending from one material layer to the other material layer are indicative of the diffusion between the two material layers.

In one exemplary aspect, it is contemplated that at least one intermediate material layer can be positioned between the upper and lower material layers. In this aspect, it is contemplated that, with a portion of the upper material layer plasticized, the method of spot welding can further comprise applying the axial force to the rotating rod such that a portion of the bottom surface of the upper material layer and a portion of a top surface of an intermediate material layer are deformed. Application of the axial force can continue until a bottom surface of the at least one intermediate material layer and the top surface of the lower material layer are deformed. It is further contemplated that this deformation at the interface between the various material layers can result in metallurgical bonds between the upper and intermediate material layers and between the intermediate and lower material layers. When more than one intermediate material layer is used, metallurgical bonds can form between the various intermediate material layers.

In a further aspect, the method of spot welding can comprise axially retracting the rod relative to the welding axis such that the distal end of the rod is removed from contact with the top surface of the upper material layer.

Optionally, in one aspect, when the rod is a consumable rod, the step of applying the axial force to the rotating rod can comprise applying an axial force to the rotating rod such that frictional heat between the distal end of the rod and the upper material layer plasticizes a portion of the distal end of the rod. In this aspect, it is further contemplated that, with a portion of the distal end of the consumable rod and a portion of the upper material layer plasticized, the axial force can be applied to the rotating rod such that the distal end of the rod penetrates through at least a portion of the upper material layer, thereby defining a cavity. It is still further contemplated that the plasticized portion of the distal end of the rod can fill the cavity prior to retraction of the rod from the upper material layer. It is still further contemplated that, following retraction of the rod such that the distal end of the rod is removed from the cavity, the longitudinal length of the rod can range from about 45 mm to about 90 mm.

It is contemplated that the plasticized portions of the distal end of the rod (which fill the cavity) can remain separated from the plasticized portions of the upper material layer. However, in some exemplary applications, it is contemplated that a small intermixed zone (within a few micrometers in thickness) comprising a mixture of the plasticized portions of the rod and the plasticized portions of the upper material layer can be formed.

In exemplary aspects, the upper material layer and the lower material layer can have respective thicknesses. In these aspects, it is contemplated that the thickness of the upper material layer and the thickness of the lower material layer can both range from about 0.5 mm to about 3.25 mm. In one aspect, the thickness of the upper material layer can be substantially equal to the thickness of the lower material layer. Alternatively, in another aspect, the thickness of the upper material layer can be greater than the thickness of the lower material layer. In still another aspect, it is contemplated that the thickness of the upper material layer can be less than the thickness of the lower material layer.

In exemplary aspects, the longitudinal axis of the rod can be substantially perpendicular to the top surface of the upper material layer (and substantially axially aligned with the welding axis) when the distal end of the rod contacts the top surface of the upper material layer. Alternatively, in other exemplary aspects, it is contemplated that the longitudinal axis of the rod can be angularly oriented relative to the welding axis when the distal end of the rod contacts the top surface of the upper material layer. In these aspects, it is contemplated that the longitudinal axis of the rod can be positioned at an angle ranging from about 1 degree to about 4 degrees relative to the welding axis.

In one exemplary aspect, the upper material layer and the lower material layer can both comprise a first material. In this aspect, it is contemplated that at least the distal end of the rod can comprise the first material. Alternatively, it is contemplated that at least the distal end of the rod can comprise a second material different from the first material.

In another exemplary aspect, the upper material layer can comprise a first material, and the lower material layer can comprise a second material different than the first material. In this aspect, it is contemplated that at least the distal end of the rod can comprise the first material. Alternatively, it is contemplated that at least the distal end of the rod can comprise the second material. It is still further contemplated that at least the distal end of the rod can comprise a third material different from the first material and the second material.

In additional exemplary aspects, the upper material layer can comprise a material selected from the group consisting of a Carbon-Manganese (C—Mn) steel (including a Carbon-Manganese steel formed by conventional cold-rolling, hot-rolling, coating, and/or galvanization processes); high-strength-low-alloy steels; heat-treatable low-alloy steels; thermal-mechanical-controlled processing steels; Chromium-Molybdenum steels; quenched and tempered steels; dual-phase steels; ultra-high-strength steels; maraging steels; a stainless steel (including an austenitic stainless steel, a martensitic stainless steel, a ferritic stainless steel, a duplex stainless steel, or a super duplex stainless steel as are known in the art); Nickel; a Nickel-based alloy; Copper; a Copper alloy; Aluminum; an Aluminum alloy; Magnesium; a Magnesium alloy; Titanium; a Titanium alloy; and a metal matrix composite of two or more of the foregoing materials. However, it is contemplated that the upper material layer can comprise other metallic materials, including, for example and without limitation, a refractory metal, a rare earth metal, a magnetic material, a metallic glass, a shape-memory alloy, an intermetallic material, an Iron-based oxide-dispersion-strengthened alloy, a Nickel-based oxide-dispersion-strengthened alloy, a tool material, zirconium, Gallium, and Indium.

Similarly, in other exemplary aspects, the lower material layer can comprise a material selected from the group consisting of a Carbon-Manganese (C—Mn) steel (including a Carbon-Manganese steel formed by conventional cold-rolling, hot-rolling, coating, and/or galvanization processes); high-strength-low-alloy steels; heat-treatable low-alloy steels; thermal-mechanical-controlled processing steels; Chromium-Molybdenum steels; quenched and tempered steels; dual-phase steels; ultra-high-strength steels; maraging steels; a stainless steel (including an austenitic stainless steel, a martensitic stainless steel, a ferritic stainless steel, a duplex stainless steel, or a super duplex stainless steel as are known in the art); Nickel; a Nickel-based alloy; Copper; a Copper alloy; Aluminum; an Aluminum alloy; Magnesium; a Magnesium alloy; Titanium; a Titanium alloy; and a metal matrix composite of two or more of the foregoing materials. However, it is contemplated that the lower material layer can comprise other metallic materials, including, for example and without limitation, a refractory metal, a rare earth metal, a magnetic material, a metallic glass, a shape-memory alloy, an intermetallic material, an Iron-based oxide-dispersion-strengthened alloy, a Nickel-based oxide-dispersion-strengthened alloy, a tool material, zirconium, Gallium, and Indium.

Where intermediate material layers are used, it is contemplated that each intermediate material layer can comprise one of the exemplary materials listed above with respect to the upper and lower material layers. Thus, it is contemplated that each intermediate material layer can comprise the same material as one or more of the upper and lower material layers. Similarly, it is contemplated that each intermediate material layer can comprise a material that is different in chemical composition and/or properties than the materials of the upper and lower material layers.

In still other exemplary aspects, the rod can comprise a material selected from the group consisting of a Carbon-Manganese (C—Mn) steel (including a Carbon-Manganese steel formed by conventional cold-rolling, hot-rolling, coating, and/or galvanization processes); high-strength-low-alloy steels; heat-treatable low-alloy steels; thermal-mechanical-controlled processing steels; Chromium-Molybdenum steels; quenched and tempered steels; dual-phase steels; ultra-high-strength steels; maraging steels; a stainless steel (including an austenitic stainless steel, a martensitic stainless steel, a ferritic stainless steel, a duplex stainless steel, or a super duplex stainless steel as are known in the art); Nickel; a Nickel-based alloy; Copper; a Copper alloy; Aluminum; an Aluminum alloy; Magnesium; a Magnesium alloy; Titanium; a Titanium alloy; and a metal matrix composite of two or more of the foregoing materials. However, it is contemplated that the rod can comprise other metallic materials, including, for example and without limitation, a refractory metal, a rare earth metal, a magnetic material, a metallic glass, a shape-memory alloy, an intermetallic material, an Iron-based oxide-dispersion-strengthened alloy, a Nickel-based oxide-dispersion-strengthened alloy, a tool material, zirconium, Gallium, and Indium.

Optionally, in some aspects, the rod can comprise a material that is the same as at the material of least one material layer to be welded. For example, when the material layers comprise steel, stainless steel, or Inconels, it is contemplated that the rod can comprise the same material as the material layers. Alternatively, it is contemplated that the rod can comprise a material that is different from the materials of the material layers to be welded. For example, when the material layers comprise aluminum, copper, or titanium, it is contemplated that the rod can comprise a material different from the material of the material layers. In exemplary aspects, it is contemplated that a stainless steel rod can be used to weld together upper and lower material layers of Aluminum alloys, CP Cu, CP Mg, brass or Ti6Al4V.

Optionally, in further exemplary aspects, it is contemplated the distal end of the rod can penetrate through at least a portion of the upper material layer such that the distal end of the rod is positioned at a selected depth relative to the top surface of the upper material layer.

In exemplary aspects, prior to welding of the upper material layer to the lower material layer, at least a portion of the top surfaces of upper material layer and the lower material layer can be ground to produce a surface finish having a selected surface roughness (Ra). In these aspects, it is contemplated that the surface roughness (Ra) can range from about 1 μm to about 2 μm. It is further contemplated that at least a portion of the rod, such as, for example, at least a portion of the distal end of the rod, can be ground to produce a surface finish having a selected surface roughness (Ra). In exemplary aspects, it is contemplated that the surface roughness (Ra) of the ground portions of the rod can range from about 1 μm to about 2 μm.

In one aspect, the disclosed method can have a corresponding cycle time (duration). In this aspect, it is contemplated that the cycle time of the method can range from about 5 seconds to about 60 seconds. In another aspect, it is contemplated that the step of applying the axial force to the rotating rod such that the distal end of the rod penetrates through the upper material layer can have an associated dwell time. In this aspect, it is contemplated that the dwell time can range from about 1 second to about 10 seconds and, more preferably, about 10 seconds. In a further aspect, it is contemplated that the rod can penetrate through the upper material layer at a selected feed rate.

Optionally, in still another aspect, it is contemplated that the rod can penetrate into the upper material layer at a pre-set plunge depth. In this aspect, for consumable rods, the pre-set plunge depth can optionally range from about 1.0 mm to about 50 mm. For non-consumable rods, it is contemplated that the pre-set plunge depth can optionally range from about 0.05 mm to about 2 mm and, more preferably, from about 0.05 mm to about 0.5 mm. It is contemplated that the actual (achieved) plunge depth can range from about 25% to about 50% of the thickness of the upper material layer and, more preferably, be about 25% of the thickness of the upper material layer. Thus, it is contemplated that the actual (achieved) plunge depth can optionally range from about 0.1 mm to about 1.5 mm. It is contemplated that, even though the pre-set plunge depth can exceed the total thicknesses of the material layers, the actual penetration of the rod will never exceed the thickness of the upper material layer. It is contemplated that the processing circuitry of the welding system can evaluate the penetration of the rod into the upper material layer, as well as the decrease in the length of the rod, to determine the actual plunge depth of the rod.

### Friction Lap Seam Welding

Described herein with reference to FIGS. 7-13 are systems and methods for lap seam welding an upper material layer 14 to a lower material layer 16 relative to a vertical axis (z-axis) 200. The upper material layer 14 can be positioned in overlying relation to at least a portion of the lower material layer 16. Optionally, in one aspect, it is contemplated that one or more edges of the upper material layer 14 can be substantially aligned with one or more corresponding edges of the lower material layer 16. In another aspect, the upper and lower material layers 14, 16 can have respective top and bottom surfaces. In exemplary aspects, it is contemplated that the upper and lower material layers 14, 16 can be provided in the form of a sheet. However, it is contemplated that the upper and lower material layers 14, 16 can be provided in any form that permits at least a portion of the upper material layer 14 to overlie at least a portion of the lower material layer 16 such that the upper material layer can be welded to the lower material layer. It is further contemplated that one or more intermediate material layers can be provided in between the upper and lower material layers 14, 16 without affecting the ability of the disclosed systems and methods to form a lap seam weld between the upper and lower material layers.

It is contemplated that the systems and methods disclosed herein can achieve stronger lap seam welds than can be achieved using conventional welding methods. It is further contemplated that the systems and methods disclosed herein can be used to weld together a larger variety of materials (including, for example, hard metals and high-conductivity materials) than can be welded together using conventional seam welding methods. It is still further contemplated that the systems and methods disclosed herein can be used in a variety of industrial welding applications, including, for example and without limitation: (1) seam welding applications, including those in the automotive, aircraft, aerospace, nuclear, marine, chemical, and processing industries; (2) cladding applications, including those in hardfacing (for the purpose of reducing wear, abrasion, impact, erosion, galling, or cavitation), weld cladding (for the purpose of providing a corrosion-resistant surface), and buttering (for the purpose of adding one or more layers of weld metal to the face of the joint or surface to be welded), such as, for example and without limitation, mill hammers, digging tools, extrusion screws, cutting shears, parts of earthmoving equipment, ball mills, and crusher parts, control valves, undercarriage parts of tractors and shovels, and high-performance bearings, valves and pumps handling corrosive liquids, or slurries, turbine blades, shear blades, disk brakes, machine-tipped tools, press tool dies, internal surfaces of carbon and low-alloy steel, pressure vessels, paper digesters, urea reactors, tubesheets, austentic stainless steel and nickel based alloy nuclear reactor containment vessels for current and next generation nuclear plant applications, hydrocrackers, dissimilar metal welding for nuclear, marine, chemical, and processing industries; and (3) layer-by-layer additive manufacturing applications, including, for example and without limitation, customized implants and medical devices, energy system components, defense components, aeronautical, aerospace, automotive, tooling, consumer products, and the like. It is contemplated that the multi-material/functionally graded aspects of the disclosed process can improve efficiency in the creation of a variety of products, including bio-medical implants and corrosion- and wear-resistant layers. It is contemplated that the disclosed method can be used as an additive and selective subtractive manufacturing method to build up a near-net shape part which can be subsequently machined to its final dimensions using an integrated, 3-axis CNC milling machine. It is also contemplated that the disclosed method can be used for a wide range of technological applications because wires, tapes and meshes can be easily embedded within the metal matrix. For example, it is contemplated that the disclosed methods can be used during the manufacture of components with embedded optical fibers and/or sensors.

### Friction Lap Seam Welding Systems

In exemplary aspects, and with reference to FIGS. 7-10, a lap seam welding system for welding an upper material layer 14 to a lower material layer 16 relative to the vertical axis 200 can be provided. In one aspect, the seam welding system can comprise a rod 10 having a collet end 11, an opposed distal end 12, and a longitudinal axis 13. In this aspect, the rod 10 can have a diameter ranging from about 5 mm to about 25 mm. It is contemplated that, prior to formation of a seam weld using the rod 10 as disclosed herein, the rod can have a longitudinal length ranging from about 100 mm to about 200 mm and an exposed longitudinal length ranging from about 50 mm to about 100 mm (from the collet end 11 to the distal end 12 of the rod). In one exemplary aspect, the rod 10 can have a longitudinal length of about 150 mm and a diameter of about 2.5 cm. In additional exemplary aspects, the rod 10 can be axially tapered relative to its longitudinal axis 13. Although generally depicted and described herein as a substantially cylindrical rod having a circular cross-section, it is contemplated that the rod 10 can have any selected cross-sectional shape, including, for example and without limitation, rectangular, square, and elliptical cross-sectional shapes. In exemplary aspects, it is contemplated that the rod 10 can be a non-consumable rod. Alternatively, however, it is contemplated that the rod 10 can be a consumable rod.

In another aspect, the seam welding system can comprise means for selectively axially moving the rod 10 relative to the vertical axis. In this aspect, it is contemplated that the means for selectively axially moving the rod 10 can be configured to apply an axial force to the rod relative to the vertical axis. It is further contemplated that the axial force can range from about 1,000 Newtons (N) to about 25,000 N. In exemplary aspects, the axial force can range from about 5,000 N to about 9,000 N. Exemplary means for selectively axially moving the rod 10 comprise, for example and without limitation, axial spindles, servo-motors, and other motorized/axially translational mechanisms as are conventionally known in the art. In an additional aspect, the seam welding system can comprise means for selectively rotating the rod 10 about the longitudinal axis 13 of the rod. In this aspect, it is contemplated that the means for selectively rotating the rod 10 can be configured to rotate the rod at a rotational rate ranging from about 800 rotations per minute (RPM) to about 2,500 RPM. In exemplary aspects, the rotational rate can range from about 800 RPM to about 1,600 RPM. Exemplary means for selectively rotating the rod 10 comprise, for example and without limitation, rotational spindles, servo-motors, and other motorized/rotationally translational mechanisms as are conventionally known in the art.

In exemplary aspects, it is contemplated that the seam welding system can comprise a conventional welding machine that is configured to selectively move and rotate a rod as disclosed herein. Exemplary welding machines for use as disclosed herein include, for example and without limitation, an RM-1 model friction stir welding machine (Manufacturing Technology, Inc.), and a friction stir welding machine as disclosed in U.S. Pat. No. 6,554,175 and U.S. Patent Application Publication No. 2003/0209586, both of which are incorporated by reference herein in their entirety.

Thus, in exemplary aspects, and with reference to FIGS. 11-13, the seam welding system can comprise a welding machine 20 comprised of a frame or gantry 22 and a base 24 extending through the frame. The base 24 can support a work table 26 that is slidable (manually or automatically) along the length of the base 24 in a generally horizontal direction (relative to a weld traverse axis (x-axis), as further described herein). The work table 28 can support various material layers (shown as 28, 30, 31), which can be secured adjacent each other using the methods disclosed herein to form joints 32, 33. Friction lap-seam welding the material layers 28, 30, 31 along the joints 32, 33 as disclosed herein can secure the parts 28, 30, 31 together in a unitary piece. The gantry 22 can have a pair of columns or uprights 34, 36 that are spaced outside of, but adjacent to, lateral side rails 38, 40 of the base 24. The columns 34, 36 can be joined together by lower, intermediate and upper cross members or cross rails 42, 44, 46, respectively. An anvil 48 can be rigidly connected to the top of the lower cross member 42. Each of the side rails 38, 40 can be joined to the lower cross member 42 by a post 39 to connect the frame 22 and base 24 into a unitary structure. A spindle carriage or slide 50 can be mounted to the intermediate cross member 44 by means of a pair of linear guides or bearings 52. The spindle carriage 50 can also be operatively connected to a drive 54 providing motion of the linear carriage 50 in a generally horizontal direction substantially perpendicular to the longitudinal side rails 38, 40 of the base 24. The drive 54 can be of various known types, but the illustrated drive 54 is a five ton “ComDRIVE ACTUATOR” commercially available from Joyce Dayton of Dayton, Ohio. The drive 54 can use a jack or screw 56 having one end rotatably mounted in a bearing attached to the column 36. A nut (not shown) can be attached to the rear side of the spindle carriage 50 in a known manner. The drive 54 can further include a source of power 58, for example, a three horsepower AC induction motor, that is coupled to an opposite end of the screw 56 by a mechanical coupling, for example, a worm gear 60 commercially available from Cincinnati Electric of Cincinnati, Ohio. The drive 54 can be capable of providing a horizontal drive force of approximately 10,000 pounds.

A spindle or tool head 62 can be slidably mounted to the spindle carriage 50 by linear guides or bearings 64. Referring to FIG. 12, a pair of linear guides 64 can be used; and the guides 64 can be positioned laterally on opposite sides of the spindle carrier 50. The spindle 62 can be operatively connected to a second drive 65 for moving the spindle 62 in a generally vertical linear path substantially perpendicular to the spindle carriage guides 52 and the longitudinal side rails 38, 40 of the base 24. The second drive 65 can be of various known types, but the illustrated drive 65 has a screw 66 rotatably mounted at its upper end to the spindle carriage 50. The spindle 62 can be moved vertically by a nut (not shown) that carries a bracket 70 rigidly connected to the spindle 62. Referring to FIG. 12, a power source 72, for example, a one horsepower electric motor, can be mechanically coupled to an upper end of the screw 66 through a gear box 74. Thus, rotation of the motor 72 and screw 66 can be operative to move the nut 68 that carries the bracket 70 and spindle 62 in a generally vertical direction.

The spindle 62 can be rigidly connected to a lower end of a pair of rods or brackets 76 that have upper ends connected to movable portions 77 of respective drive 78. The drive 78 can function as a weld force generator and is comprised of a pair of power actuators, for example, air stroke actuators Model No. 1T15S-6 commercially available from Firestone of Carmel, Ind. It is contemplated that the air stroke actuators 78 can have a desirable characteristic of having a limited stroke or displacement within their total range of displacement in which they apply a relatively constant force through that limited displacement. Thus, through that limited displacement, it is contemplated that the force being applied by the actuators is a known, relatively constant magnitude and is applied independent of any deflections in the structure of the machine. The actuators 78 can have movable portions 77 rigidly connected to a plate 80 that is slidably mounted to the upper cross member 46 by means of a linear guide 82. The linear guide 82 can be located substantially along a longitudinal centerline of a lower surface 83 of the upper cross member 46. The linear guides 52, 64, 82 can be known devices such as Tompson linear guides commercially available from Tompson of Port Washington, N.Y.

With reference to FIGS. 12-13, it is contemplated that the rod 10 can be oriented perpendicularly or at a slight angle, for example, between 0 and 4 degrees, relative to the top surface of the upper material layer. Angular orientation of the rod 10 can be accomplished by rotating the spindle 62 clockwise through a small angle about an axis of rotation parallel to the side rails 38, 40. Referring to FIG. 13, the spindle 62 can be pivotally mounted to a plate 85 by means of a pivot pin 87; and the plate 85 can be mounted to the linear guides 64 on the spindle carriage 50. Thus, the spindle 62 and rod 10 can be angularly displaced, for example, up to five degrees, and clamped to the plate 85 by bolts or other means.

The rod 10 can be powered by a spindle motor 84, for example, a 25 horsepower motor commercially available from Cincinnati Electric mounted on the spindle 62. Referring to FIG. 13, the spindle motor 84 can be rotatably coupled to an upper end of a spindle shaft 86 by means of a belt drive 88. The spindle shaft 86 can be rotatably mounted in the spindle 62 by bearings 90. A tool holder 92 (for holding the rod 10) can be mounted to a lower end of the spindle shaft 86, and the rod 10 can be mounted within the tool holder 92. The tool holder 92 can be made from a material having a low thermal conductivity, for example, stainless steel, so that only minimal heat from the welding process and in the rod 10 can be conducted to other components, for example, the bearings 90, of the spindle 62. A spindle cover 96 can also be connected to the lower end of the spindle 62 and can cover a portion of the lower end of the spindle shaft 86. Rollers 97a, 97b can be rotatably mounted in a roller support or truck 100 on respective axles or pins 98a, 98b. The lower end of the spindle cover 96 can have a generally U-shaped clevis. The roller truck 100 can be pivotally mounted within the clevis of the spindle cover 96 by a pair of shoulder bolts that extend through clearance holes in opposed arms of the clevis and are threaded into opposite sides of the spindle cover 96. One of the rollers 97a, 97b can be located on each side of the tool 10 and the joint 32. Referring to FIG. 13, the rollers 97a, 97b can contact the upper surfaces of the respective material layers 28, 30. The rollers 97 can turn about an axis of rotation 102 that is substantially perpendicular to the axis of rotation 104 of the rod 10 and substantially parallel to the longitudinal side rails 38, 40 (FIG. 11) of the base 24.

In exemplary aspects, the rod 10 can be configured for movement relative to not only the vertical axis 200 but also a transverse axis (y-axis) 210 that is substantially perpendicular to a weld traverse axis (x-axis) 220 and the vertical axis (z-axis). In other exemplary aspects, it is contemplated that the work table 26 (and, thus, any supported material layers) can be configured for movement relative to not only the weld traverse axis (x-axis) 220 but also a transverse axis (y-axis) 210 that is positioned in a common plane with the weld traverse axis and that is substantially perpendicular to the weld traverse axis and the vertical axis (z-axis) 200.

In additional exemplary aspects, it is contemplated that the seam welding system can comprise processing means for effecting movement and rotation of the rod 10 as described herein. In these aspects, it is contemplated that the processing means can comprise a computer having a processor. It is further contemplated that the processor can be configured to cause the seam welding system to effect movement and/or rotation in a desired manner according to preset parameters, including, for example and without limitation, rotation rate, plunge depth, feed rate, applied axial force, movement of the material layers and/or rod relative to the welding, machine, and transverse axes, and the like. It is still further contemplated that the processing means can comprise a control panel positioned in operative communication with the processor such that a user can selectively adjust the operating parameters of the seam welding system. In exemplary aspects, the control panel can comprise a keyboard and a display, as shown in FIG. 8. In further exemplary aspects, it is contemplated that the computer can have a memory in operative communication with the processor. In these aspects, it is contemplated that the memory can be configured to store predetermined system parameters, such as, for example and without limitation, rotation rate, plunge depth, feed rate, applied axial force, movement of the material layers and/or rod relative to the welding, machine, and transverse axes, and the like.

### Friction Lap Seam Welding Methods

In operation, and with reference to FIGS. 7-10, the seam welding system can be used in a method of lap seam welding the upper material layer to the lower material layer relative to the vertical axis. In one aspect, the method of seam welding can comprise axially advancing and rotating the rod relative to the vertical axis such that the distal end of the rod contacts the top surface of the upper material layer. In another aspect, the method of seam welding can comprise applying an axial force to the rotating rod such that frictional heat between the distal end of the rod and the upper material layer plasticizes a portion of the upper material layer.

With a portion of the upper material layer plasticized, the method of seam welding can further comprise applying the axial force to the rotating rod such that a portion of the bottom surface of the upper material layer and a portion of the top surface of the lower material layer are deformed. It is contemplated that this deformation at the interface between the upper and lower material layers can result in a metallurgical bond between the upper and lower material layers.

It is contemplated that the sudden rise in temperature at the distal end of the rod and the upper material layer can result in plastic deformation of top surface of the upper material layer. It is further contemplated that this sudden rise in temperature can be due to the adiabatic heating resulting from viscous heat dissipation during plastic deformation. In operation, the rod can rotate at a given rotational rate, and an axial load applied to the rod can impart rotational force to the plasticized metal on the top surface of the upper sheet. It is contemplated that the imparted rotational force can cause elasto-plastic deformation due to the shear forces at the interface between the bottom surface of upper material layer and top surface of lower material layer. More particularly, tangential (centrifugal or rotational) forces can lead to the formation of spiral flow lines between a center portion of the material layers and the peripheral portions of the material layers. It is further contemplated that highly localized stick and slip at the interface can break up surface oxides and surface films. This, in turn, can facilitate metal-to-metal contact between contacting surfaces at the interface. The metal-to-metal contact area can grow due to the continued stick and slip mechanism, resulting in a continuous metallurgically bonded interface. Additionally, it is contemplated that there can be a rise in localized temperature at the interface between the upper and lower material layers due to the combined effects of conduction (imparted from the rotating plasticized metal), interfacial stick-slip mechanism, and plastic deformation. It is further contemplated that this rise in temperature at the interface can help solid state diffusion to take place at the interface between the upper and lower material layers. Thus, the metallurgical bonding at the interface between the upper and lower material layers can result from one or more operating mechanisms, including localized stick and slip at the interface, which tends to break up surface oxides and surface films, and diffusion between the upper and lower material layers while they are held together under high axial force applied through the rod. FIGS. 67 A and 67B display cross-sectional image of exemplary seam welds achieved using the friction seam welding methods described herein As shown, FIGS. 67 A and 67B depict images of the microstructure of the seam welds near the interface between the upper and lower material layers. As depicted, there is complete metallurgical bonding between the material layers at the interface. The image displays discrete oxide particles embedded in the matrix, indicating that the stick-slip mechanism caused a break up of surface oxide. The grains extending from one material layer to the other material layer are indicative of the diffusion between the two material layers.

In one exemplary aspect, it is contemplated that at least one intermediate material layer can be positioned between the upper and lower material layers. In this aspect, it is contemplated that, with a portion of the upper material layer plasticized, the method of seam welding can further comprise applying the axial force to the rotating rod such that a portion of the bottom surface of the upper material layer and a portion of a top surface of an intermediate material layer are deformed. Application of the axial force can continue until a bottom surface of the at least one intermediate material layer and the top surface of the lower material layer are deformed. It is further contemplated that this deformation at the interface between the various material layers can result in metallurgical bonds between the upper and intermediate material layers and between the intermediate and lower material layers. When more than one intermediate material layer is used, metallurgical bonds can form between the various intermediate material layers.

In a further aspect, the method of seam welding can comprise axially advancing the upper and lower material layers (and any intermediate material layers) relative to the weld traverse axis by a desired length, thereby forming a metallurgical bond of the desired length between the upper and lower material layers. In this aspect, it is contemplated that the desired length can optionally be about 125 mm. In another aspect, it is contemplated that the upper and lower material layers (and any intermediate material layers) can be axially advanced at a selected traverse rate relative to the weld traverse axis. It is further contemplated that the traverse rate can optionally range from about 10 mm/min. to about 20 mm/min.

In yet another aspect, the method of seam welding can comprise axially retracting the rod relative to the vertical axis such that the distal end of the rod is removed from contact with the top surface of the upper material layer.

In exemplary aspects, the upper material layer and the lower material layer can have respective thicknesses. In these aspects, it is contemplated that the thickness of the upper material layer and the thickness of the lower material layer can both range from about 0.5 mm to about 2.00 mm. In one aspect, the thickness of the upper material layer can be substantially equal to the thickness of the lower material layer. Alternatively, in another aspect, the thickness of the upper material layer can be greater than the thickness of the lower material layer. In still another aspect, it is contemplated that the thickness of the upper material layer can be less than the thickness of the lower material layer.

In exemplary aspects, the longitudinal axis of the rod can be substantially perpendicular to the top surface of the upper material layer (and substantially axially aligned with the vertical axis) when the distal end of the rod contacts the top surface of the upper material layer. Alternatively, in other exemplary aspects, it is contemplated that the longitudinal axis of the rod can be angularly oriented relative to the vertical axis when the distal end of the rod contacts the top surface of the upper material layer. In these aspects, it is contemplated that the longitudinal axis of the rod can be positioned at an angle ranging from about 1 degree to about 4 degrees relative to the vertical axis.

In one exemplary aspect, the upper material layer and the lower material layer can both comprise a first material. In this aspect, it is contemplated that at least the distal end of the rod can comprise the first material. Alternatively, it is contemplated that at least the distal end of the rod can comprise a second material different from the first material.

In another exemplary aspect, the upper material layer can comprise a first material, and the lower material layer can comprise a second material different than the first material. In this aspect, it is contemplated that at least the distal end of the rod can comprise the first material. Alternatively, it is contemplated that at least the distal end of the rod can comprise the second material. It is still further contemplated that at least the distal end of the rod can comprise a third material different from the first material and the second material.

In additional exemplary aspects, the upper material layer can comprise a material selected from the group consisting of a Carbon-Manganese (C—Mn) steel (including a Carbon-Manganese steel formed by conventional cold-rolling, hot-rolling, coating, and/or galvanization processes); high-strength-low-alloy steels; heat-treatable low-alloy steels; thermal-mechanical-controlled processing steels; Chromium-Molybdenum steels; quenched and tempered steels; dual-phase steels; ultra-high-strength steels; maraging steels; a stainless steel (including an austenitic stainless steel, a martensitic stainless steel, a ferritic stainless steel, a duplex stainless steel, or a super duplex stainless steel as are known in the art); Nickel; a Nickel-based alloy; Copper; a Copper alloy; Aluminum; an Aluminum alloy; Magnesium; a Magnesium alloy; Titanium; a Titanium alloy; and a metal matrix composite of two or more of the foregoing materials. However, it is contemplated that the upper material layer can comprise other metallic materials, including, for example and without limitation, a refractory metal, a rare earth metal, a magnetic material, a metallic glass, a shape-memory alloy, an intermetallic material, an Iron-based oxide-dispersion-strengthened alloy, a Nickel-based oxide-dispersion-strengthened alloy, a tool material, zirconium, Gallium, and Indium.

Similarly, in other exemplary aspects, the lower material layer can comprise a material selected from the group consisting of a Carbon-Manganese (C—Mn) steel (including a Carbon-Manganese steel formed by conventional cold-rolling, hot-rolling, coating, and/or galvanization processes); high-strength-low-alloy steels; heat-treatable low-alloy steels; thermal-mechanical-controlled processing steels; Chromium-Molybdenum steels; quenched and tempered steels; dual-phase steels; ultra-high-strength steels; maraging steels; a stainless steel (including an austenitic stainless steel, a martensitic stainless steel, a ferritic stainless steel, a duplex stainless steel, or a super duplex stainless steel as are known in the art); Nickel; a Nickel-based alloy; Copper; a Copper alloy; Aluminum; an Aluminum alloy; Magnesium; a Magnesium alloy; Titanium; a Titanium alloy; and a metal matrix composite of two or more of the foregoing materials. However, it is contemplated that the lower material layer can comprise other metallic materials, including, for example and without limitation, a refractory metal, a rare earth metal, a magnetic material, a metallic glass, a shape-memory alloy, an intermetallic material, an Iron-based oxide-dispersion-strengthened alloy, a Nickel-based oxide-dispersion-strengthened alloy, a tool material, zirconium, Gallium, and Indium.

Where intermediate material layers are used, it is contemplated that each intermediate material layer can comprise one of the exemplary materials listed above with respect to the upper and lower material layers. Thus, it is contemplated that each intermediate material layer can comprise the same material as one or more of the upper and lower material layers. Similarly, it is contemplated that each intermediate material layer can comprise a material that is different in chemical composition and/or properties than the materials of the upper and lower material layers.

In still other exemplary aspects, the rod can comprise a material selected from the group consisting of a Carbon-Manganese (C—Mn) steel (including a Carbon-Manganese steel formed by conventional cold-rolling, hot-rolling, coating, and/or galvanization processes); high-strength-low-alloy steels; heat-treatable low-alloy steels; thermal-mechanical-controlled processing steels; Chromium-Molybdenum steels; quenched and tempered steels; dual-phase steels; ultra-high-strength steels; maraging steels; a stainless steel (including an austenitic stainless steel, a martensitic stainless steel, a ferritic stainless steel, a duplex stainless steel, or a super duplex stainless steel as are known in the art); Nickel; a Nickel-based alloy; Copper; a Copper alloy; Aluminum; an Aluminum alloy; Magnesium; a Magnesium alloy; Titanium; a Titanium alloy; and a metal matrix composite of two or more of the foregoing materials. However, it is contemplated that the rod can comprise other metallic materials, including, for example and without limitation, a refractory metal, a rare earth metal, a magnetic material, a metallic glass, a shape-memory alloy, an intermetallic material, an Iron-based oxide-dispersion-strengthened alloy, a Nickel-based oxide-dispersion-strengthened alloy, a tool material, zirconium, Gallium, and Indium.

Optionally, in some aspects, it is contemplated that the rod can comprise a material that is different from the materials of the material layers to be welded. For example, when the material layers comprise aluminum, copper, or titanium, it is contemplated that the rod can comprise a material different from the material of the material layers. In exemplary aspects, it is contemplated that a stainless steel rod (AISI 304) can be used to weld together upper and lower material layers of Aluminum alloys. In other exemplary aspects, when seam welding harder materials, or when softer intermediate material layers are positioned between the upper and lower harder material layers, it is contemplated that the rod can comprise CP Molybdenum.

In various exemplary aspects, when the rod is a non-consumable rod, it is contemplated that the melting point(s) of the material layers to be welded together can be significantly lower than the melting point of the rod such that the rod does not plasticize and deposit material on the material layers. For example, rods comprising a refractory metal, such as, for example, niobium, molybdenum, tantalum, tungsten, and rhenium, which have melting points above about 2,200° C., can be used to seam weld material layers comprising conventional engineering metals and alloys, such as, for example, steels, stainless steels, nickel-based alloys, and titanium-based alloys. When the material layers to be welded together comprise lower-melting point materials such as aluminum, magnesium, copper, silver, gold, zinc, indium, and tin, it is contemplated that the rod can comprise steel, stainless steel, a nickel-based alloy, and the like having a melting point of between about 1,300° C. and about 1,400° C. When the material layers to be welded together comprise even lower melting point materials such as tin (melting point of 232° C.), lead (melting point of 327° C.), zinc (melting point of 420° C.), and the like, it is contemplated that the rod can comprise an aluminum alloy or similar material having a melting point of around 600° C.

In exemplary aspects, prior to welding of the upper material layer to the lower material layer, at least a portion of the top surfaces of the upper material layer and the lower material layer can be ground to produce a surface finish having a selected surface roughness (Ra). In these aspects, it is contemplated that the surface roughness (Ra) can range from about 1 μm to about 2 nm. It is further contemplated that at least a portion of the rod, such as, for example, at least a portion of the distal end of the rod, can be ground to produce a surface finish having a selected surface roughness (Ra). In exemplary aspects, it is contemplated that the surface roughness (Ra) of the ground portions of the rod can range from about 1 μm to about 2 nm.

In use, the upper and lower material layers can begin movement relative to the weld traverse axis as soon as the distal end of rod touches the upper portion of the upper material and the required force is built up between the distal end of the rod and the top surface (and upper portion) of the upper material.

### Multi-Layer Seam Welding

As disclosed herein, a lap seam weld can be formed between the upper and lower material layers (and any intermediate material layers) as disclosed herein, thereby forming a welded structure. In exemplary aspects, the lap seam welding method disclosed herein can be repeated to weld at least one additive layer to the welded structure (comprising the upper and lower material layers and any intermediate layers that were previously welded together). Thus, in these aspects, the at least one additive layer can be clamped against the upper material layer of the welded structure under pressure. Then, the rod, welded structure, and at least one additive layer can be selectively moved as disclosed herein to effect formation of a seam weld between the welded structure and the at least one additive layer. After formation of the lap seam weld between the welded structure and the at least one additive layer, the resulting structure can effectively be a multi-layered seam-welded structure. It is contemplated that this sequence can be continued on an indefinite basis until sufficient additive layers have been added to the pre-existing welded structure. It is contemplated that the additive layers can optionally comprise a different material than one or more of the material layers of the existing welded structure. Alternatively, it is contemplated that the additive layers can comprise a material that is substantially the same as the material of at least oen of the material layers of the existing welded structure.

In exemplary aspects, when the methods disclosed herein are used to lap seam weld at least one additive layer to an existing welded structure, it is contemplated that the additive layers can be selectively added to the existing welded structure to form a functional gradient based upon the properties of the various material layers. In these aspects, it is further contemplated that the disclosed methods can be employed in net-shape manufacturing processes.

### Multi-Track Seam Welding

In various aspects, the disclosed method can be selectively repeated to form multi-track seam welds between material layers. In one exemplary aspect, and with reference to FIG. 10, a multi-track seam weld can be performed by initially performing the steps of the method as disclosed herein. In this aspect, the rod can be axially advanced and rotated relative to the vertical axis such that the distal end of the rod contacts a top surface of the upper material layer. After a first seam weld between the upper and lower material layers is formed and the rod is axially retracted from the upper material layer as disclosed herein, the first and second material layers can be returned to their initial position relative to the weld traverse axis, either manually or through selective activation of the welding system. Then, the rod can then be axially advanced and rotated relative to the vertical axis such that the distal end of the rod contacts a second location on the top surface of the upper material layer, with the second location being spaced from the first location relative to the transverse axis. After the rod contacts the second location, the welding method can continue as disclosed herein to form a second seam weld. In exemplary aspects, it is contemplated that the first seam weld and the second seam weld can overlap relative to the transverse axis (See FIG. 10). In these aspects, the amount of overlap between the first seam weld and the second seam weld can correspond to about 10% to about 20% of the width of the first seam weld. It is further contemplated that the sequence of method steps can be repeated at additional locations (see, for example, the third seam in FIG. 10) on the upper material layer to expand the size of the weld between the material layers and thereby further strengthen the bond between the various material layers.

Prior to the step of axially advancing and rotating the rod relative to the vertical axis such that the distal end of the rod contacts a second location on the top surface of the upper material layer, the method can further comprise axially shifting the upper and lower material layers (and any intermediate material layers) relative to the transverse axis such that the second location is substantially aligned with the vertical axis. Alternatively, prior to the step of axially advancing and rotating the rod relative to the vertical axis such that the distal end of the rod contacts a second location on the top surface of the upper material layer, the method can further comprise axially shifting the rod relative to the transverse axis such that the vertical axis is substantially aligned with the second location.

### Exemplary Applications

In operation, it is contemplated that the disclosed methods can be employed in a variety of applications. For example, it is contemplated that the disclosed methods can be used to join together two or more material layers, including similar as well as dissimilar material layers. In another exemplary application, it is contemplated that the disclosed methods can be used in a cladding process whereby the surface properties of a substrate layer(s) are enhanced by the surface properties of an upper material layer welded to the substrate layer(s). In still another exemplary application, it is contemplated that the disclosed methods can be used in an additive manufacturing process to add additional material layers to existing substrate layer(s) on an as needed basis. It is further contemplated that the disclosed seam welding method can be used as an additive and selective subtractive manufacturing method to build up a near-net shape part which can then be machined to its final dimensions using a milling machine, such as, for example and without limitation, an integrated, 3-axis CNC milling machine. In another exemplary application, it is contemplated that multi-track-seam cladding of an upper material layer (or additive layer) to a lower material layer (or existing welded structure) can be used in Next Generation Nuclear Plant (NGNP) applications. In such applications, it is contemplated that a Ni-200 layer can be lap seam welded to a substrate comprising, for example and without limitation, a HX alloy substrate or a AISI 304 substrate.

It is contemplated that numerous functional and performance advantages can be achieved by use of the disclosed methods. For example, it is contemplated that, unlike laser seam welding methods, coated metals can be easily welded using the solid-state welding methods disclosed herein, which eliminate the coating volatility problems associated with laser seam welding methods. It is further contemplated that the disclosed methods are not fit up-sensitive (as are laser welding methods). Unlike fusion based methods, it is contemplated that the disclosed methods can weld dissimilar metals without producing deleterious metallurgical changes in the metals. Unlike resistance seam welding methods, it is contemplated that the disclosed methods do not require electrode cooling, can easily weld metals having varying thicknesses and/or high carbon content, and will not cause cracking, porosity, and/or deleterious metallurgical changes. It is further contemplated that the disclosed methods can be used to easily weld metals and alloys within a narrow plastic range, such as, for example and without limitation, titanium.

Unlike fusion-based cladding methods, it is contemplated that the disclosed cladding methods can clad a variety of metals on steel substrates, stainless steel substrates, nickel based alloy substrates, titanium alloy based substrates and the like without causing cracking, porosity, and/or undesirable brittle intermetallic compounds.

Unlike fusion-based additive manufacturing methods, it is contemplated that the disclosed additive manufacturing methods can be used to build three-dimensional parts that are substantially free of (a) unmelted zones, which cause a lack of bonding between powder particles; (b) porosity; (c) solidification, which causes susceptibility; (d) cast microstructure and micro-segregation, which lead to compositional in-homogeneities; (e) significant tensile residual stress build-up and long production times for large components; and (f) stiffness problems. Unlike solid-state additive manufacturing methods, it is contemplated that the disclosed methods can be used to more quickly build larger three-dimensional parts that are free from inter-layer bond defects and geometric constraints. By interrupted multilayering and selectively cutting channels in the overlapped metallic layers (using CNC machining), internal features can be built (for ex., for specific applications such as embedding sensors which can withstand high temperatures).

Exemplary applications of the disclosed methods and systems can include: formation of gas-tight and/or liquid-tight cans, tanks, and joints; automotive applications (including formation of fuel tanks, catalytic converters, mufflers, automobile trim, roof joints, and the like); formation of furnace heat exchangers; formation of water tanks; heat-exchangers (aircraft, refrigerator, industrial); formation of solar panels; formation of temperature controllers; formation of bimetallic strips for thermostats (as used in cars, furnaces, televisions, industrial controls, and the like); electrical contacts; clad cookware; underground cable wraps; electromagnetic shielding; corrosion and/or wear-resistant coatings; customized orthopedic implants; high-power electrical contacts; embedded automotive sensors (engine and vehicle); embedded medical sensors (temperature, pressure, and vibration sensors for invasive cardiac monitoring); original equipment manufacturing (refrigeration, energy, process control, automation, altitude and depth measurements); home appliances (sport watches, printers, microwave ovens, refrigerators, dryers); turbo machinery (gas pressure, liquid pressure, temperatures, barometric pressure); and the aerospace industry (force sensors for load monitoring on control surfaces and secondary load paths; torque transducers for brake system monitoring).

In another exemplary application, it is contemplated that the seam welding methods disclosed herein can be used to form seam welds with milled micro-channels (cavities). In exemplary aspects, it is contemplated that the seam welding methods disclosed herein can be used to form a micro-channel within and/or between upper and lower material layers. In these aspects, it is contemplated that the micro-channel can be configured to receive fluid, thereby permitting the welded material layers to function as a micro-reactor. Thus, in exemplary aspects, it is contemplated that the seam welding methods disclosed herein can be configured to form high-temperature micro-reactors for use in a variety of applications.

The experimental welding of a variety of material layer combinations is described in the following representative examples.

### Experimental Example One

In this experimental example, an upper metallic sheet was overlaid on to a lower metallic sheet, with the upper and lower sheets being clamped under pressure (FIG. 3). In some cases, welds were made with an intermediate metallic sheet in between the lower and upper metallic sheets. The thickness of the sheets (0.4 mm-3.25 mm) used was generally similar, but there were some cases in which varying thicknesses were used. The following metallic sheets were used: AISI 304; C—Mn; Ni-based alloys (IN 600, IN 625, HX); AA 6061 and AA 2014; and CP Cu, brass, CP Mg, Ti6Al4V. Metal welds between similar metals and metal welds between dissimilar metals were both achieved. Metallic rods (both consumable and non-consumable) with a surface roughness (Ra) ranging from about 1-2 μm were used. Consumable AISI 304 rods; C—Mn steel rods; IN 718 and AISI 304 rods were used to spot weld AISI 304 sheets, C—Mn steel sheets; and In 600, IN 625 and HX sheets, respectively. Non-consumable commercially pure Mo was used for spot welding AISI 304, C—Mn steel and In 600, IN 625 and HX sheets. Non-consumable AISI 304 rods were used to spot weld AA 6061, AA 2014, CP Cu, brass, CP Mg, Ti6Al4V sheets, and combinations thereof. The chemical compositions of the sheets and rods used are shown in Table 1.

TABLE 1
Chemical Compositions of Sheets and
Rods Used in Experimental Example

| Materials | Elements (in wt. %) |
|---|---|
| AISI 304 | 0.06%C, 18.4%Cr 8.17%Ni, 0.32%Si, 1.38%Mn |
| | Balance Fe |
| C—Mn steel | 0.21% C, 1.61% Mn, 0.27% Si, 0.021% P, 0.034% S. |
| | and Balance Fe |
| Inconel 600 | 0.05% C, 16.50% Cr, 9.00% Fe, 0.30% Ti, 0.04% Co, |
| | 0.03% Nb and Balance Ni |
| (HastealloyX) | 0.10% C, 21.81%Cr, 18.21%Fe, 1.48%Co, 0.62% W, |
| HX alloy | 9.10% Mo, 0.48% Mn, 0.49%Si and Balance Ni |
| Inconel 625 | 0.03% C, 22.10%Cr, 0.10% Co, 8.70% Mo, 3.60% Nb + |
| | Ta, 0.20% Ti, 3.90% Fe and Balance Ni |
| AA2014 | 4.52%Cu, 0.83%Si, 0.81%Mg, 0.61%Mn, 0.23%Fe, |
| | 0.058%Cr, 0.03%Sn and Balance Al |
| AA6061 | 0.96%Mg, 0.73%Si, 0.24%Fe, 0.33%Mn, 0.23%Cu, and |
| | Balance Al |
| CP Cu | 0.004%Fe, 0.005%Al, 0.015%Ni, 0.003%Pb |
| | and Balance Cu |
| Brass | 28.1%Zn, 0.012%Fe, 0.03%Pb, and Balance Cu |
| CP Mg | 0.01%Zn, 0.05% Fe and Balance Mg |
| Ti6Al4V | 6.45% Al, 3.97% V, 0.20% Fe and Balance Ti |

The diameter of the rods ranged from 12.5 to 25.4 mm. The longitudinal length of the rods (from the collet end to the distal end of the rod) ranged from 50 mm to about 100 mm. A RM-1 model friction stir welding machine (Manufacturing Technology, Inc.) was used to achieve the spot welds in accordance with the methods disclosed herein. The rod was rotated (at 1,000 rotations per minute (RPM) to 3,000 RPM) and advanced towards the top surface of the upper metallic sheet. As the distal end of the rod contacted the top portion of the upper metallic sheet, an axial force (1,000 Newtons (N) to about 25,000 N) was applied between the distal end of the rotating rod and the top portion of the upper metallic sheet. An additional parameter, plunge depth was also controlled between 0.1 and 1.5 mm. FIG. 5 shows the sequential steps of a friction spot weld, and FIG. 6 is a flowchart depicting the steps of the friction spot welds.

Tables 2-8 show the weld parameters for different materials studied. A difference between the applied and actual values of axial force and plunge depth was noticed. The application of axial force and rod rotation resulted in frictional heat between the upper and lower sheets and a portion of the upper metallic sheet being plasticized. After a predetermined dwell time (10 s), a portion of the bottom surface of the upper metallic sheet and a portion of the top surface of the lower metallic sheet were found to be metallurgically bonded (FIG. 4B shows a cross-sectional view of an exemplary friction spot weld). Whenever an additional metallic sheet was positioned between the upper and lower metallic sheets, the additional metallic sheet was found to be metallurgically bonded to the upper and lower sheets. Once the weld was achieved, the rod was retracted vertically from contact with the top surface of the upper metallic sheet. All the welds were subjected to bend and/or peel-off testing to examine bond integrity. The interface between the sheets was also examined by optical metallography to assess the bonding.

Consumable Rods:

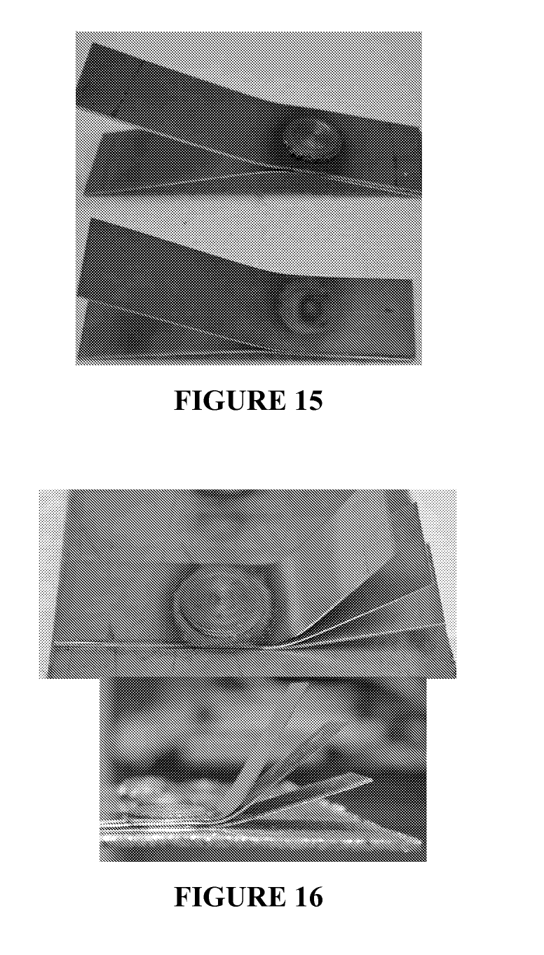

Table 2 shows the weld parameters for a variety of AISI 304 welds. These welds were formed using AISI 304 and C—Mn steel consumable rods and the following parameters: rod diameter of 10-19 mm, axial force of 12,000-20,000 N, a rotational rate of the rod of 1,200-1,500 RPM, an achieved plunge depth of 0.1-1.0 mm, and a dwell time of 10 seconds. FIG. 14 shows a spot weld for 0.4 mm thick sheets. FIG. 15 shows a spot weld for 0.8 mm thick sheets. FIG. 16 shows a spot weld for 0.8 mm sheets (3) to a 2.25 mm thick sheet. FIG. 17 shows a spot weld for 3.00 mm thick sheets.

TABLE 2
Spot Weld Parameters for Austenitic Stainless Steel AISI 304 Sheets
Using Consumable Rods

| | | Rod | | | | | |
|---|---|---|---|---|---|---|---|
| | | (unless | | | | Plunge | Plunge |
| | | mentioned | | Rod | | Depth, | Depth |
| | Sheet | AISI 304) | Force, | Rotational | Dwell | Applied, | Achieved, |
| No. | Thickness, mm | dia, mm | kN | speed, RPM | time, s | mm | mm |
| 1 | 0.4 + 0.4 | 10 | 15 | 1500 | 10 | −1.5 | 0.1 |
| 2 | 0.8 + 0.8 | 12.5 | 15 | 1500 | 10 | −2.5 | 0.2 |
| 3 | 0.8 + 0.8 | 12.5 | 15 | 1500 | 10 | −2.5 | 0.2 |
| 4 | 0.8 + 0.8 + 0.8 + | 19.0 | 20 | 1500 | 10 | −15 | 0.2 |
| | 2.25 | | | | | | |
| 5 | 1.4 + 1.4 | 12.5 | 12 | 1200 | 10 | −2.5 | 0.3 |
| | | (C—Mn | | | | | |
| | | steel) | | | | | |
| 6 | 2.25 + 2.25 | 19 | 20 | 1500 | 10 | −50 | 0.5 |
| 7 | 2.25 + 2.25 | 19 | 20 | 1500 | 10 | −20 | 0.5 |
| 8 | 3.0 + 3.0 | 19 | 20 | 1500 | 10 | −50 | 1.0 |

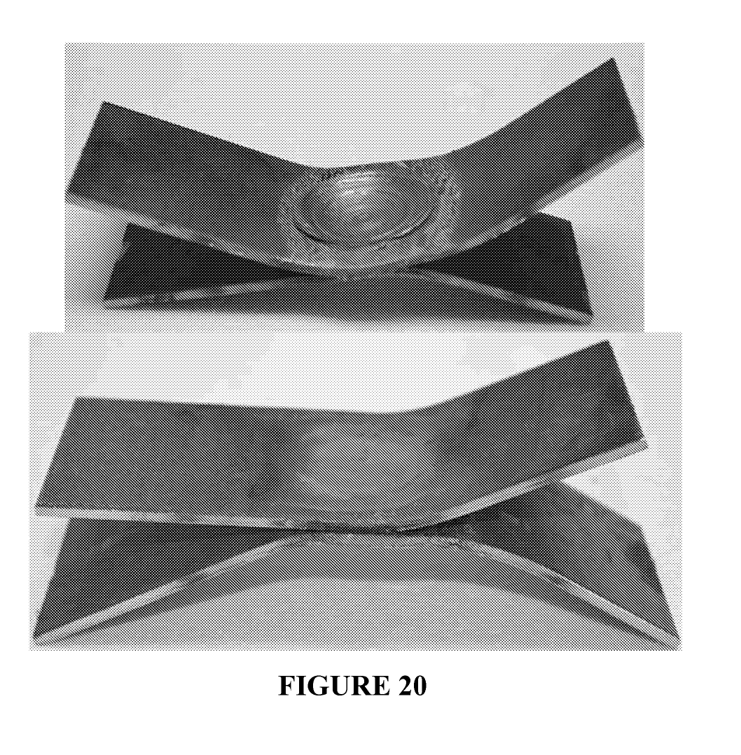

Table 3 shows the weld parameters for a variety of C—Mn welds. These welds were formed using C—Mn steel and AISI 304 consumable rods and the following parameters: rod diameter of 12.5-25.4 mm, axial force of 10,000-25,000 N, a rotational rate of the rod of 1,300-2,800 RPM, an achieved plunge depth of 0.3-1.5 mm, and a dwell time of 10 seconds. FIG. 18 shows a spot weld for 0.4 mm thick sheets. FIG. 19 shows a spot weld for 2.0 mm thick sheets. FIG. 20 shows a spot weld for 3.25 mm thick sheets.

TABLE 3
Spot Weld Parameters for C—Mn Steels Using Consumable Rods

| | | Rod | | | | | |
|---|---|---|---|---|---|---|---|
| | | (unless | | | | | |
| | | mentioned | | Rod | | Plunge | Plunge |
| | Sheet | C—Mn | | Rotational | | Depth, | Depth |
| | Thickness, | steel) | Force, | speed, | Dwell | Applied, | Achieved, |
| No. | mm | dia, mm | kN | RPM | time, s | mm | mm |
| 1 | 0.8 + 0.8 + 0.8 | 12.5 (AISI | 10 | 1300 | 10 | −1.5 | 0.3 |
| | | 304) | | | | | |
| 2 | 0.8 + 0.8 + (2.25 | 12.5 | 15 | 2800 | 10 | −5 | 0.3 |
| | AISI 304) | | | | | | |
| 3 | 0.8 + 0.8 + (2.25 | 12.5 (AISI | 10 | 1300 | 10 | −2.5 | 0.3 |
| | AISI 304) | 304) | | | | | |
| 4 | 2.0 + 2.0 | 25.4 | 15 | 1500 | 10 | −30 | 0.5 |
| 5 | 2.0 + 2.0 | 12.5 | 15 | 1500 | 10 | −25 | 0.75 |
| 6 | 3.25 + 3.25 | 25.4 | 25 | 2000 | 10 | −40 | 1.5 |

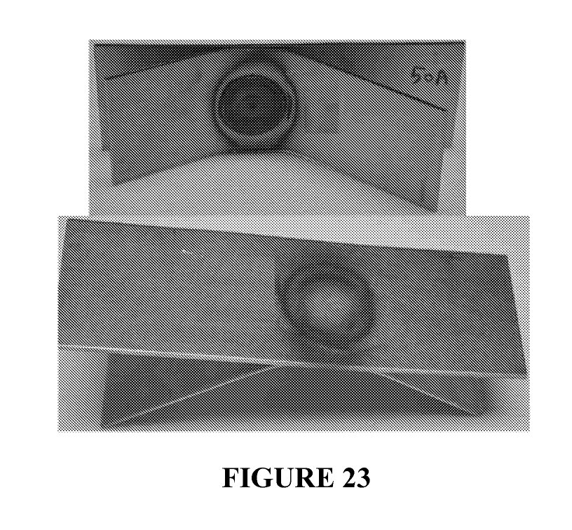

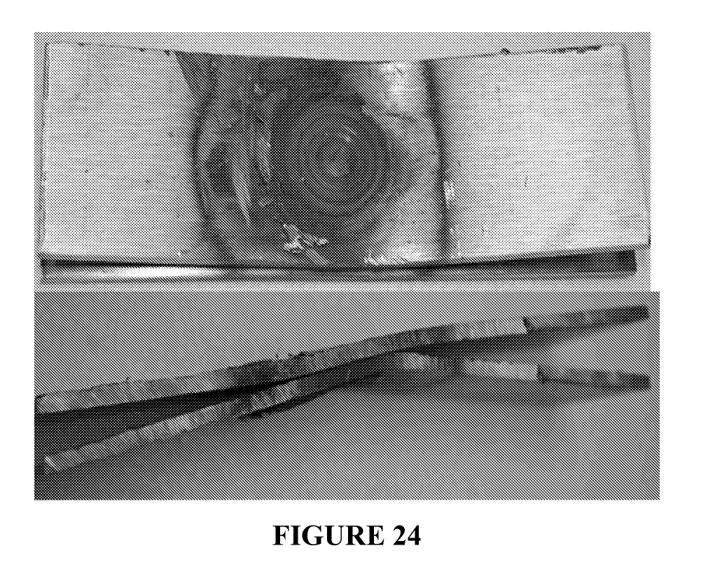

Table 4 shows the weld parameters for a variety of Ni-based alloys. These welds were formed using various consumable rods and the following parameters: Inconel 718 and AISI 304 consumable rods diameter of 12.5-25.4 mm, axial force of 8,000-25,000 N, a rotational rate of the rod of 1,500 RPM, an achieved plunge depth of 0.1-0.5 mm, and a dwell time of 10 seconds. FIG. 21 shows a spot weld for 0.4 mm thick In 600 sheets. FIG. 22 shows a spot weld for 0.8 mm thick HX sheets. FIG. 23 shows a spot weld for 2.0 mm thick IN 600 sheets. FIG. 24 shows a spot weld for 3.15 mm thick IN 625 sheets.

TABLE 4
Spot Weld Process Parameters for Ni-based Alloys Using Consumable Rods

| | | Rod | | | | | |
|---|---|---|---|---|---|---|---|
| | | (unless | | Rod | | Plunge | Plunge |
| | Sheet | mentioned | | Rotational | | Depth, | Depth |
| | Thickness, | IN 718) | Force, | speed, | Dwell | Applied, | Achieved, |
| No. | mm | dia, mm | kN | RPM | time, s | mm | mm |
| 1 | 0.4 + 0.4 | 12.5 | 8 | 1500 | 10 | −5 | 0.1 |
| | (IN 600) | | | | | | |
| 2 | 0.8 + 0.8 (HX) | 12.5 | 20 | 1500 | 10 | −25 | 0.2 |
| 3 | 2.0 + 2.0 (IN600) | 19 (AISI | 20 | 1500 | 10 | −50 | 0.3 |
| | | 304) | | | | | |
| 4 | 3.15 + 3.15 (IN625) | 25.4 (AISI | 25 | 1500 | 10 | −50 | 0.5 |
| | | 304) | | | | | |

### Non-Consumable Rods:

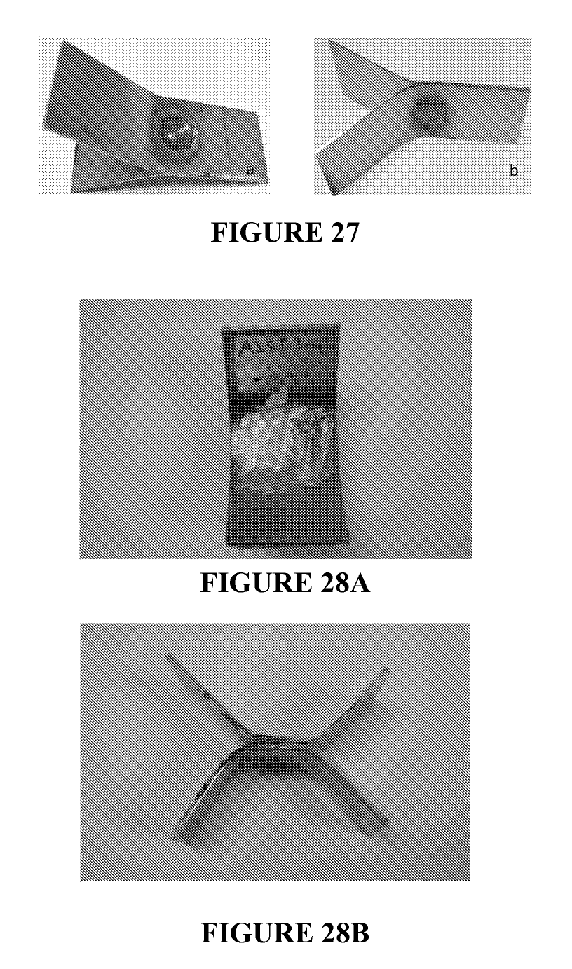

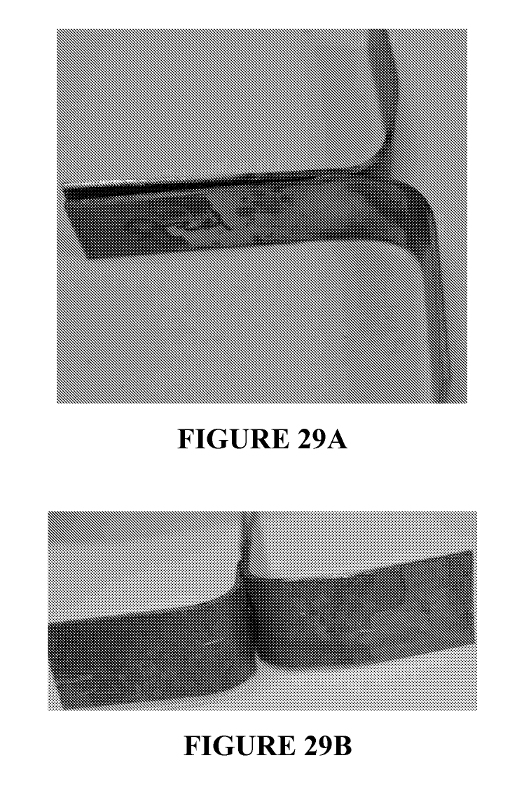

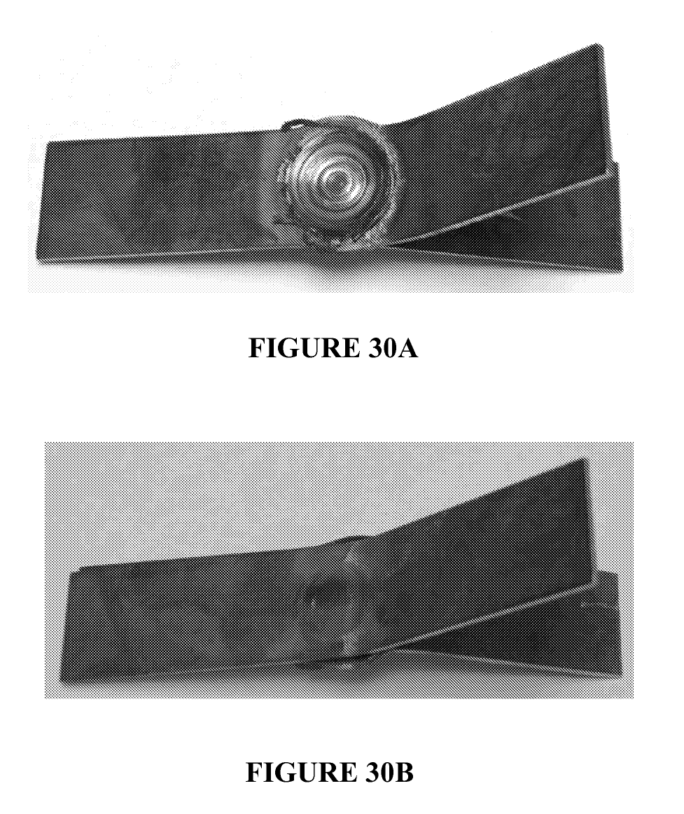

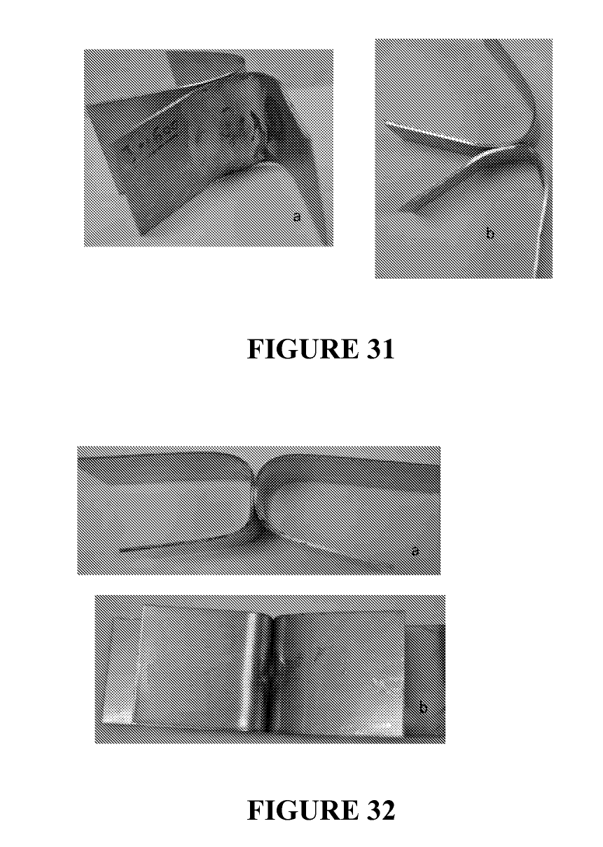

Table 5 shows the weld parameters for AISI 304, C—Mn steel and Inconel alloys using a non-consumable rod (CP Mo 25.4 mm diameter). Parameters used include an axial force of 3,000-8,000 N; a rotational rate of the rod of 1,600 RPM, and a dwell time of 10 seconds. This is in contrast to the higher axial force levels used for the consumable rod counterparts. RPM levels and dwell times were almost same as those achieved with the consumable rods. FIG. 25 shows a spot weld for 3 sheets of 0.8 mm thick AISI 304 sheets. FIG. 26 shows spot weld of two sheets of AISI 304 (0.8 mm) welded to C—Mn steel (3 mm) FIG. 27 shows a spot weld for 2 sheets of AISI 304, with each sheet having a thickness of 1.6 mm. FIG. 28 shows a spot weld for 2 sheets of AISI 304, with each sheet having a thickness of 2.0 mm. FIG. 29 shows a spot weld for 2 sheets of C—Mn steel, with each sheet having a thickness of 1.5 mm. FIG. 30 shows a spot weld for 2 sheets of C—Mn steel, with each sheet having a thickness of 2.0 mm. FIG. 31 shows a spot weld for 2 sheets of IN 600, with each sheet having a thickness of 1.50 mm. FIG. 32 shows a spot weld for 2 sheets of IN 625, with each sheet having a thickness of 1.50 mm.

TABLE 5
Spot Weld Parameters for AISI 304, C—Mn steel
and Inconel Alloys Using Non-consumable Rod

| | | | Rod | |
|---|---|---|---|---|
| | Sheet | | Rotational | |
| | Thickness, | Force, | speed, | Dwell |
| No. | mm | KN | RPM | time, s |
| 1 | 0.80 (AISI304) + 0.80(AISI 304) + | 3 | 1600 | 10 |
| | 0.80 (AISI304) | | | |
| 2 | 0.80(AISI 304) + 0.80(AISI 304) + | 5 | 1600 | 10 |
| | 3.00(C—Mn steel) | | | |
| 3 | 1.60(AISI 304) + 1.60 (AISI 304) | 5 | 1600 | 10 |
| 4 | 2.00(AISI 304) + 2.00 (AISI 304) | 5 | 1600 | 10 |
| 5 | 1.50(C—Mn steel) + 1.50 (C—Mn | 6 | 1600 | 10 |
| | steel) | | | |
| 6 | 2.00(C—Mn steel) + 2.00 (C—Mn | 6 | 1600 | 10 |
| | steel) | | | |
| 7 | 1.5 (IN 600) + 1.5 (IN 600) | 8 | 1600 | 10 |
| 8 | 1.50 (IN 625) + 1.50 (IN 625) | 8 | 1600 | 10 |

Table 6 shows the weld parameters for aluminum alloys, including AA6061 and AA2014 alloys using a non-consumable rod (AISI 304 12.5 mm diameter). The weld parameters included an an axial force of 2,000-3000 N, a rotational rate of the rod of 1,600 RPM, and a dwell time of 5 seconds. FIG. 33 shows a spot weld for 1.0 mm thick AA6061 sheets.

TABLE 6
Spot Weld Process Parameters for Aluminum
Alloys using Non-consumable Rods

| | | Rod | | Rod | |
|---|---|---|---|---|---|
| | Sheet | (AISI | | Rotational | |
| | Thickness, | 304) | Force, | speed, | Dwell |
| No. | mm | dia, mm | kN | RPM | time, s |
| 1 | 3.0 + 3.0 | 12.5 | 3 | 1600 | 5 |
| | (AA2014) | | | | |
| 2 | 1.0 + 1.0(AA6061) | 12.5 | 2.0 | 1600 | 5 |
| 3 | 3.0 + 3.0(AA6061) | 12.5 | 3.0 | 1600 | 5 |

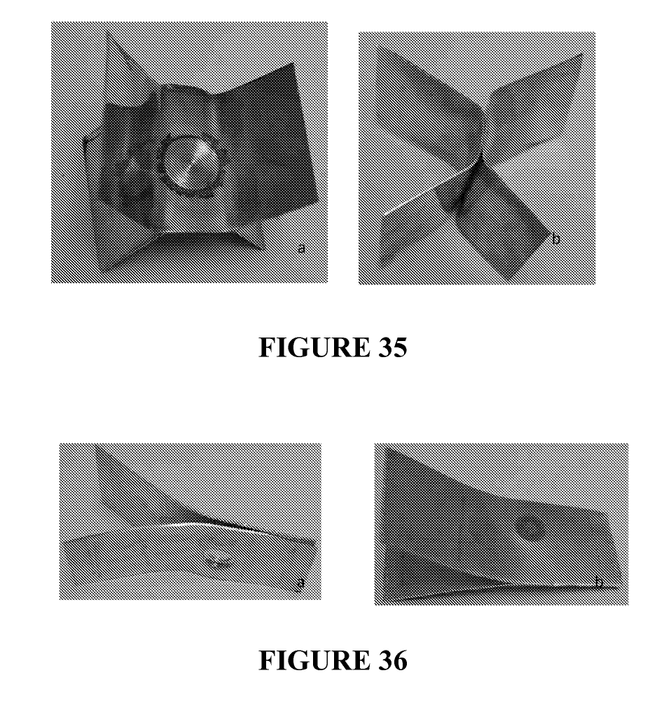

Table 7 shows the weld parameters for non-ferrous metallic sheets, including CP Cu, brass, and CP Mg using a non-consumable rod (AISI 304 12.5 mm diameter). The weld parameters included an axial force of 1,000-2500 N, a rotational rate of the rod of 1,600 RPM, and a dwell time of 5 seconds. FIG. 34 shows spot welds for 0.5 mm thick CP Cu sheets. FIG. 35 shows spot welds for 1.0 mm thick brass sheets. FIG. 36 shows spot welds for 1.0 mm thick CP Mg sheets.

TABLE 7
Spot Weld Process Parameters for CP Copper, Brass,
and CP Magnesium Using Non-consumable Rod

| | | Rod | | Rod | |
|---|---|---|---|---|---|
| | Sheet | (AISI | | Rotational | |
| | Thickness, | 304) | Force, | speed, | Dwell |
| No. | mm | dia, mm | kN | RPM | time, s |
| 1 | 0.5 + 0.5 (Cu) | 12.5 | 1.0 | 1600 | 5 |
| 2 | 1.0 + 1.0(Brass) | 12.5 | 2.5 | 1600 | 5 |
| 3 | 1.0 + 1.0(Mg) | 12.5 | 1.5 | 1600 | 5 |

Table 8 shows the weld parameters for welds between dissimilar metallic sheets, including welds of Ti6Al4V to AISI 304 and welds of CP Cu to AISI 304 using a non-consumable rod (AISI 304 12.5 mm diameter). The weld parameters included an axial force of 1,500-5,000 N, a rotational rate of the rod of 1,600 RPM, and a dwell time of 5 seconds. FIG. 37 shows spot welds for two 0.8 mm thick Ti6Al4V sheets welded to an AISI 304 (3.0 mm) sheet. FIG. 38 shows a spot weld for two 0.5 mm thick CP Cu sheets welded to an AISI 304 (3.0 mm) sheet.

TABLE 8
Spot Weld Process Parameters for Ti6Al4V and CP Copper
Welded to AISI 304 Sheet Using Non-consumable Rods

| | | Rod | | Rod | |
|---|---|---|---|---|---|
| | Sheet | (AISI | | Rotational | |
| | Thickness, | 304) | Force, | speed, | Dwell |
| No. | mm | dia, mm | kN | RPM | time, s |
| 1 | 0.8 (Ti6Al4V) + | 12.5 | 5.0 | 1600 | 5 |
| | 0.8 (Ti6Al4V) + | | | | |
| | 3.0 (AISI 304) | | | | |
| 2 | 0.5 (Cu) + | 12.5 | 1.5 | 1600 | 5 |
| | 0.5 (Cu) + | | | | |
| | 3.0 (AISI 304) | | | | |

Bend test and Peel-off test results are shown in FIGS. 14-39. In the case of AISI 304, C—Mn steel, and Ni-based alloys and CP copper and brass, the spot welds remained intact after bend and peel-off tests, indicating weld integrity. In the case of AA 6061 and AA 2014 (FIG. 39), failure was observed in the base metal/heat affected zone (HAZ) areas. It is contemplated that this failure can be due to the decrease in hardness compared to the unwelded base metal. In the case of CP Mg, the weld gave up, indicating the lack of bonding (FIGS. 40A-40B).

### Experimental Example Two

In one series of experiments, upper and lower material layers having similar compositions were welded together by single seam welds using the methods disclosed herein. The material layers were provided in sheet form (190 mm×200 mm×1.5 to 2 mm) The length of each seam weld was about 125 mm long and 25 mm wide.

FIG. 42 depicts a single seam weld between two layers of AA6061. Each layer had a thickness of 1.5 mm.

FIG. 43 depicts a single seam weld between two C—Mn steel layers. FIG. 43a depicts a top view, and FIG. 43b depicts a side view. Each layer had a thickness of 1.5 mm.

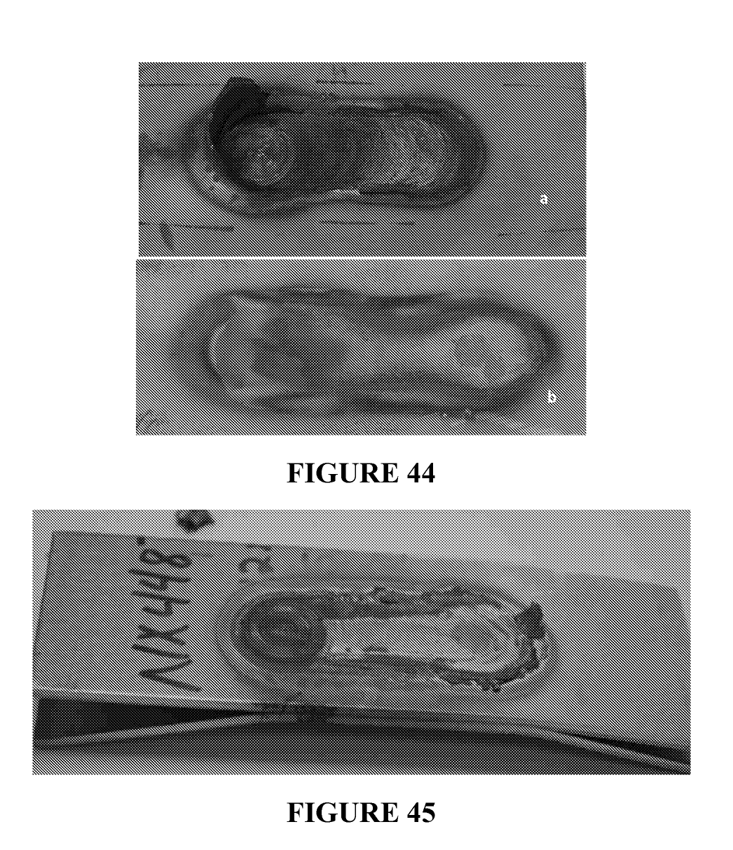

FIG. 44 depicts a single seam weld between two AISI 304 stainless steel layers. FIG. 44A depicts a top view, and FIG. 44B depicts a bottom view. Each layer had a thickness of 2 mm.

FIG. 45 depicts a single seam weld between two Inconel HX alloy layers. Each layer had a thickness of 2 mm.

Table 9 summarizes the process parameters that were employed to achieve the welds depicted in FIGS. 42-45.

TABLE 9
Seam Weld Process Parameters

| | | Rod | Weld |
|---|---|---|---|
| | Applied | Rotational | traverse |
| | force, | speed, | speed, |
| Materials | KN | RPM | mm/min |
| AA6061 (1.5 mm) to self | 5 | 800 | 20 |
| C—Mn steel (mm) to self | 8 | 1600 | 15 |
| AISI 304 (2 mm) to self | 8 | 1600 | 15 |
| Inconel HX (2 mm) to self | 8 | 1600 | 20 |

### Experimental Example Three

In another series of experiments, upper and lower material layers having similar compositions were welded together by multi-track seam welds using the methods disclosed herein. Two or three material layers were welded together using various material combinations and thicknesses. The material layers were welded together by multi-track seam welds using the methods disclosed herein. The material layers were provided in sheet form (190 mm×200 mm×1.5 to 2 mm) The length of each seam weld was about 125 mm, and the width of each seam weld was about 25 mm.

FIGS. 46A-46C depict a multi-track seam weld of two AA6061 layers. FIG. 46A depicts a top view, FIG. 46B depicts a side view, and FIG. 46C depicts a cross-sectional view of metallurgical bonding between the upper and lower material layers. Each layer had a thickness of 1.5 mm.

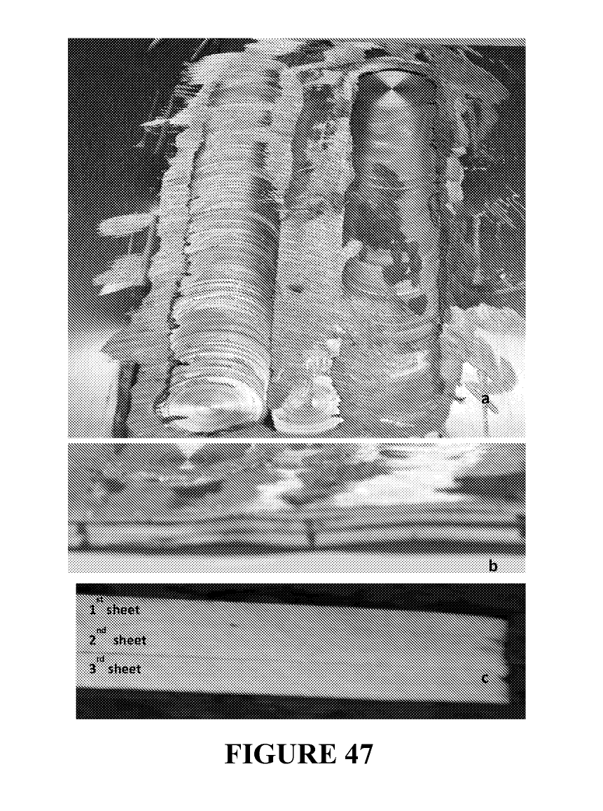

FIGS. 47A-47C depict a multi-track seam weld of three AA6061 layers. FIG. 47A depicts a top view, FIG. 47B depicts a side view, and FIG. 47C depicts a cross-sectional view of metallurgical bonding between the upper, lower, and intermediate material layers. Each layer had a thickness of 1.5 mm.

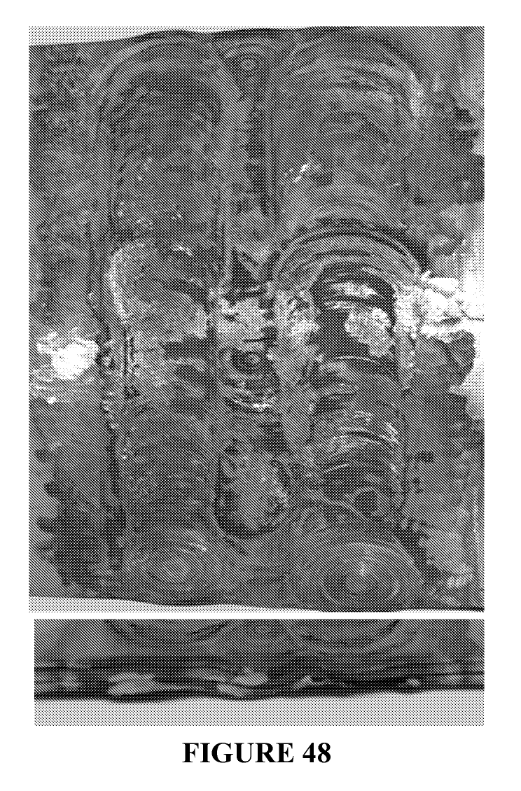

FIGS. 48A-48B depict a multi-track seam weld of three C—Mn steel layers. FIG. 48A depicts a top view, and FIG. 48B depicts a side view. Each layer had a thickness of 1.50 mm.

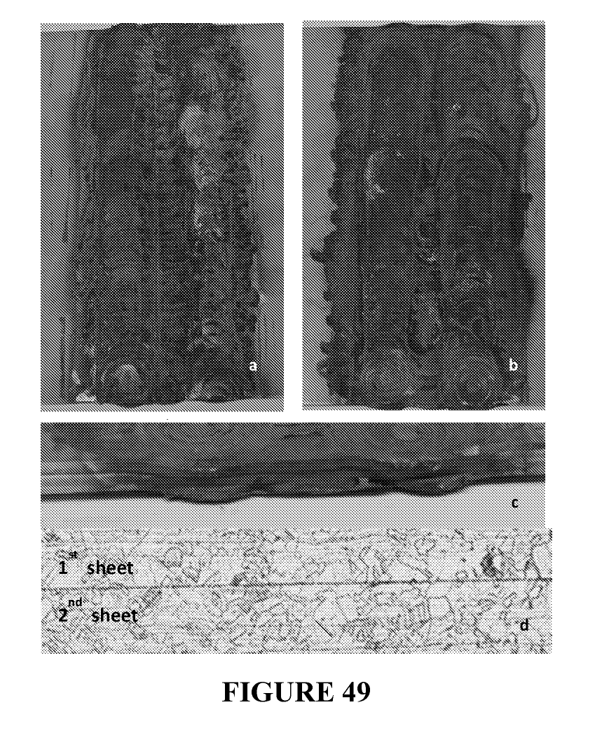

FIGS. 49A-49D depict multi-track seam welds of two and three AISI 304 layers. FIG. 49A depicts a top view of two layers, FIG. 49B depicts a top view of three layers, FIG. 49C depicts a side view of three layers and FIG. 49D depicts a cross-sectional view of metallurgical bonding between upper and lower material layers. Each layer had a thickness of 2 mm.

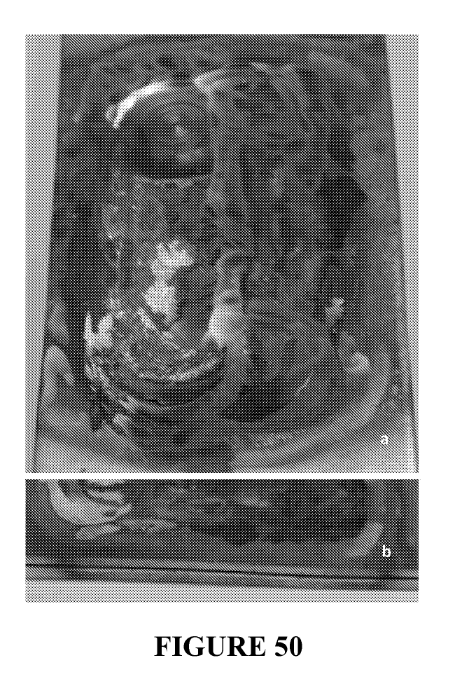

FIGS. 50A-50B depict a multi-track seam weld of two Inconel HX layers. FIG. 50A depicts a top view, and FIG. 50B depicts a side view. Each layer had a thickness of 2 mm.

Table 9 (above) summarizes the process parameters that were employed to achieve the welds depicted in FIGS. 46A-50B.

In these experimental multi-track seam welds, the interface between the various material layers did not show any no-bond zones or any types of physical defects, such as porosity, cracking, and the like.

### Experimental Example Four

In another series of experiments, upper and lower material layers having dissimilar compositions were welded together by single-track seam welds using the methods disclosed herein. The welds were formed between three material layers. Various material combinations and thicknesses and were welded together by single seam welds using the methods disclosed herein. The material layers were provided in sheet form (125 mm×25 mm×0.5 to 1.5 mm) The length of each seam weld was about 50 mm, and the width of each seam weld was about 25 mm.

FIGS. 51A-51B depict a single seam weld of a CP Cu layer in between two C—Mn steel layers. FIG. 51A depicts a top view of three layers, and FIG. 51B depicts the cross-sectional view of metallurgical bonding between CP Cu and C—Mn steel layers. The CP Cu layer had a thickness of 0.5 mm, and the C—Mn steel layers had a thickness of 1.5 mm.

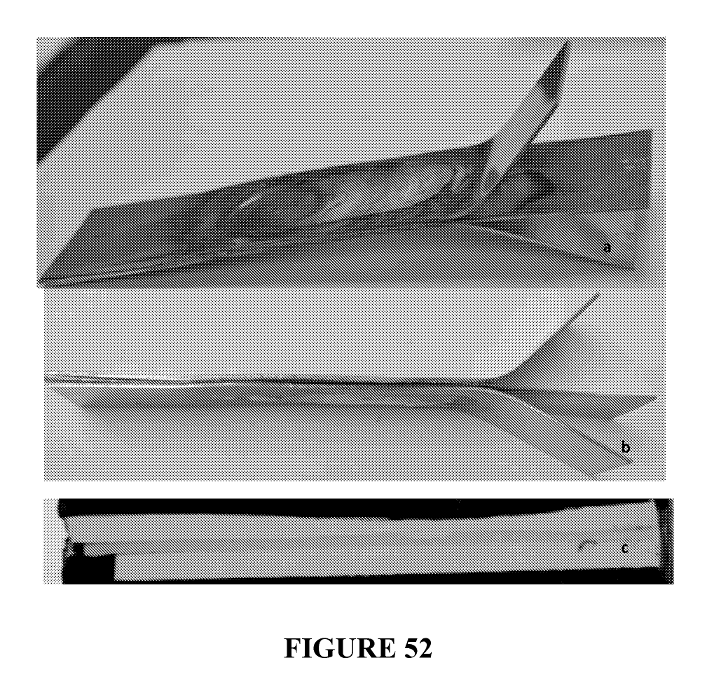

FIGS. 52A-52C depict a multi-track seam weld of a CP Cu layer in between two AISI 304 stainless steel layers. FIG. 52A depicts a top view of three layers, FIG. 52B depicts a side view, and FIG. 52C depicts a cross-sectional view of metallurgical bonding between CP Cu and AISI 304 layers. The CP Cu layer had a thickness of 0.5 mm, and the AISI 304 stainless steel layers had a thickness of 1.5 mm.

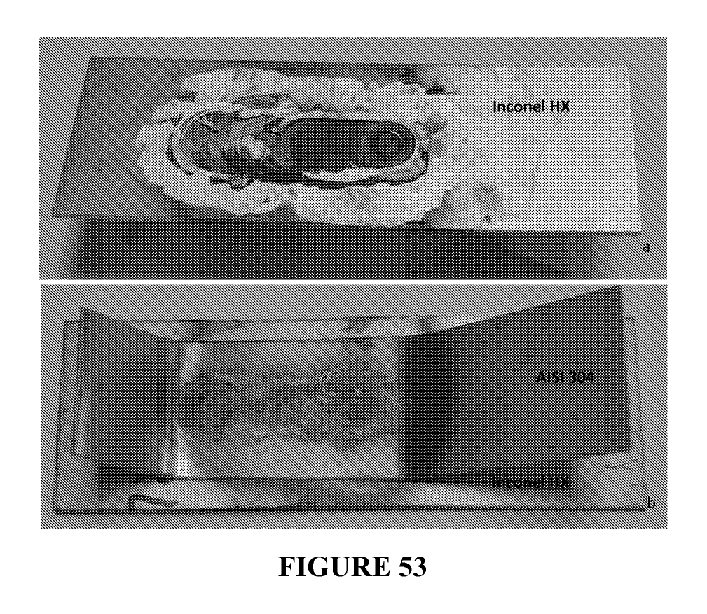

FIGS. 53A-53B depict a single-track seam weld of an Inconel HX alloy and an AISI 304 stainless steel layer. FIG. 53A depicts a top view, and FIG. 53B depicts a side view of the weld. The Inconel HX alloy layer had a thickness of 2.0 mm, and the AISI 304 stainless steel layer had a thickness of 1.5 mm.

Table 10 summarizes the process parameters that were employed to achieve the welds depicted in FIGS. 51-53B.

TABLE 10
Seam Weld Process Parameters

| | | Rod | Weld |
|---|---|---|---|
| | Applied | Rotational | traverse |
| | force, | speed, | speed, |
| Materials | KN | RPM | mm/min |
| CP Cu (0.5 mm) in between 2 | 8 | 1600 | 10 |
| C—Mn sheets (1.5 mm) | | | |
| CP Cu (0.5 mm) in between 2 | 8 | 1600 | 10 |
| AISI 304 sheets (1.5 mm) | | | |
| Inconel HX (2 mm) to AISI | 8 | 1600 | 20 |
| 304 (1.5 mm) | | | |

In these experimental single-track seam welds between differing material layers, the interface between the various material layers did not show any no-bond zones or any types of physical defects, such as porosity, cracking, and the like.

### Experimental Example Five

In another series of experiments, upper and lower material layers having dissimilar compositions were welded together by single track seam welds and multi-track seam welds using the methods disclosed herein. The upper and lower material layers included various material combinations, and a variety of material thicknesses were used. The material layers were provided in sheet form (150 mm×50 mm×0.8 to 2 mm) The length of each seam weld was about 50 mm, and the width of each seam weld was about 25 mm.

FIGS. 54A-54D depict single-seam cladding of an AISI 304 layer on a C—Mn steel substrate. FIG. 54A depicts a top view of two layers, FIG. 54B depicts a back view, FIG. 54C depicts a side view, and FIG. 54D depicts a cross-sectional view depicting metallurgical bonding between the upper and lower material layers. The AISI 304 layer had a thickness of 1.5 mm, and the C—Mn steel substrate layer had a thickness of 2 mm.

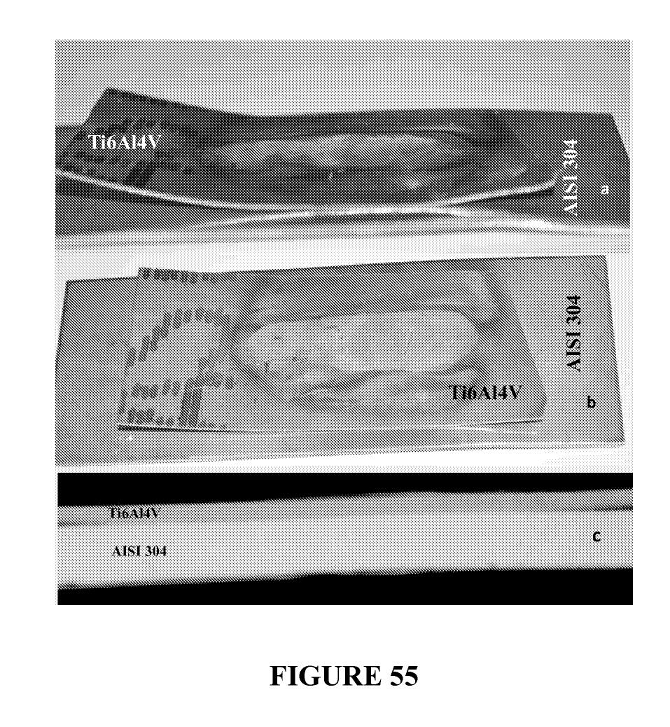

FIGS. 55A-55C depict seam cladding of a Ti6Al4V layer on an AISI 304 substrate. FIG. 55A depicts a top view of the two layers, FIG. 55B depicts a back view, and FIG. 55C depicts a cross-sectional view depicting metallurgical bonding between the upper and lower material layers. The AISI 304 substrate layer had a thickness of 1.5 mm, and the Ti6Al4V layer had a thickness of 0.8 mm.

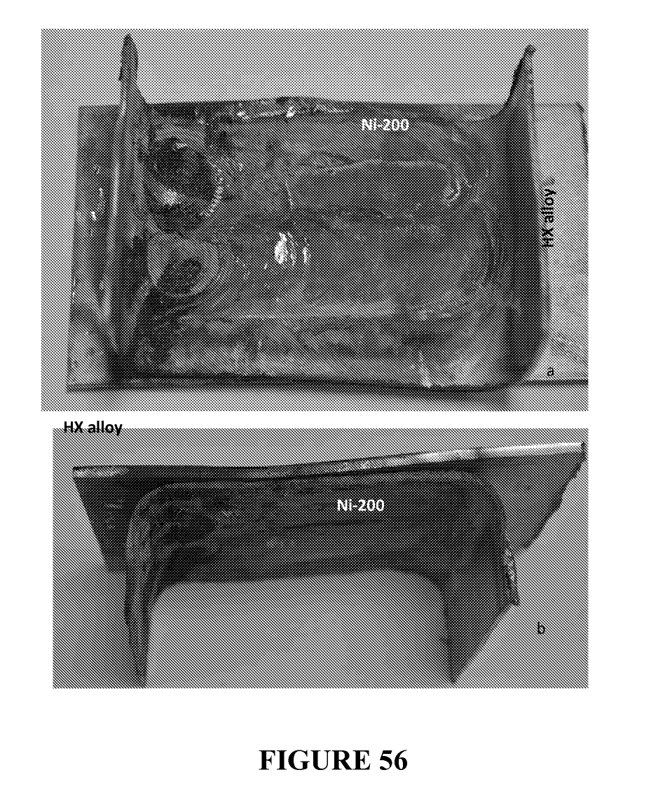

FIGS. 56A-56B depict multi-track-seam cladding of an Ni-200 layer on an Inconel HX alloy substrate. FIG. 56A depicts a top view of the two layers, and FIG. 56B depicts a back view. The Ni-200 layer had a thickness of 1.5 mm, and the HX alloy layer had a thickness of 2.0 mm.

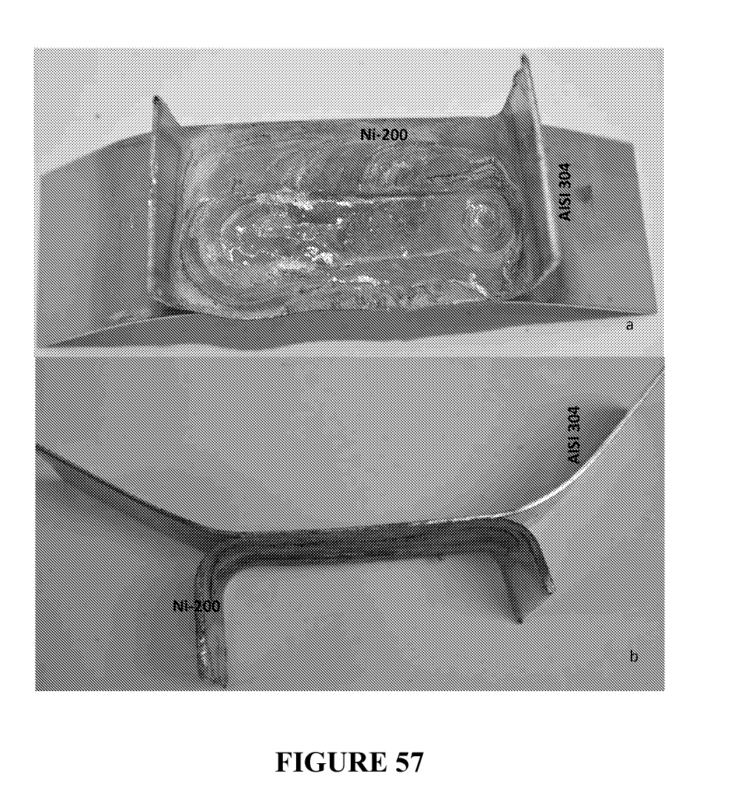

FIGS. 57A-57B depict multi-track-seam cladding of an Ni-200 layer on a AISI 304 substrate. FIG. 57A depicts a top view of the two layers, and FIG. 57B depicts a side view. The Ni-200 layer had a thickness of 1.5 mm, and the AISI 304 layer had a thickness of 1.5 mm.

Table 11 summarizes the process parameters that were employed to achieve the welds depicted in FIGS. 54A-57B.

TABLE 11
Seam Weld Process Parameters

| | | Rod | Weld |
|---|---|---|---|
| | Applied | Rotational | traverse |
| | force, | speed, | speed, |
| Materials | KN | RPM | mm/min |
| AISI 304 (1.5 mm) to C—Mn | 9 | 1600 | 10 |
| steel (2 mm) | | | |
| Ti6Al4V (0.8 mm) to AISI 304 | 8 | 1600 | 15 |
| (1.5 mm) | | | |
| Ni-200 (1.5 mm) to AISI 304 | 9 | 1600 | 15 |
| (1.5 mm) | | | |
| Ni-200 (1.5 mm) to HX alloy | 9 | 1600 | 15 |
| (2 mm) | | | |

### Experimental Example Six

Friction seam weld bond integrity for upper and lower material layers having similar compositions was assessed by U-bend and shear tensile tests. The bend test and shear test results are shown in Table 12 and depicted in FIGS. 58A-65C. U-bend tests showed that the welds did not fail in the seam weld after 180 degree U-bend testing, demonstrating the weld bond integrity. (See FIGS. 58-61). In the shear tests, all the welds failed in either the base metal or the heat affected zone (HAZ) and not in the weld, indicating that the seam welds were stronger than both the base metal and the HAZ. (See FIGS. 62-65).

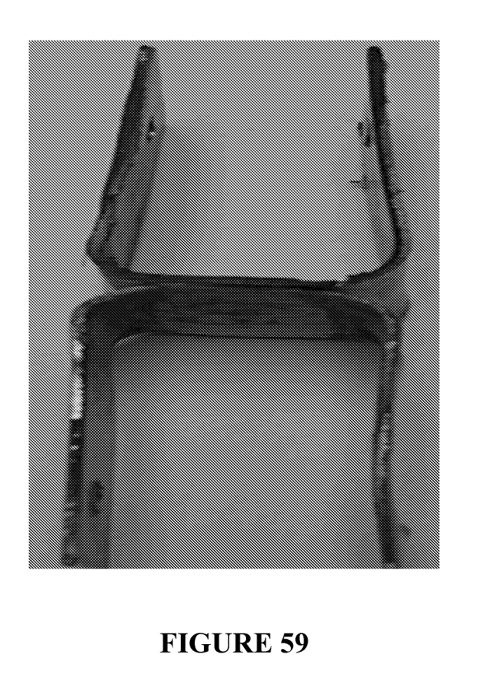

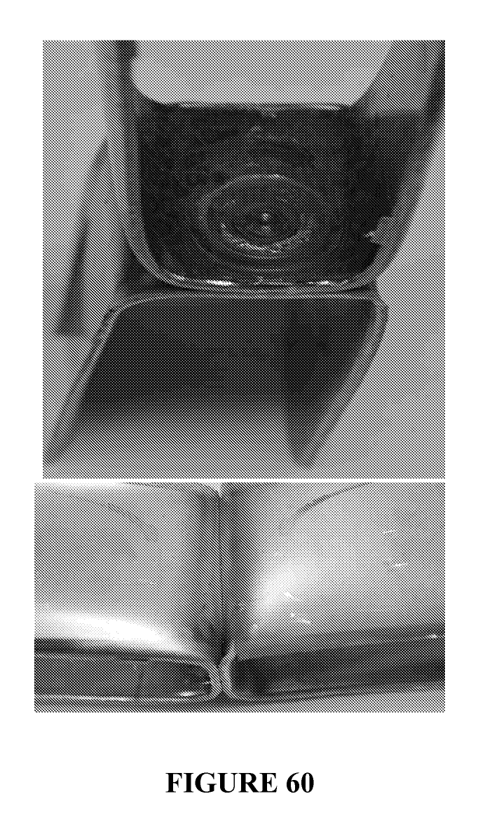

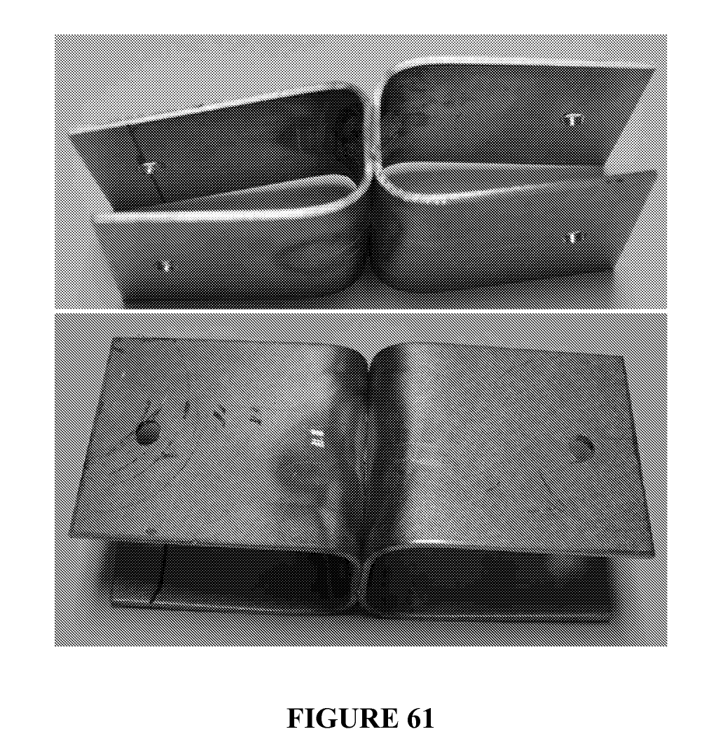

FIGS. 58A-58D depict the appearance of a seam weld between AA6061 layers following bend testing. FIG. 59 depicts the appearance of a seam weld between C—Mn steel layers following bend testing. FIG. 60 depicts the appearance of a seam weld between AISI 304 layers following bend testing. FIG. 61 depicts the appearance of a seam weld between Inconel HX layers following bend testing.

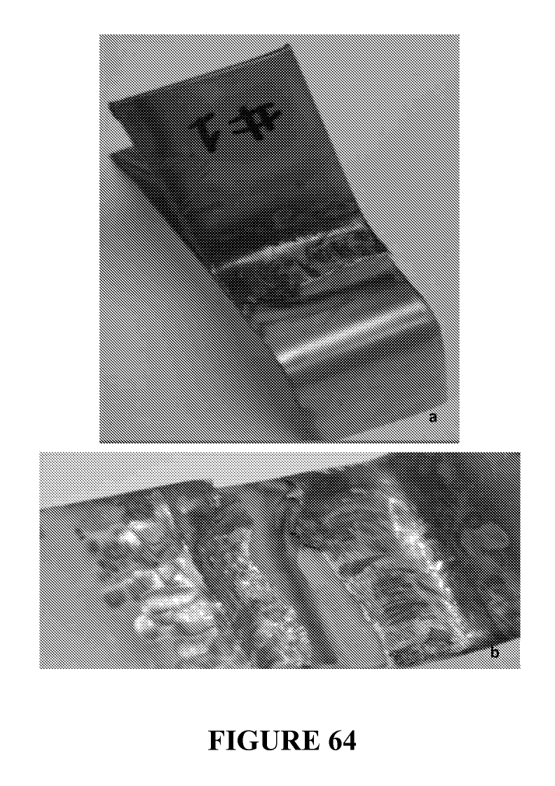

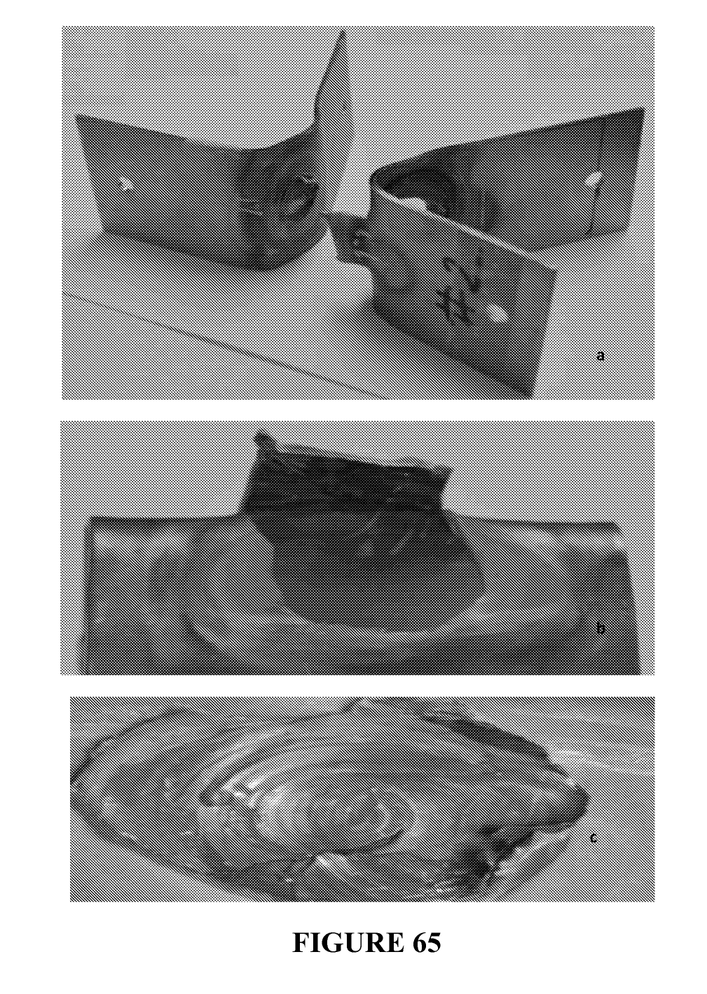

FIG. 62 depicts the appearance of a seam weld between AA6061 layers following shear testing. Following shear testing, the seam weld showed failure in the heat affected zone (HAZ). FIG. 63 depicts the appearance of a seam weld between C—Mn steel layers following shear testing. Following shear testing, the seam weld showed failure in the base metal. FIGS. 64A-64B depict the appearance of a seam weld between AISI 304 layers following shear testing. Following shear testing, the seam weld showed failure in the edge of weld and in the heat affected zone (HAZ). FIGS. 65A-65C depict the appearance of a seam weld between Inconel HX layers following shear testing. Following shear testing, the seam weld showed failure in the edge of weld and in the heat affected zone (HAZ).

The weld integrity of these seam welds can be attributed to the metallurgical bonding bteween the upper and lower sheets. FIGS. 66A and 66B display cross-sectional image of exemplary seam welds achieved between similar materials using the friction seam welding methods described herein.

TABLE 12
Bend and Shear Test Results

| | Failure in | |
|---|---|---|
| | the weld | Failure |
| | (Yes/No) | location, |
| Seam welds | Bend test | Shear test |
| AA6061 (1.5 mm) to | No | Heat affected |
| self | | zone |
| C—Mn steel (mm) to | No | Base metal |
| self | | |
| AISI 304 (2 mm) to | No | Edge/HAZ |
| self | | of seam weld |
| Inconcel HX (2 mm) to | No | Edge/base |
| self | | metal of |
| | | seam weld |

### Experimental Example Seven

Friction seam weld failure load was assessed by tensile tests by pulling the single seam weld sheet specimens from Experimental Example Seven. The tensile test axis was in the direction of seam welding. The tensile test was conducted on single seam welds of similar materials having the same thickness. Reduced cross section tensile tests as per ASME code-section IX were used to assess the failure load of seam welds. For comparative purposes, the base materials (without any weld) were also subjected to tensile testing using the reduced cross section sheet tensile test. The tensile test results are shown in Table 13. The results showed that the tensile strength of the single seam weld of AA6061 was less than its base metal counterpart. In the case of C—Mn steel, AISI 304 and HX alloy, the tensile strength did not decrease because of seam welding.

TABLE 13
Tensile Test Results

| Material | Tensile strength (MPa) |
|---|---|
| AA6061- base metal | 256 |
| AA6061-seam weld | 158 |
| C—Mn steel- base metal | 375 |
| C—Mn steel-seam weld | 390 |
| AISI 304- base metal | 521 |
| AISI 304-seam weld | 580 |
| HX- base metal | 762 |
| HX-seam weld | 783 |

### Experimental Example Eight

An AISI 304 sheet cladded on to C—Mn steel was examined for any corrosion degradation using ASTM A-262 Practice A (10% Oxalic acid test). The microstructure of the ASI 304 sheet cladded to C—Mn steel substrate showed a “step” structure, indicating that the frictional heat generated by the seam welding did not lead to any “ditch” structure and demonstrating the absence of intergranular corrosion in the cladded 304 sheet. See FIG. 67, which shows the “step” structure micrographs across the entire cross section of the cladded AISI 304 layer.

### Experimental Example Nine

In another series of experiments, upper and lower material layers having similar compositions were welded together by single seam welds using the methods disclosed herein. 2 mm thick Inconel 625 sheets (150×150 mm) were used to fabricate a metallic micro reactor. Micro-channels (depth of 1 mm with a length of 25 mm and width of 2 mm) were milled over one sheet using a CNC milling machine. The two sheets were clamped and a friction seam weld was made using the methods disclosed herein. The following exemplary welding parameters were used: RPM: 1600, Axial force: 10,000 N and Feed rate: 10 mm/min. The welded piece was cut to a size of 65×25 mm.

FIGS. 68A-68C depict a single seam weld between an upper material layer and a lower material layer of IN 600 with a milled micro-channel having two drilled holes at its edges.

FIG. 69 depicts the radoigraph of a friction seam weld of Inconel 600 sheets depicting the drilled holes and the micro-channel as dark patches.

FIG. 70 depicts the color of water exiting through the right hole (via the micro-channel of seam weld) when injected through the left hole, indicating the presence of a concealed micro-channel.

### Exemplary Aspects

In one exemplary aspect, a method of spot welding an upper material layer to a lower material layer relative to a welding axis is disclosed. The upper material layer is positioned in overlying relation to at least a portion of the lower material layer, and the upper and lower material layers have respective top and bottom surfaces. The method comprises: axially advancing and rotating a rod relative to the welding axis such that a distal end of the rod contacts the top surface of the upper material layer; applying an axial force to the rotating rod such that frictional heat between the distal end of the rod and the upper material layer plasticizes a portion of the upper material layer; with a portion of the upper material layer plasticized, applying the axial force to the rotating rod such that a portion of the bottom surface of the upper material layer and a portion of the top surface of the lower material layer are deformed, thereby forming a metallurgical bond between the upper and lower material layers; and axially retracting the rod relative to the welding axis such that the distal end of the rod is removed from contact with the top surface of the upper material layer.

In other exemplary aspects, the rod is substantially perpendicular to the top surface of the upper material layer when the distal end of the rod contacts the top surface of the upper material layer.

In other exemplary aspects, the upper material layer and the lower material layer have respective thicknesses, and the thickness of the upper material layer and the thickness of the lower material layer both range from about 0.5 mm to about 3.25 mm.

In other exemplary aspects, the upper material layer and the lower material layer comprise a first material. In other exemplary aspects, at least the distal end of the rod comprises the first material. In other exemplary aspects, the at least the distal end of the rod comprises a second material different from the first material.

In other exemplary aspects, the upper material layer comprises a first material, and the lower material layer comprises a second material different from the first material. In other exemplary aspects, at least the distal end of the rod comprises the first material. In other exemplary aspects, at least the distal end of the rod comprises the second material. In other exemplary aspects, at least the distal end of the rod comprises a third material different from the first material and the second material.

In other exemplary aspects, at least one intermediate material layer is positioned between the upper material layer and the lower material layer, each intermediate material layer of the at least one intermediate material layer has a top surface and a bottom surface, and the step of applying the axial force to the rotating rod such that the distal end of the rod penetrates through the upper material layer comprises applying the axial force to the rotating rod such that at least a portion of the top and bottom surfaces of each intermediate material layer is deformed, thereby forming a metallurgical bond between the upper material layer, the at least one intermediate material layer, and the lower material layer.

In other exemplary aspects, the rod is a non-consumable rod.

In other exemplary aspects, the rod is a consumable rod. In other exemplary aspects, the step of applying an axial force to the rotating rod comprises applying an axial force to the rotating rod such that frictional heat between the distal end of the rod and the upper material layer plasticizes a portion of the distal end of the rod, wherein, with a portion of the distal end of the rod and a portion of the upper material layer plasticized, the axial force is applied to the rotating rod such that the distal end of the rod penetrates through at least a portion of the upper material layer, thereby defining a cavity, and wherein, prior to axial retraction of the consumable rod, the plasticized portion of the distal end of the rod fills the cavity. In other exemplary aspects, the rod has a diameter ranging from about 5 mm to about 25 mm, wherein, prior to plasticization of the distal end of the rod, the rod has a longitudinal length ranging from about 50 mm to about 100 mm, and wherein, following filling of the cavity by the plasticized portion of the distal end of the rod, the longitudinal length of the rod ranges from about 45 mm to about 90 mm.

In other exemplary aspects, the rod rotates at a rotational rate ranging from about 500 RPM to about 3,000 RPM.

In other exemplary aspects, the axial force applied to the rod ranges from about 1,000 N to about 25,000 N.

In another exemplary aspect, a spot welding system for welding an upper material layer to a lower material layer relative to a welding axis is provided. The upper material layer is positioned in overlying relation to at least a portion of the lower material layer, and the upper and lower material layers have respective top and bottom surfaces. The spot welding system comprises: a rod having a distal end and a longitudinal axis substantially axially aligned with the welding axis; means for selectively axially moving the rod relative to the welding axis; and means for selectively rotating the rod about the longitudinal axis of the rod, wherein, during rotation of the rod about the longitudinal axis of the rod, the means for selectively axially moving the rod is configured to apply an axial force to the rod to thereby generate frictional heat between the distal end of the rod and the upper material layer such that a portion upper material layer is plasticized, wherein, with a portion of the upper material layer plasticized, the means for selectively axially moving the rod is configured to apply the axial force to the rotating rod such that a portion of the bottom surface of the upper material layer and a portion of the top surface of the lower material layer are deformed, thereby forming a metallurgical bond between the upper and lower material layers, wherein the means for selectively axially moving the rod is configured to axially retract the rod relative to the welding axis such that the distal end of the rod is removed from contact with the top surface of the upper material layer.

In other exemplary aspects, the rod is a non-consumable rod.

In other exemplary aspects, the rod is a consumable rod.

In other exemplary aspects, the means for selectively axially moving the rod is configured to apply an axial force to the rotating rod such that frictional heat between the distal end of the rod and the upper material layer plasticizes a portion of the distal end of the rod, wherein, with a portion of the distal end of the rod and a portion of the upper material layer plasticized, the means for axially moving the rod is configured to apply the axial force to the rotating rod such that the distal end of the rod penetrates through at least a portion of the upper material layer, thereby defining a cavity, and wherein, prior to axial retraction of the rod, the plasticized portion of the distal end of the rod is configured to fill the cavity.

In an additional exemplary aspect, a method of lap seam welding an upper material layer to a lower material layer relative to a vertical axis is disclosed. The upper material layer is secured in overlying relation to at least a portion of the lower material layer, and the upper and lower material layers have respective top and bottom surfaces and are configured for movement along a weld traverse axis. The weld traverse axis is substantially perpendicular to the vertical axis. The method comprises: axially advancing and rotating a rod relative to the vertical axis such that a distal end of the rod contacts the top surface of the upper material layer; applying an axial force to the rotating rod such that frictional heat between the distal end of the rod and the upper material layer plasticizes a portion of the upper material layer; with a portion of the upper material layer plasticized, applying the axial force to the rotating rod such that a portion of the bottom surface of the upper material layer and a portion of the top surface of the lower material layer are deformed, axially advancing the upper and lower material layers relative to the weld traverse axis by a desired length, thereby forming a metallurgical bond of the desired length between the upper and lower material layers; and axially retracting the rod relative to the vertical axis such that the distal end of the rod is removed from contact with the top surface of the upper material layer.

In other exemplary aspects, the rod is substantially perpendicular to the top surface of the upper material layer when the distal end of the rod contacts the top surface of the upper material layer.

In other exemplary aspects, the upper material layer and the lower material layer have respective thicknesses, and the thickness of the upper material layer and the thickness of the lower material layer both range from about 0.5 mm to about 2 mm.

In other exemplary aspects, the upper material layer and the lower material layer comprise a first material. In other exemplary aspects, at least the distal end of the rod comprises the first material. In other exemplary aspects, at least the distal end of the rod comprises a second material different from the first material.

In other exemplary aspects, the upper material layer comprises a first material, and the lower material layer comprises a second material different from the first material. In other exemplary aspects, at least the distal end of the rod comprises the first material. In other exemplary aspects, at least the distal end of the rod comprises the second material. In other exemplary aspects, at least the distal end of the rod comprises a third material different from the first material and the second material.

In other exemplary aspects, at least one intermediate material layer is secured between the upper material layer and the lower material layer, and each intermediate material layer of the at least one intermediate material layer has a top surface and a bottom surface, and the step of applying the axial force to the rotating rod such that the distal end of the rod penetrates through the upper material layer comprises applying the axial force to the rotating rod such that at least a portion of the top and bottom surfaces of each intermediate material layer is deformed, and wherein the step of axially advancing the upper and lower material layers relative to the weld traverse axis comprises axially advancing the upper material layer, the lower material layer, and the at least one intermediate material layer by the desired length, thereby forming a metallurgical bond of the desired length between the upper material layer, the at least one intermediate material layer, and the lower material layer.

In other exemplary aspects, the rod is a non-consumable rod.

In other exemplary aspects, the method is used as a cladding method as disclosed herein.

In other exemplary aspects, following formation of the lap seam weld between the upper material layer and the lower material layer, the method further comprises lap seam welding at least one additive layer to the upper material layer.

In other exemplary aspects, the rod rotates at a rotational rate ranging from about 800 RPM to about 1600 RPM.

In other exemplary aspects, the axial force applied to the rod ranges from about 5,000 N to about 9,000 N.

In other exemplary aspects, the method is used as an additive manufacturing method as disclosed herein.

In a further exemplary aspect, a method of lap seam welding an upper material layer to a lower material layer relative to a vertical axis is disclosed. The upper material layer is secured in overlying relation to at least a portion of the lower material layer, the upper and lower material layers have respective top and bottom surfaces and are configured for movement along a weld traverse axis and a transverse axis. The weld traverse axis and the transverse axis are positioned in a plane substantially perpendicular to the vertical axis, and the weld traverse axis is substantially perpendicular to the transverse axis. The method comprises: axially advancing and rotating a rod relative to the vertical axis such that a distal end of the rod contacts a first location on the top surface of the upper material layer; applying a first axial force to the rotating rod such that frictional heat between the distal end of the rod and the upper material layer plasticizes a portion of the upper material layer; with a portion of the upper material layer plasticized, applying the first axial force to the rotating rod such that a portion of the bottom surface of the upper material layer and a portion of the top surface of the lower material layer are deformed, axially advancing the upper and lower material layers relative to the weld traverse axis by a first desired length, thereby forming a first seam weld between the upper and lower material layers; axially retracting the rod relative to the vertical axis such that the distal end of the rod is removed from contact with the top surface of the upper material layer; axially advancing and rotating the rod relative to the vertical axis such that the distal end of the rod contacts a second location on the top surface of the upper material layer, the second location on the top surface being spaced from the first location relative to the transverse axis; applying a second axial force to the rotating rod such that frictional heat between the distal end of the rod and the upper material layer plasticizes a portion of the upper material layer; with a portion of the upper material layer plasticized, applying the second axial force to the rotating rod such that a portion of the bottom surface of the upper material layer and a portion of the top surface of the lower material layer are deformed, axially advancing the upper and lower material layers relative to the weld traverse axis by a second desired length, thereby forming a second seam weld between the upper and lower material layers; and axially retracting the rod relative to the vertical axis such that the distal end of the rod is removed from contact with the top surface of the upper material layer, wherein the first seam weld and the second seam weld overlap relative to the transverse axis.

In other exemplary aspects, at least one intermediate material layer is secured between the upper material layer and the lower material layer, and each intermediate material layer of the at least one intermediate material layer has a top surface and a bottom surface, wherein the steps of applying the first and second axial forces to the rotating rod such that the distal end of the rod penetrates through the upper material layer comprise applying the first and second axial forces to the rotating rod such that at least a portion of the top and bottom surfaces of each intermediate material layer is deformed, and wherein the steps of axially advancing the upper and lower material layers relative to the weld traverse axis comprise axially advancing the upper material layer, the lower material layer, and the at least one intermediate material layer by the first and second desired lengths, thereby forming the first and second seam welds between the upper material layer, the at least one intermediate material layer, and the lower material layer.

In other exemplary aspects, prior to the step of axially advancing and rotating the rod relative to the vertical axis such that the distal end of the rod contacts the second location on the top surface of the upper material layer, the method comprises axially shifting the upper and lower material layers relative to the transverse axis such that the vertical axis is substantially aligned with the second location.

In other exemplary aspects, prior to the step of axially advancing and rotating the rod relative to the vertical axis such that the distal end of the rod contacts the second location on the top surface of the upper material layer, the method comprises axially shifting the rod relative to the transverse axis such that the vertical axis is substantially aligned with the second location.

In still a further exemplary aspect, a lap seam welding system for welding an upper material layer to a lower material layer relative to a vertical axis is provided. The upper material layer is secured in overlying relation to at least a portion of the lower material layer, and the upper and lower material layers have respective top and bottom surfaces and are configured for movement along a weld traverse axis. The weld traverse axis is substantially perpendicular to the vertical axis. The lap seam welding system comprises: a rod having a distal end and a longitudinal axis substantially axially aligned with the vertical axis; means for selectively axially moving the rod relative to the vertical axis; means for selectively rotating the rod about the longitudinal axis of the rod; and means for selectively axially moving the upper and lower material layers relative to the weld traverse axis, wherein, during rotation of the rod about the longitudinal axis of the rod, the means for selectively axially moving the rod is configured to apply an axial force to the rod to thereby generate frictional heat between the distal end of the rod and the upper material layer such that a portion upper material layer is plasticized, wherein, with a portion of the upper material layer plasticized, the means for selectively axially moving the rod is configured to apply the axial force to the rotating rod such that a portion of the bottom surface of the upper material layer and a portion of the top surface of the lower material layer are deformed, wherein the means for selectively axially moving the upper and lower material layers is configured to axially advance the upper and lower material layers relative to the weld traverse axis by a desired length, thereby forming a metallurgical bond of the desired length between the upper and lower material layers, and wherein the means for selectively axially moving the rod is configured to axially retract the rod relative to the vertical axis such that the distal end of the rod is removed from contact with the top surface of the upper material layer.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A method of spot welding an upper material layer to a lower material layer relative to a welding axis, the upper material layer being positioned in overlying relation to at least a portion of the lower material layer, the upper and lower material layers having respective top and bottom surfaces, the method comprising:
axially advancing and rotating a rod relative to the welding axis such that a distal end of the rod contacts the top surface of the upper material layer;
applying an axial force to the rotating rod such that frictional heat between the distal end of the rod and the upper material layer plasticizes a portion of the upper material layer;
with a portion of the upper material layer plasticized, applying the axial force to the rotating rod such that a portion of the bottom surface of the upper material layer and a portion of the top surface of the lower material layer are deformed, thereby forming a metallurgical bond between the upper and lower material layers; and
axially retracting the rod relative to the welding axis such that the distal end of the rod is removed from contact with the top surface of the upper material layer.

2. The method of claim 1, wherein the rod is substantially perpendicular to the top surface of the upper material layer when the distal end of the rod contacts the top surface of the upper material layer.

3. The method of claim 1, wherein the upper material layer and the lower material layer have respective thicknesses, and wherein the thickness of the upper material layer and the thickness of the lower material layer both range from about 0.5 mm to about 3.25 mm.

4. The method of claim 1, wherein the upper material layer and the lower material layer comprise a first material.

5. The method of claim 4, wherein at least the distal end of the rod comprises the first material.

6. The method of claim 4, wherein the at least the distal end of the rod comprises a second material different from the first material.

7. The method of claim 1, wherein the upper material layer comprises a first material, and wherein the lower material layer comprises a second material different from the first material.

8. The method of claim 7, wherein at least the distal end of the rod comprises the first material.

9. The method of claim 7, wherein at least the distal end of the rod comprises the second material.

10. The method of claim 7, wherein at least the distal end of the rod comprises a third material different from the first material and the second material.

11. The method of claim 1, wherein at least one intermediate material layer is positioned between the upper material layer and the lower material layer, wherein each intermediate material layer of the at least one intermediate material layer has a top surface and a bottom surface, and wherein the step of applying the axial force to the rotating rod such that the distal end of the rod penetrates through the upper material layer comprises applying the axial force to the rotating rod such that at least a portion of the top and bottom surfaces of each intermediate material layer is deformed, thereby forming a metallurgical bond between the upper material layer, the at least one intermediate material layer, and the lower material layer.

12. The method of claim 3, wherein the rod is a non-consumable rod.

13. The method of claim 3, wherein the rod is a consumable rod.

14. The method of claim 13, wherein the step of applying an axial force to the rotating rod comprises applying an axial force to the rotating rod such that frictional heat between the distal end of the rod and the upper material layer plasticizes a portion of the distal end of the rod, wherein, with a portion of the distal end of the rod and a portion of the upper material layer plasticized, the axial force is applied to the rotating rod such that the distal end of the rod penetrates through at least a portion of the upper material layer, thereby defining a cavity, and wherein, prior to axial retraction of the consumable rod, the plasticized portion of the distal end of the rod fills the cavity.

15. The method of claim 14, wherein the rod has a diameter ranging from about 5 mm to about 25 mm, wherein, prior to plasticization of the distal end of the rod, the rod has a longitudinal length ranging from about 50 mm to about 100 mm, and wherein, following filling of the cavity by the plasticized portion of the distal end of the rod, the longitudinal length of the rod ranges from about 45 mm to about 90 mm.

16. The method of claim 1, wherein the rod rotates at a rotational rate ranging from about 500 RPM to about 3,000 RPM.

17. The method of claim 1, wherein the axial force applied to the rod ranges from about 1,000 N to about 25,000 N.

18. A method of lap seam welding an upper material layer to a lower material layer relative to a vertical axis, the upper material layer being secured in overlying relation to at least a portion of the lower material layer, the upper and lower material layers having respective top and bottom surfaces and being configured for movement along a weld traverse axis, the weld traverse axis being substantially perpendicular to the vertical axis, the method comprising:
axially advancing and rotating a rod relative to the vertical axis such that a distal end of the rod contacts the top surface of the upper material layer;
applying an axial force to the rotating rod such that frictional heat between the distal end of the rod and the upper material layer plasticizes a portion of the upper material layer;
with a portion of the upper material layer plasticized, applying the axial force to the rotating rod such that a portion of the bottom surface of the upper material layer and a portion of the top surface of the lower material layer are deformed,
axially advancing the upper and lower material layers relative to the weld traverse axis by a desired length, thereby forming a metallurgical bond of the desired length between the upper and lower material layers; and
axially retracting the rod relative to the vertical axis such that the distal end of the rod is removed from contact with the top surface of the upper material layer.

19. The method of claim 18, wherein the rod is substantially perpendicular to the top surface of the upper material layer when the distal end of the rod contacts the top surface of the upper material layer.

20. The method of claim 18, wherein the upper material layer and the lower material layer have respective thicknesses, and wherein the thickness of the upper material layer and the thickness of the lower material layer both range from about 0.5 mm to about 2 mm.

21. The method of claim 18, wherein the upper material layer and the lower material layer comprise a first material.

22. The method of claim 21, wherein at least the distal end of the rod comprises the first material.

23. The method of claim 21, wherein at least the distal end of the rod comprises a second material different from the first material.

24. The method of claim 18, wherein the upper material layer comprises a first material, and wherein the lower material layer comprises a second material different from the first material.

25. The method of claim 24, wherein at least the distal end of the rod comprises the first material.

26. The method of claim 24, wherein at least the distal end of the rod comprises the second material.

27. The method of claim 24, wherein at least the distal end of the rod comprises a third material different from the first material and the second material.

28. The method of claim 18, wherein at least one intermediate material layer is secured between the upper material layer and the lower material layer, wherein each intermediate material layer of the at least one intermediate material layer has a top surface and a bottom surface,
wherein the step of applying the axial force to the rotating rod such that the distal end of the rod penetrates through the upper material layer comprises applying the axial force to the rotating rod such that at least a portion of the top and bottom surfaces of each intermediate material layer is deformed, and
wherein the step of axially advancing the upper and lower material layers relative to the weld traverse axis comprises axially advancing the upper material layer, the lower material layer, and the at least one intermediate material layer by the desired length, thereby forming a metallurgical bond of the desired length between the upper material layer, the at least one intermediate material layer, and the lower material layer.

29. The method of claim 20, wherein the rod is a non-consumable rod.

30. The method of claim 18, wherein the method is used as a cladding method.

31. The method of claim 18, wherein, following formation of the lap seam weld between the upper material layer and the lower material layer, the method further comprises lap seam welding at least one additive layer to the upper material layer.

32. The method of claim 18, wherein the rod rotates at a rotational rate ranging from about 800 RPM to about 1600 RPM.

33. The method of claim 18, wherein the axial force applied to the rod ranges from about 5000 N to about 9,000 N.

34. The method of claim 31, wherein the method is used as an additive manufacturing method.

35. A method of lap seam welding an upper material layer to a lower material layer relative to a vertical axis, the upper material layer being secured in overlying relation to at least a portion of the lower material layer, the upper and lower material layers having respective top and bottom surfaces and being configured for movement along a weld traverse axis and a transverse axis, the weld traverse axis and the transverse axis being positioned in a plane substantially perpendicular to the vertical axis, the weld traverse axis being substantially perpendicular to the transverse axis, the method comprising:
axially advancing and rotating a rod relative to the vertical axis such that a distal end of the rod contacts a first location on the top surface of the upper material layer;
applying a first axial force to the rotating rod such that frictional heat between the distal end of the rod and the upper material layer plasticizes a portion of the upper material layer;
with a portion of the upper material layer plasticized, applying the first axial force to the rotating rod such that a portion of the bottom surface of the upper material layer and a portion of the top surface of the lower material layer are deformed,
axially advancing the upper and lower material layers relative to the weld traverse axis by a first desired length, thereby forming a first seam weld between the upper and lower material layers;
axially retracting the rod relative to the vertical axis such that the distal end of the rod is removed from contact with the top surface of the upper material layer;
axially advancing and rotating the rod relative to the vertical axis such that the distal end of the rod contacts a second location on the top surface of the upper material layer, the second location on the top surface being spaced from the first location relative to the transverse axis;
applying a second axial force to the rotating rod such that frictional heat between the distal end of the rod and the upper material layer plasticizes a portion of the upper material layer;
with a portion of the upper material layer plasticized, applying the second axial force to the rotating rod such that a portion of the bottom surface of the upper material layer and a portion of the top surface of the lower material layer are deformed,
axially advancing the upper and lower material layers relative to the weld traverse axis by a second desired length, thereby forming a second seam weld between the upper and lower material layers; and
axially retracting the rod relative to the vertical axis such that the distal end of the rod is removed from contact with the top surface of the upper material layer,
wherein the first seam weld and the second seam weld overlap relative to the transverse axis.

36. The method of claim 35, wherein at least one intermediate material layer is secured between the upper material layer and the lower material layer, wherein each intermediate material layer of the at least one intermediate material layer has a top surface and a bottom surface,
wherein the steps of applying the first and second axial forces to the rotating rod such that the distal end of the rod penetrates through the upper material layer comprise applying the first and second axial forces to the rotating rod such that at least a portion of the top and bottom surfaces of each intermediate material layer is deformed, and
wherein the steps of axially advancing the upper and lower material layers relative to the weld traverse axis comprise axially advancing the upper material layer, the lower material layer, and the at least one intermediate material layer by the first and second desired lengths, thereby forming the first and second seam welds between the upper material layer, the at least one intermediate material layer, and the lower material layer.

37. The method of claim 35, wherein, prior to the step of axially advancing and rotating the rod relative to the vertical axis such that the distal end of the rod contacts the second location on the top surface of the upper material layer, the method comprises axially shifting the upper and lower material layers relative to the transverse axis such that the vertical axis is substantially aligned with the second location.

38. The method of claim 35, wherein, prior to the step of axially advancing and rotating the rod relative to the vertical axis such that the distal end of the rod contacts the second location on the top surface of the upper material layer, the method comprises axially shifting the rod relative to the transverse axis such that the vertical axis is substantially aligned with the second location.
